(19) United States
(12) Patent Application Publication
(10) Pub. No.: US 2006/0088081 A1
(43) Pub. Date: Apr. 27, 2006

(54) Transmit-rake apparatus in communication systems and associated methods

(75) Inventors: Paul Withington, West Chester, PA (US); James Richards, Fayettevile, TN (US); Larry W. Fullerton, Owens Crossroads, AL (US); Mark Roberts, Huntsville, AL (US)

Correspondence Address: JAMES RICHARDS, 58 BONING RD, FAYETTEVILLE, TN, 37334, US

(73) Assignee: Time Domain Corporation, Huntsville, AL (US)

(21) Appl. No.: 10/971,429

(22) Filed: Oct. 22, 2004

(51) Int. Cl. H04B 1/69

(52) U.S. Cl. 375/130

(57) ABSTRACT

A transmit-rake apparatus includes at least one pulse generator that provides a plurality of pulses with selected signal properties so as to improve the signal-to-noise ratio at a receiver. The signal properties may include pulse timing, amplitude, polarity, and pulse shape. The transmit-rake apparatus may use a multipath analyzer, receive multipath or signal-quality information, or use a combination of those techniques. The multipath analyzer may include a scanning receiver to generate a scan of the multipath response. Correlation of the multipath response with a model pulse shape may be used to establish pulse position and amplitude. Iteration based on link performance measurements may be used to select or refine pulse properties. A method is disclosed to vary the selection of pulses to improve the spectrum.

### TECHNICAL FIELD OF THE INVENTION

This invention relates generally to improving the signal-to-noise ratio in communication systems and, more particularly, to using transmit-rake apparatus and associates methods to improve the signal-to-noise ratio in ultra-wideband communication systems.

### BACKGROUND

Designers of communications systems strive to increase the quality of those systems. A high-quality communication system allows the system's user to communicate information to other users with no or minimal loss or degradation of the information. The signal-to-noise ratio of a communication system typically constitutes a measure of the communication system quality, i.e., other things being equal, the higher the signal-to-noise ratio, the higher the quality of the communication system, and vice-versa. System designers therefore seek to improve the signal-to-noise ratio of communication systems.

One may improve the signal-to-noise ratio of a communication system simply by using the brute force technique of increasing the transmitted power. Assuming that the characteristics of the communication medium and the noise profile do not change, increasing the transmitter's power would increase the signal-to-noise ratio and, hence, the overall quality of the system. Unfortunately, that brute force technique has several drawbacks.

First, increasing the transmitter's output power usually requires using components, for example, radio-frequency (RF) amplifiers, switching devices, and the like, with higher power-handling capability. Components with high power-handling capability usually cost more and occupy more physical space. Using those components therefore results in more costly and more bulky communication systems.

Second, increasing the transmitter's power arbitrarily may produce undesired interference with other equipment. For example, increased transmitter power may interfere with medical instruments or sensitive communication equipment.

Third, increasing the transmitted power may pose health hazards. Although the results to date seem inconclusive, some studies have shown that the relatively high RF levels of a cellular telephone may pose health risks for the telephone's user.

Fourth, increasing the transmitted power may be undesirable or even hazardous in some applications. For example, increasing the transmitted power in covert military communications may alert an adversary to the existence or location of the troops. Moreover, the higher transmitted power may allow detection of the covert communication at longer distances or in the presence of higher interference and noise.

Finally, in some applications, one may not arbitrarily increase the transmitter's RF output power because of regulatory requirements. For example, in the United States, the Federal Communication Commission has rigorous rules that specify the maximum RF output power of communication equipment operating in the various parts of the radio spectrum. A need therefore exists for apparatus and associated methods for improving the signal-to-noise ratio of a communication system that do not suffer from the disadvantages discussed above.

### BRIEF SUMMARY OF THE INVENTION

The disclosed novel transmit-rake apparatus overcomes the disadvantages associated with improving the signal-to-noise ratio in communication systems. An improved signal-to-noise ratio would allow transmission of information at higher speed, through higher interference, or to receivers at longer distances.

The transmit-rake apparatus according to the invention can improve the signal-to-noise ratio in a communication system without increasing the transmitted output RF power. It achieves that result by providing to a receiver a plurality of transmitted pulses that have individually selected timing and amplitudes. To achieve an even higher improvement in the signal-to-noise ratio, the transmit-rake apparatus according to the invention may individually select the polarity, as well as the timing and amplitude, of each of the plurality of pulses. The transmit-rake apparatus according to the invention preferably operates in ultra-wideband (also known as time-domain or impulse radio) communication systems that employ ultra-wideband signals.

Briefly, the present invention is a system and method for improving the signal to noise of a signal by transmitting a plurality of pulses in accordance with a measurement of the environment.

In one embodiment, the measurement of the environment is accomplished by a multipath analyzer. A multipath analyzer may include a scanning receiver. A scanning receiver acquires and tracks a signal and measures energy at a selection of time offsets from the tracking timing to determine a multipath responses characteristic.

In one embodiment, the multipath analyzer proceses the multipath response characteristic using correlation (or deconvolution) with a signal model to find a peak match. The signal model is then subtracted from the multipath response characteristic to generate a remainder characteristic. The remainder characteristic is then correlated with a signal model to locate a subsequent pulse position and amplitude. A transmitter may utilize an internal multipath analyzer or may obtain multipath information from an external source.

In another embodiment, the measurement of the environment is accomplished by measurement of performance indictors including signal to noise ratio or bit error rate. The pulses in a set of pulses are varied in signal properties, including position, amplitude, and/or polarity based on the performance indicators. The process of varying signal properties and measuring performance is iteratively performed to refine the pulse properties.

In a further embodiment, the pulses may be defined in groups wherein the pulse property selection from group to group may be varied. Typically, each pulse within each group is related by being derived from the same multipath response, i.e. resulting from the same ideal impulse source. Each group results from a different time shifted ideal impulse. In a preferred embodiment, the groups do not overlap, but they may overlap for high pulse rates or long multpath delays.

In one embodiment, the total power from each group may remain constant. In another embodiment, the total received signal from each group may be constant. In another embodiment, each pulse may have the same amplitude. In another embodiment, the number of pulses in each group may remain constant. In another embodiment, the pulse shape is varied.

In another embodiment, the system includes a precision timing generator to provide pulse timing and a controller to control the pulse generator based on environment information.

In another embodiment, the system includes a delay generator to further determine pulse timing.

### BRIEF DESCRIPTION OF THE DRAWINGS

The description of the invention refers to the accompanying drawings. The drawings illustrate only exemplary embodiments of the invention and should not be used to limit its scope because the disclosed inventive concepts lend themselves to other equally effective embodiments.

FIG. 1A illustrates a representative Gaussian Monocycle waveform in the time domain.

FIG. 1B illustrates the frequency domain amplitude of the Gaussian Monocycle of FIG. 1A.

FIG. 2A illustrates a pulse train comprising pulses as in FIG. 1A.

FIG. 2B illustrates the frequency domain amplitude of the waveform of FIG. 2A.

FIG. 3 illustrates the frequency domain amplitude of a sequence of time coded pulses.

FIG. 4 illustrates a typical received signal and interference signal.

FIG. 5A illustrates a typical geometrical configuration giving rise to multipath received signals.

FIG. 5B illustrates exemplary multipath signals in the time domain.

FIGS. 5C-5E illustrate a signal plot of various multipath environments.

FIG. 5F illustrates the Rayleigh fading curve associated with non-impulse radio transmissions in a multipath environment.

FIG. 5G illustrates a plurality of multipaths with a plurality of reflectors from a transmitter to a receiver.

FIG. 5H graphically represents signal strength as volts versus time in a direct path and multipath environment.

FIG. 6 illustrates a representative impulse radio transmitter functional diagram.

FIG. 7 illustrates a representative impulse radio receiver functional diagram.

FIG. 8A illustrates a representative received pulse signal at the input to the correlator.

FIG. 8B illustrates a sequence of representative impulse signals in the correlation process.

FIG. 8C illustrates the output of the correlator for each of the time offsets of FIG. 8B.

FIG. 9 illustrates an example environment of an impulse radio communication system.

FIG. 10 is an exemplary flow diagram of a two transceiver system employing power control functions.

FIG. 11 is an exemplary diagram of an impulse receiver including power control functions.

FIG. 12 is a detailed representation of one embodiment of the detection process shown in FIG. 10.

FIG. 13 is a detailed block diagram of one embodiment of the signal evaluation process in FIG. 11.

FIG. 14 illustrates an alternate processing method for FIG. 13.

FIG. 15 is a detailed block diagram of one embodiment of the signal evaluation process in FIG. 11.

FIG. 16 illustrates an alternate processing method for FIG. 15.

FIG. 17 illustrates a lock detection and signal combination function used by the signal evaluation function of FIG. 11.

FIG. 18 is a flowchart that describes a method of power control.

FIG. 19 is a flowchart that describes controlling the transmitter power of a first transceiver according to the power control updates.

FIG. 20 is a flow diagram illustrating the control dynamics of one embodiment of the power control function.

FIG. 21 is a flow diagram illustrating the control dynamics of a system including signal-to-noise ratio measurement.

FIG. 22 is a flow diagram illustrating the control dynamics of a system including bit-error rate measurement.

FIG. 23 is a flow diagram illustrating the control dynamics of a system employing log mapping of bit-error rate measurements.

FIG. 24 is a flow diagram illustrating the control dynamics of a system that incorporates auto power control and cross power control.

FIG. 25 illustrates an embodiment of a power control algorithm employing auto-control with power level messaging.

FIG. 26 illustrates an embodiment of a power control algorithm where auto-control and cross control are implemented in combination.

FIG. 27 illustrates two signals having different pulse peak power.

FIG. 28 illustrates periods of two subcarriers.

FIG. 29 is a flow diagram illustrating the control dynamics of a system employing gain expansion power control.

FIG. 30A illustrates four nodes in an Impulse Radio TDMA linked network and the known distances between each node.

FIG. 30B illustrates the four time slots associated with a four node Impulse Radio TDMA network.

FIG. 31 illustrates a block diagram for the transmitter and multiple correlator scanning receiver.

FIG. 32 illustrates a corresponding impulse radio transmitter.

FIG. 33 is an impulse response of room with 4 meters of separation and with one intervening sheet rock and metal stud wall between the transmitter and receiver.

FIG. 34 illustrates the output of the tracking correlator for a 250 point scan.

FIGS. 35 and 36 show the impulse response measurements for two different in-building scans. FIG. 35 is the first scan at a range of approximately 4 meters through a single wall (sheet rock over metal studs). FIG. 36 is the second scan at a range of 21 meters through five walls of similar construction.

FIG. 37 shows the amplitude versus range of the three largest correlations where data were taken at each location. The “+” signs indicate the coherent sum of the top ten correlation values as might be obtained from a variable tap rake receiver design.

FIG. 38 illustrates the time of arrival of the three largest correlations at each location where data was taken. The largest correlation is marked with “o,” the second largest with “+,” and the third largest with “*.”

FIG. 39 is an overview block diagram illustrating an eight correlator receiver.

FIG. 40 more particularly sets forth the correlator configuration within a digital impulse radio architecture.

FIG. 41 illustrates a distinct timer configuration used in a multiple correlator receiver.

FIG. 42 is yet another distinct configuration of a multiple correlator receiver wherein slaved correlators are utilized and driven by the same timer as the master correlator with a delay there between.

FIG. 43A illustrates signal transmission in a multipath environment from a first transceiver to a second transceiver.

FIG. 43B shows signal transmission in a multipath environment from the second transceiver to the first transceiver.

FIG. 44A depicts an ultra-wideband signal transmitted in a multipath environment.

FIG. 44B illustrates a received signal corresponding to the signal transmitted in the multipath environment of FIG. 44A.

FIG. 45A shows a first transceiver and a second transceiver that include transmit-rake apparatus according to the invention, operating in a multipath environment that includes an obstruction that gives rise to a reflected signal.

FIG. 45B depicts a single ultra-wideband pulse, P, transmitted from the first transceiver in FIG. 45A.

FIG. 45C illustrates a direct-path signal, A, and a multipath signal, B, received at the second transceiver in FIG. 45A.

FIG. 45D shows a transmitted signal, TX, comprising a pair of signals, P₁ and P₂, transmitted from the first transceiver in FIG. 45A.

FIG. 45E depicts a received signal, RX_{A}, comprising a pair of signals, P_{1A} and P_{2A}, arriving via the direct path at the second transceiver in FIG. 45A.

FIG. 45F illustrates a received signal, RX_{B}, comprising a pair of signals, P_{1B} and P_{2B}, arriving via the reflected path at the second transceiver in FIG. 45A.

FIG. 45G shows a composite signal, RXₛᵤₘ, comprising signal P_{1A}, the sum of signals P_{2A} and P_{1B}, and signal P_{2B}, received at the second transceiver in FIG. 45A.

FIG. 46 depicts a transceiver that comprises transmit-rake apparatus according to the invention, including a precision-timing generator and a pulse generator.

FIG. 47 illustrates another transceiver that comprises transmit-rake apparatus according to the invention, including a precision-timing generator, a delay generator, and a pulse generator.

FIG. 48 shows another transceiver that comprises transmit-rake apparatus according to the invention, including a precision-timing generator, a plurality of delay generators, and a plurality of pulse generators. The number of delay generators in this embodiment equals the number of pulse generators.

FIG. 49 depicts another transceiver that comprises transmit-rake apparatus according to the invention, including a precision-timing generator, a plurality of delay generators, and a plurality of pulse generators. In this embodiment, the number of pulse generators exceeds the number of delay generators.

FIG. 50 illustrates another transceiver that comprises transmit-rake apparatus according to the invention, including a precision-timing generator, a plurality of delay generators, and a plurality of pulse generators. The number of delay generators in this embodiment exceeds the number of pulse generators.

FIG. 51 shows another transceiver that comprises transmit-rake apparatus according to the invention, including a plurality of precision-timing generators and a plurality of pulse generators. In this embodiment, the number of precision-timing generators equals the number of pulse generators.

FIG. 52 depicts another transceiver that comprises transmit-rake apparatus according to the invention, including a plurality of precision-timing generators and a plurality of pulse generators. The number of pulse generators in this embodiment exceeds the number of precision-timing generators.

FIG. 53 illustrates another transceiver that comprises transmit-rake apparatus according to the invention, including a plurality of precision-timing generators and a plurality of pulse generators. In this embodiment, the number of precision-timing generators exceeds the number of the pulse generators.

FIG. 54A shows a single pulse, TX, transmitted in a multipath environment.

FIG. 54B depicts a received signal, RX, received in a multipath environment, that corresponds to the transmitted signal TX in FIG. 54A. The largest peaks of signal RX include three negative peaks and a positive peak.

FIG. 55A shows an exemplary multipath response characteristic waveform.

FIG. 55B shows an transmitter waveform to be used with the multipath response characteristic of FIG. 55A.

FIG. 56A shows the selection of a model for a multipath response characteristic.

FIG. 56B shows a schematic of a composite transmitter signal associated with the model of FIG. 56A.

FIG. 57A and FIG. 57B illustrate an alternative embodiment utilizing constant amplitude pulses.

FIGS. 58A-D illustrate a coded sequence of pulses based on varying the transmitted pulse pattern.

FIGS. 59A-59D illustrates pulse groups adjusted for equal transmitted power.

FIGS. 60A-60D show pulse groups of differing size pulses.

FIGS. 61A-61D show pulse groups with a varying number of pulses.

FIGS. 62A-62D show pulse groups with a varying number of pulses, using a constant amplitude for each pulse.

FIG. 63 illustrates a link system wherein a transmitter receives performance data and/or multipath data from an external source in accordance with the present invention.

### DETAILED DESCRIPTION OF THE INVENTION

The present invention is described more fully in detail with reference to the accompanying drawings, in which the preferred embodiments of the invention are shown. This invention, however, should not be construed as limited to the disclosed embodiments; rather, the embodiments are provided so that this disclosure will be thorough and complete and fully convey the scope of the invention to those skilled in art.

Recent advances in communications technology have enabled an emerging, revolutionary ultra-wideband technology (UWB) called impulse radio communications systems (hereinafter “impulse radio”). Impulse radio was first fully described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990), and U.S. Pat. No. 5,363,108 (issued Nov. 8, 1994), to Larry W. Fullerton. A second generation of impulse radio patents includes U.S. Pat. No. 5,677,927 (issued Oct. 14, 1997), U.S. Pat. No. 5,687,169 (issued Nov. 11, 1997), and U.S. Pat. No. 5,832,035 (issued Nov. 3, 1998), to Fullerton et al. Uses of impulse radio systems are described in U.S. Pat. No. 6,177,903 (issued Jan. 23, 2001) and U.S. Pat. No. 6,218,979 (issued Apr. 17, 2001). These patent documents are incorporated herein by reference.

The present invention may be beneficially used with the following U.S. patents and applications: U.S. patent application Ser. No. 09/537,263, filed on Mar. 29, 2000, now U.S. Pat. No. 6,700,538 (issued Mar. 2, 2004) and entitled, “System and Method for Estimating Separation Distance Between Impulse Radios Using Impulse Signal Amplitude”;

U.S. patent application Ser. No. 09/537,264, filed on Mar. 29, 2000, entitled, “System and Method of Using Multiple Correlator Receivers in an Impulse Radio System”;

U.S. patent application Ser. No. 09/537,692, filed on Mar. 29, 2000, entitled, “Apparatus, System and Method for Flip Modulation in an Impulse Radio Communication System”;

U.S. patent application Ser. No. 09/538,292, filed on Mar. 29, 2000, now U.S. Pat. No. 6,556,621 (issued Apr. 29, 2003) and entitled, “System for Fast Lock and Acquisition of Ultra-Wideband Signals”; and

U.S. patent application Ser. No. 09/538,519, filed on Mar. 29, 2000, now U.S. Pat. No. 6,763,057 (issued Jul. 13, 2004) and entitled, “Vector Modulation System and Method for Wideband Impulse Radio Communications.” The present patent application incorporates by reference all of the above patent documents in their entirety.

For greater elaboration of impulse radio power control, see U.S. patent application Ser. No. 09/332,501, filed Jun. 14, 1999, now U.S. Pat. No. 6,539,213 (issued Mar. 25, 2003) and entitled “System and Method for Impulse Radio Power Control,” which is incorporated herein by reference.

To better understand the benefits of impulse radio to the present invention, a description of impulse radio and related topics follows.

Impulse Radio Basics

Impulse radio typically refers to a radio system based on short, low duty cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Most waveforms with enough bandwidth approximate a Gaussian shape to a useful degree.

Impulse radio can use many types of modulation, including AM, time shift (also referred to as pulse position) and M-ary versions. The time shift method has simplicity and power output advantages that make it desirable. In this document, the time shift method is used as an illustrative example.

In impulse radio communications, the pulse-to-pulse interval can be varied on a pulse-by-pulse basis by two components: an information component and a code component. Generally, conventional spread spectrum systems employ codes to spread the normally narrow band information signal over a relatively wide band of frequencies. A conventional spread spectrum receiver correlates these signals to retrieve the original information signal. Unlike conventional spread spectrum systems, in impulse radio communications codes are not needed for energy spreading because the monocycle pulses themselves have an inherently wide bandwidth. Instead, codes are used for channelization, energy smoothing in the frequency domain, resistance to interference, and reducing the interference potential to nearby receivers.

The impulse radio receiver is typically a direct conversion receiver with a cross correlator front end which coherently converts an electromagnetic pulse train of monocycle pulses to a baseband signal in a single stage. The baseband signal is the basic information signal for the impulse radio communications system. It is often found desirable to include a subcarrier with the baseband signal to help reduce the effects of amplifier drift and low frequency noise. The subcarrier that is typically implemented alternately reverses modulation according to a known pattern at a rate faster than the data rate. This same pattern is used to reverse the process and restore the original data pattern just before detection. This method permits alternating current (AC) coupling of stages, or equivalent signal processing to eliminate direct current (DC) drift and errors from the detection process. This method is described in detail in U.S. Pat. No. 5,677,927 to Fullerton et al.

In impulse radio communications utilizing time shift modulation, each data bit typically time position modulates many pulses of the periodic timing signal. This yields a modulated, coded timing signal that comprises a train of pulses for each single data bit. The impulse radio receiver integrates multiple pulses to recover the transmitted information.

Waveforms

Impulse radio typically refers to a radio system based on short, low duty cycle pulses. In the widest bandwidth embodiment, the resulting waveform approaches one cycle per pulse at the center frequency. In more narrow band embodiments, each pulse consists of a burst of cycles usually with some spectral shaping to control the bandwidth to meet desired properties such as out of band emissions or in-band spectral flatness, or time domain peak power or burst off time attenuation.

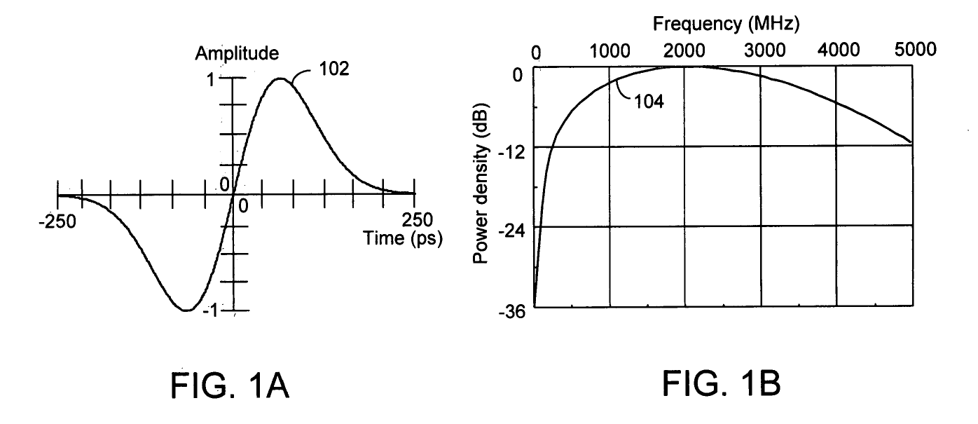

For system analysis purposes, it is convenient to model the desired waveform in an ideal sense to provide insight into the optimum behavior for detail design guidance. One such waveform model that has been useful is the Gaussian monocycle as shown in FIG. 1A. The basic equation normalized to a peak value of 1 is as follows:

$${f}_{mono} ( t ) = \sqrt{e} ( \frac{t}{σ} ) {ⅇ}^{\frac{- {t}^{2}}{2 {σ}^{2}}}$$

Where,

σ is a time scaling parameter,

t is time,

fₘₒₙₒ(t) is the waveform voltage, and

e is the natural logarithm base.

The frequency domain spectrum of the above waveform is shown in FIG. 1B. The corresponding equation is:

$${F}_{mono} ( f ) = {( 2 π )}^{\frac{3}{2}} σ f {ⅇ}^{- 2 {( πσ f )}^{2}}$$

The center frequency (f_{c}) or frequency of peak spectral density is:

$${f}_{c} = \frac{1}{2 πσ}$$

These pulses, or bursts of cycles, may be produced by methods described in the patents referenced above or by other methods that are known to one of ordinary skill in the art. Any practical implementation will deviate from the ideal mathematical model by some amount. In fact, this deviation from ideal may be substantial and yet yield a system with acceptable performance. This is especially true for microwave implementations, where precise waveform shaping is difficult to achieve. These mathematical models are provided as an aid to describing ideal operation and are not intended to limit the invention. In fact, any burst of cycles that adequately fills a given bandwidth and has an adequate on-off attenuation ratio for a given application will serve the purpose of this invention.

A Pulse Train

Impulse radio systems can deliver one or more data bits per pulse; however, impulse radio systems more typically use pulse trains, not single pulses, for each data bit. As described in detail in the following example system, the impulse radio transmitter produces and outputs a train of pulses for each bit of information.

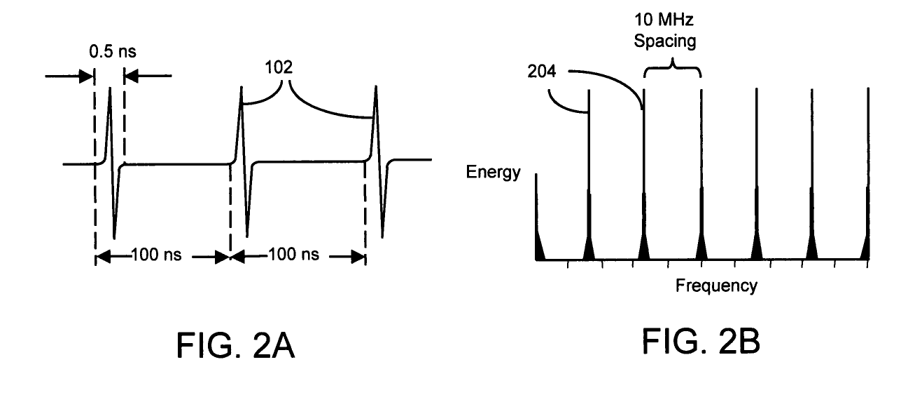

Prototypes have been built which have pulse repetition frequencies including 0.7 and 10 megapulses per second (Mpps, where each megapulse is 10⁶ pulses). FIGS. 2A and 2B are illustrations of the output of a typical 10 Mpps system with uncoded, unmodulated, 0.5 nanosecond (ns) pulses 102. FIG. 2A shows a time domain representation of this sequence of pulses 102. FIG. 2B, which shows 60 MHZ at the center of the spectrum for the waveform of FIG. 2A, illustrates that the result of the pulse train in the frequency domain is to produce a spectrum comprising a set of lines 204 spaced at the frequency of the 10 Mpps pulse repetition rate. When the full spectrum is shown, the envelope of the line spectrum follows the curve of the single pulse spectrum 104 of FIG. 1B. For this simple uncoded case, the power of the pulse train is spread among roughly two hundred comb lines. Each comb line thus has a small fraction of the total power and presents much less of an interference problem to a receiver sharing the band.

It can also be observed from FIG. 2A that impulse radio systems typically have very low average duty cycles resulting in average power significantly lower than peak power. The duty cycle of the signal in the present example is 0.5%, based on a 0.5 ns pulse in a 100 ns interval.

Coding for Energy Smoothing and Channelization

For high pulse rate systems, it may be necessary to more finely spread the spectrum than is achieved by producing comb lines. This may be done by non-uniformly positioning each pulse relative to its nominal position according to a code such as a pseudo random code.

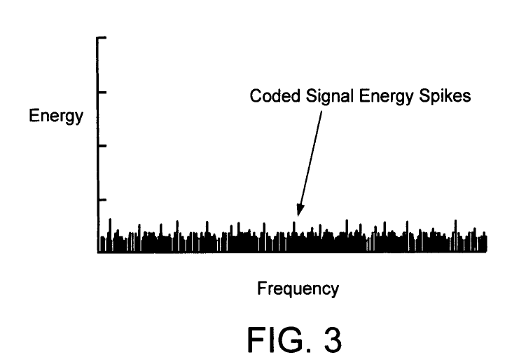

FIG. 3 is a plot illustrating the impact of a pseudo-noise (PN) code dither on energy distribution in the frequency domain (A pseudo-noise, or PN code is a set of time positions defining pseudo-random positioning for each pulse in a sequence of pulses). FIG. 3, when compared to FIG. 2B, shows that the impact of using a PN code is to destroy the comb line structure and spread the energy more uniformly. This structure typically has slight variations that are characteristic of the specific code used.

Coding also provides a method of establishing independent communication channels using impulse radio. Codes can be designed to have low cross correlation such that a pulse train using one code will seldom collide on more than one or two pulse positions with a pulses train using another code during any one data bit time. Since a data bit may comprise hundreds of pulses, this represents a substantial attenuation of the unwanted channel.

Modulation

Any aspect of the waveform can be modulated to convey information. Amplitude modulation, phase modulation, frequency modulation, time shift modulation and M-ary versions of these have been proposed. Both analog and digital forms have been implemented. Of these, digital time shift modulation has been demonstrated to have various advantages and can be easily implemented using a correlation receiver architecture.

Digital time shift modulation can be implemented by shifting the coded time position by an additional amount (that is, in addition to code dither) in response to the information signal. This amount is typically very small relative to the code shift. In a 10 Mpps system with a center frequency of 2 GHz, for example, the code may command pulse position variations over a range of 100 ns, whereas the information modulation may only deviate the pulse position by 150 ps.

Thus, in a pulse train of n pulses, each pulse is delayed a different amount from its respective time base clock position by an individual code delay amount plus a modulation amount, where n is the number of pulses associated with a given data symbol digital bit.

Modulation further smoothes the spectrum, minimizing structure in the resulting spectrum.

Reception and Demodulation

Clearly, if there were a large number of impulse radio users within a confined area, there might be mutual interference. Further, while coding minimizes that interference, as the number of users rises, the probability of an individual pulse from one user's sequence being received simultaneously with a pulse from another user's sequence increases. Impulse radios are able to perform in these environments, in part, because they do not depend on receiving every pulse. The impulse radio receiver performs a correlating, synchronous receiving function (at the RF level) that uses a statistical sampling and combining of many pulses to recover the transmitted information.

Impulse radio receivers typically integrate from 1 to 1000 or more pulses to yield the demodulated output. The optimal number of pulses over which the receiver integrates is dependent on a number of variables, including pulse rate, bit rate, interference levels, and range.

Interference Resistance

Besides channelization and energy smoothing, coding also makes impulse radios highly resistant to interference from all radio communications systems, including other impulse radio transmitters. This is critical as any other signals within the band occupied by an impulse signal potentially interfere with the impulse radio. Since there are currently no unallocated bands available for impulse systems, they must share spectrum with other conventional radio systems without being adversely affected. The code helps impulse systems discriminate between the intended impulse transmission and interfering transmissions from others.

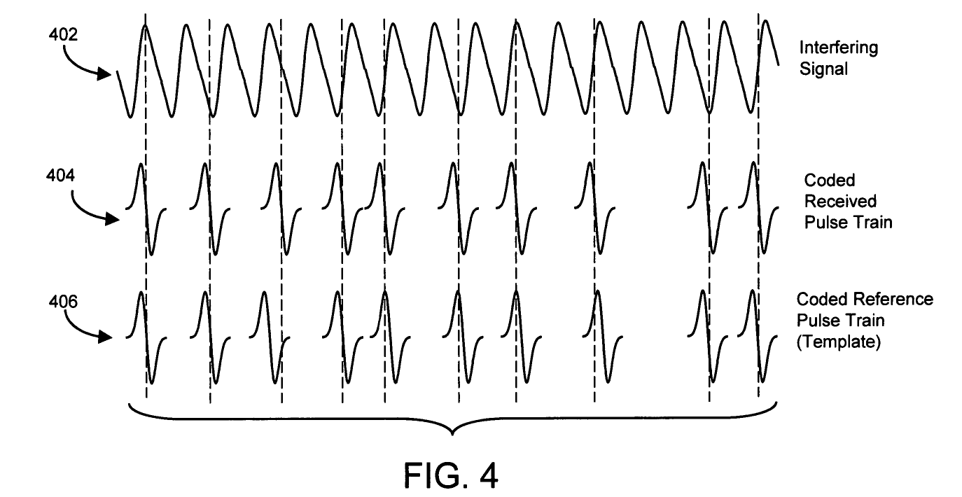

FIG. 4 illustrates the result of a narrow band sinusoidal interference signal 402 overlaying an impulse radio signal 404. At the impulse radio receiver, the input to the cross correlation would include the narrow band signal 402, as well as the received ultra-wideband impulse radio signal 404. The input is sampled by the cross correlator with a code dithered template signal 406. Without coding, the cross correlation would sample the interfering signal 402 with such regularity that the interfering signals could cause significant interference to the impulse radio receiver. However, when the transmitted impulse signal is encoded with the code dither (and the impulse radio receiver template signal 406 is synchronized with that identical code dither) the correlation samples the interfering signals non-uniformly. The samples from the interfering signal add incoherently, increasing roughly according to square root of the number of samples integrated; whereas, the impulse radio samples add coherently, increasing directly according to the number of samples integrated. Thus, integrating over many pulses overcomes the impact of interference.

Processing Gain

Impulse radio is resistant to interference because of its large processing gain. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000 or 30 dB. However, far greater processing gains are achieved by impulse radio systems, where the same 10 KHz information bandwidth is spread across a much greater 2 GHz channel bandwidth, resulting in a theoretical processing gain of 200,000 or 53 dB.

Capacity

It has been shown theoretically, using signal to noise arguments, that thousands of simultaneous voice channels are available to an impulse radio system as a result of the exceptional processing gain, which is due to the exceptionally wide spreading bandwidth.

For a simplistic user distribution, with N interfering users of equal power equidistant from the receiver, the total interference signal to noise ratio as a result of these other users can be described by the following equation:

$${V}_{tot}^{2} = \frac{N {σ}^{2}}{\sqrt{Z}}$$

Where V²ₜₒₜ is the total interference signal to noise ratio variance, at the receiver;

N is the number of interfering users;

σ² is the signal to noise ratio variance resulting from one of the interfering signals with a single pulse cross correlation; and

Z is the number of pulses over which the receiver integrates to recover the modulation.

This relationship suggests that link quality degrades gradually as the number of simultaneous users increases. It also shows the advantage of integration gain. The number of users that can be supported at the same interference level increases by the square root of the number of pulses integrated.

Multipath and Propagation

One of the striking advantages of impulse radio is its resistance to multipath fading effects. Conventional narrow band systems are typically subject to multipath fading such as Rayleigh or Ricean fading, where the signals from many delayed reflections combine at the receiver antenna according to their seemingly random relative phases. This results in possible summation or possible cancellation, depending on the specific propagation to a given location. This situation occurs where the direct path signal is weak relative to the multipath signals, which represents a major portion of the potential coverage of a radio system. In mobile systems, this results in wild signal strength fluctuations as a function of distance traveled, where the changing mix of multipath signals results in signal strength fluctuations for every few feet of travel.

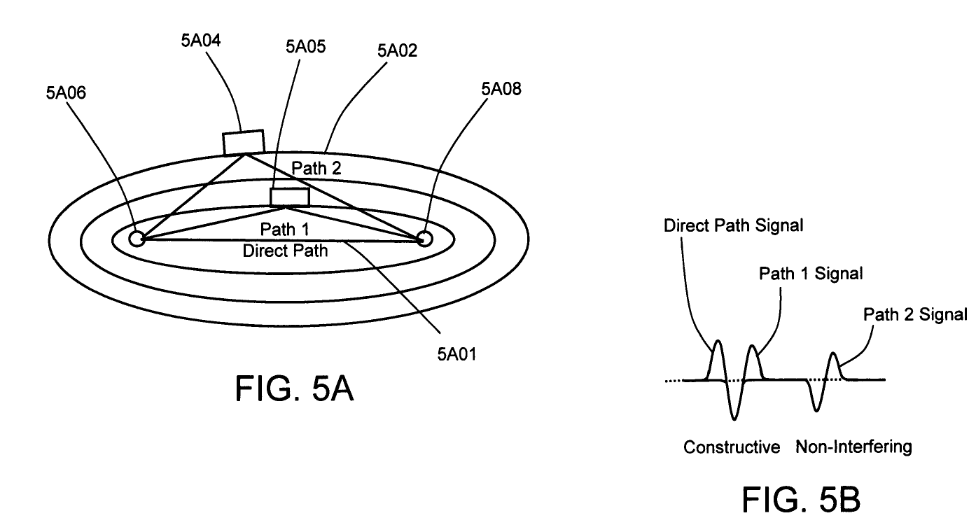

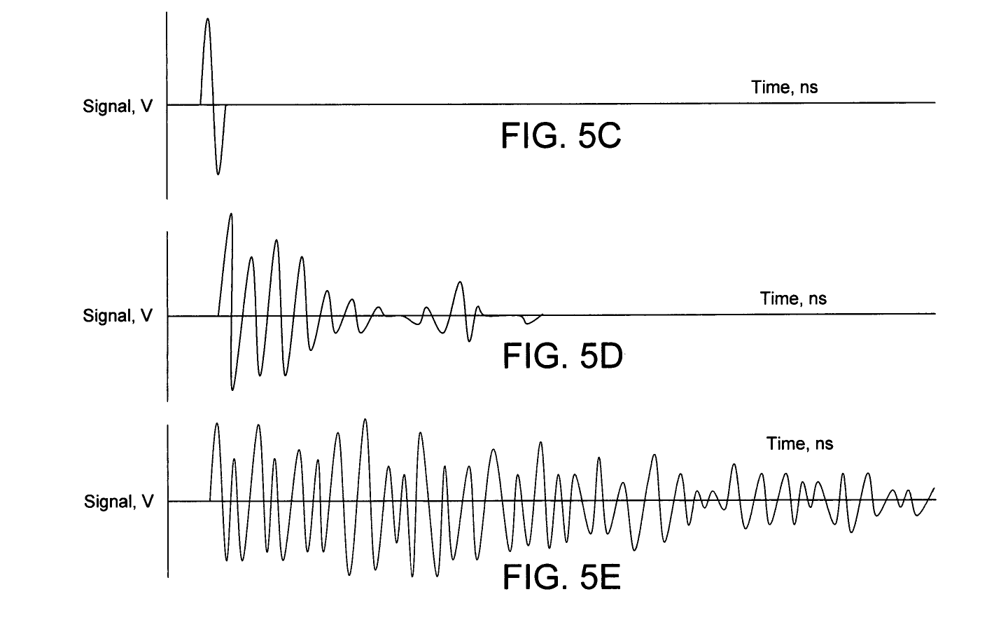

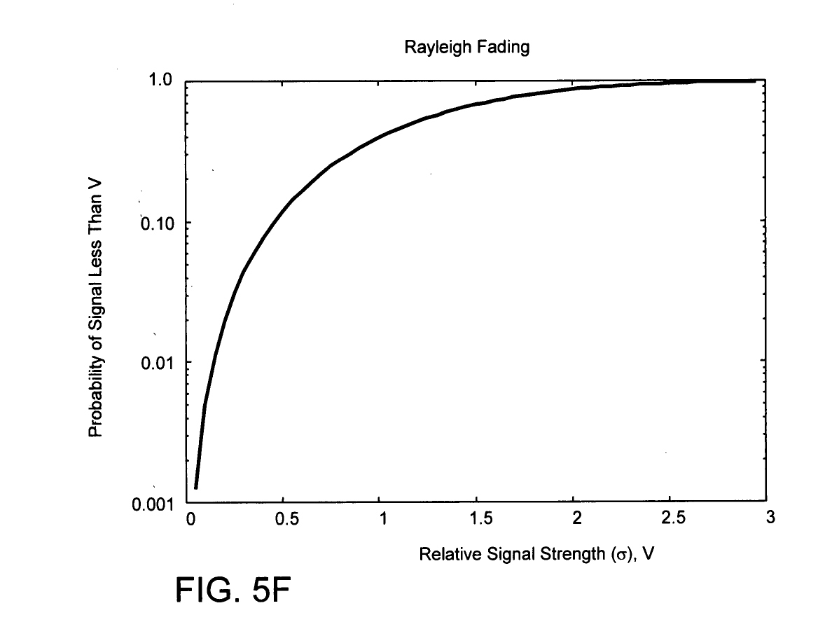

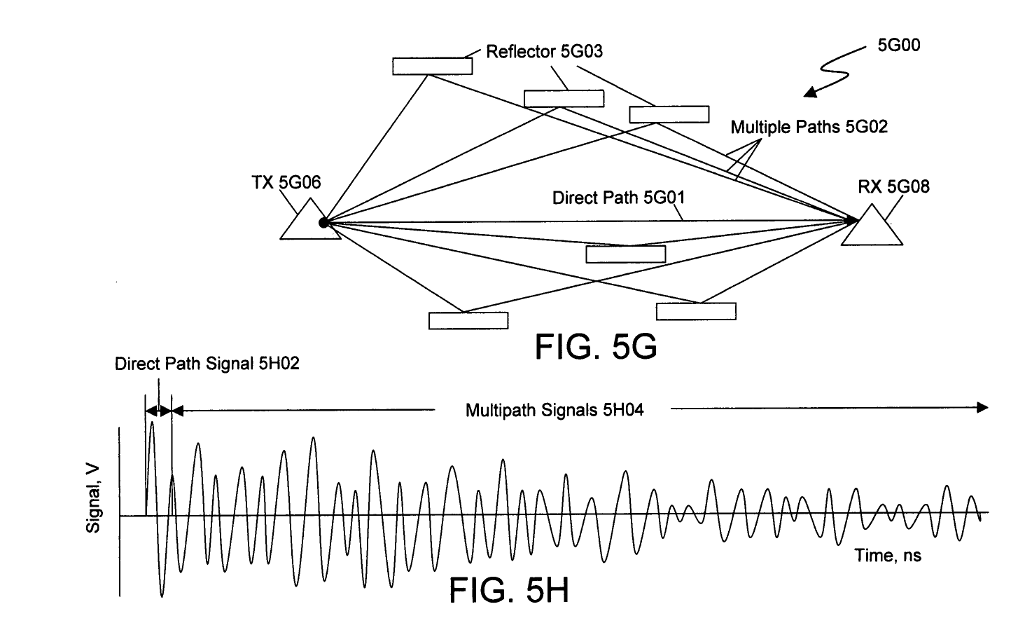

Impulse radios, however, can be substantially resistant to these effects. Impulses arriving from delayed multipath reflections typically arrive outside of the correlation time and thus can be ignored. This process is described in detail with reference to FIGS. 5A and 5B. In FIG. 5A, three propagation paths are shown. The direct path representing the straight-line distance between the transmitter and receiver is the shortest. Path 1 represents a grazing multipath reflection, which is very close to the direct path. Path 2 represents a distant multipath reflection. Also shown are elliptical (or, in space, ellipsoidal) traces that represent other possible locations for reflections with the same time delay.

FIG. 5B represents a time domain plot of the received waveform from this multipath propagation configuration. This figure comprises three doublet pulses as shown in FIG. 1A. The direct path signal is the reference signal and represents the shortest propagation time. The path 1 signal is delayed slightly and actually overlaps and enhances the signal strength at this delay value. Note that the reflected waves are reversed in polarity. The path 2 signal is delayed sufficiently that the waveform is completely separated from the direct path signal. If the correlator template signal is positioned at the direct path signal, the path 2 signal will produce no response. It can be seen that only the multipath signals resulting from very close reflectors have any effect on the reception of the direct path signal. The multipath signals delayed less than one quarter wave (one quarter wave is about 1.5 inches, or 3.5 cm at 2 GHz center frequency) are the only multipath signals that can attenuate the direct path signal. This region is equivalent to the first Fresnel zone familiar to narrow band systems designers. Impulse radio, however, has no further nulls in the higher Fresnel zones. The ability to avoid the highly variable attenuation from multipath gives impulse radio significant performance advantages.

FIG. 5A illustrates a typical multipath situation, such as in a building, where there are many reflectors 5A04, 5A05 and multiple propagation paths 5A02, 5A01. In this figure, a transmitter TX 5A06 transmits a signal that propagates along the multiple propagation paths 5A02, 5A04 to receiver RX 5A08, where the multiple reflected signals are combined at the antenna.

FIG. 5B illustrates a resulting typical received composite pulse waveform resulting from the multiple reflections and multiple propagation paths 5A01, 5A02. In this figure, the direct path signal 5A01 is shown as the first pulse signal received. The multiple reflected signals (“multipath signals”, or “multipath”) comprise the remaining response as illustrated.

FIGS. 5C, 5D, and 5E represent the received signal from an UWB transmitter in three different multipath environments. These figures are not actual signal plots, but are hand drawn plots approximating typical signal plots. FIG. 5C illustrates the received signal in a very low multipath environment. This may occur in a building where the receiver antenna is in the middle of a room and is one meter from the transmitter. This may also represent signals received from some distance, such as 100 meters, in an open field where there are no objects to produce reflections. In this situation, the predominant pulse is the first received pulse and the multipath reflections are too weak to be significant. FIG. 5D illustrates an intermediate multipath environment. This approximates the response from one room to the next in a building. The amplitude of the direct path signal is less than in FIG. 5C and several reflected signals are of significant amplitude. FIG. 5E approximates the response in a severe multipath environment such as: propagation through many rooms; from corner to corner in a building; within a metal cargo hold of a ship; within a metal truck trailer; or within an intermodal shipping container. In this scenario, the main path signal is weaker than in FIG. 5D. In this situation, the direct path signal power is small relative to the total signal power from the reflections.

An impulse radio receiver can receive the signal and demodulate the information using either the direct path signal or any multipath signal peak having sufficient signal to noise ratio. Thus, the impulse radio receiver can select the strongest response from among the many arriving signals. In order for the signals to cancel and produce a null at a given location, dozens of reflections would have to be cancelled simultaneously and precisely while blocking the direct path—a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal to noise performance.

Where the system of FIG. 5A is a narrow band system and the delays are small relative to the data bit time, the received signal is a sum of a large number of sine waves of random amplitude and phase. In the idealized limit, a Rayleigh probability distribution is as follows:

$$p ( r ) = \frac{r}{{σ}^{2}} exp ( \frac{- {r}^{2}}{2 {σ}^{2}} )$$

where r is the envelope amplitude of the combined multipath signals, and 2σ² is the RMS power of the combined multipath signals.

This distribution is shown in FIG. 5F. It can be seen in FIG. 5F that 10% of the time, the signal is more than 10 dB attenuated. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in the urban canyon or other situations where the propagation is such that the received signal is primarily scattered energy, impulse radio, according to the present invention, can avoid the Rayleigh fading mechanism that limits performance of narrow band systems. This is illustrated in FIGS. 5G and 5H in a transmit and receive system in a high multipath environment 5G00, wherein the transmitter 5G06 transmits to receiver 5G08 with the signals reflecting off reflectors 5G03 which form multipaths 5G02. The direct path is illustrated as 5G01 with the signal graphically illustrated at 5H02, with the vertical axis being the signal strength in volts and horizontal axis representing time in nanoseconds. Multipath signals are graphically illustrated at 5H04.

Distance Measurement

Important for positioning, impulse systems can measure distances to extremely fine resolution because of the absence of ambiguous cycles in the waveform. Narrow band systems, on the other hand, are limited to the modulation envelope and cannot easily distinguish precisely which RF cycle is associated with each data bit because the cycle-to-cycle amplitude differences are so small they are masked by link or system noise. Since the impulse radio waveform has no multi-cycle ambiguity, this allows positive determination of the waveform position to less than a wavelength—potentially, down to the noise floor of the system. This time position measurement can be used to measure propagation delay to determine link distance, and once link distance is known, to transfer a time reference to an equivalently high degree of precision. The inventors of the present invention have built systems that have shown the potential for centimeter distance resolution, which is equivalent to about 30 ps of time transfer resolution. See, for example, U.S. Pat. No. 6,111,536 (issued Aug. 29, 2000), U.S. Pat. No. 6,133,876 (issued Oct. 17, 2000), U.S. Pat. No. 6,295,019 (issued Sep. 25, 2001), U.S. Pat. No. 6,297,773 (issued Oct. 2, 2001), and U.S. Pat. No. 6,300,903 (issued Oct. 9, 2001), all of which are incorporated herein by reference.

In addition to the methods articulated above, impulse radio technology along with Time Division Multiple Access algorithms and Time Domain packet radios can achieve geo-positioning capabilities in a radio network. This geo-positioning method allows ranging to occur within a network of radios without the necessity of a full duplex exchange among every pair of radios.

Exemplary Transceiver Implementation

Transmitter

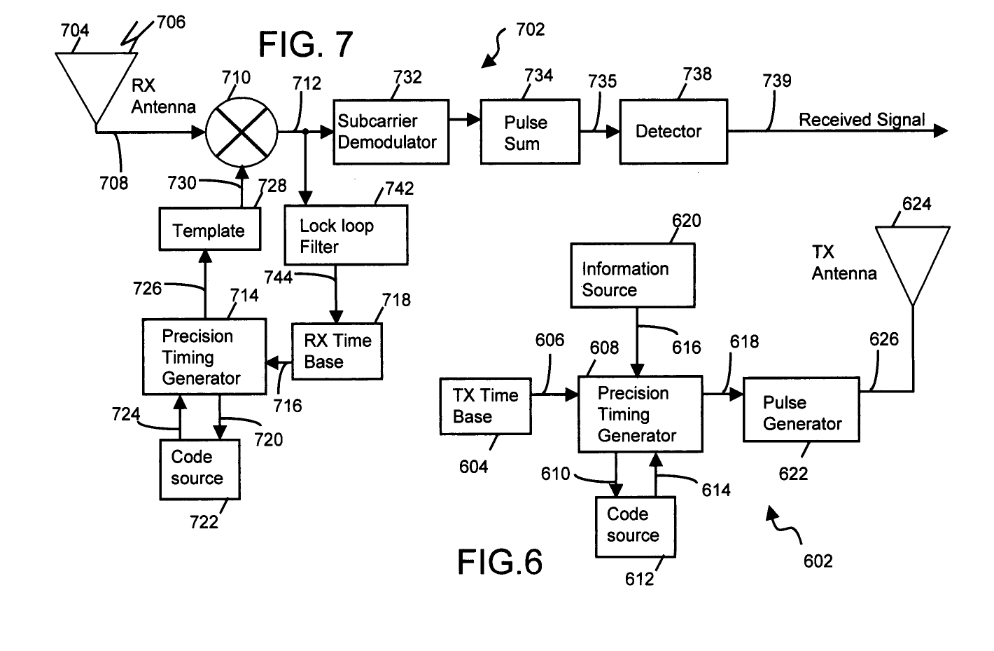

An exemplary embodiment of an impulse radio transmitter 602 of an impulse radio communication system having one subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The voltage control to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614 together with an internally generated subcarrier signal (which is optional) and an information signal 616 to generate a modulated, coded timing signal 618. The code source 612 comprises a storage device such as a random access memory (RAM), read only memory (ROM), or the like, for storing suitable codes and for outputting the PN codes as a code signal 614. Alternatively, maximum length shift registers or other computational means can be used to generate the codes.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger to generate output pulses. The output pulses are sent to a transmit antenna 624 via a transmission line 626 coupled thereto. The output pulses are converted into propagating electromagnetic pulses by the transmit antenna 624. In the present embodiment, the electromagnetic pulses are called the emitted signal, and propagate to an impulse radio receiver 702, such as shown in FIG. 7, through a propagation medium, such as air, in a radio frequency embodiment. In a preferred embodiment, the emitted signal is wide-band or ultra-wideband, approaching a monocycle pulse as in FIG. 1A. However, the emitted signal can be spectrally modified by filtering of the pulses. This bandpass filtering will cause each monocycle pulse to have more zero crossings (more cycles) in the time domain. In this case, the impulse radio receiver can use a similar waveform as the template signal in the cross correlator for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710 via a receiver transmission line, coupled to the receive antenna 704, and producing a baseband output 712.

The receiver 702 also includes a precision timing generator 714, which receives a periodic timing signal 716 from a receiver time base 718. This time base 718 is adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 ideally comprises a multiplier followed by a short term integrator to sum the multiplier product over the pulse interval.

The output of the correlator 710 is coupled to a subcarrier demodulator 732, which demodulates the subcarrier information signal from the subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to determine an output signal 739 representing the digital state of the output voltage of sample and hold 736.

The baseband signal 712 is also input to a low-pass filter 742 (also referred to as lock loop filter 742). A control loop comprising the low-pass filter 742, time base 718, precision timing generator 714, template generator 728, and correlator 710 is used to generate an error signal 744. The error signal 744 provides adjustments to the adjustable time base 718 to time position the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

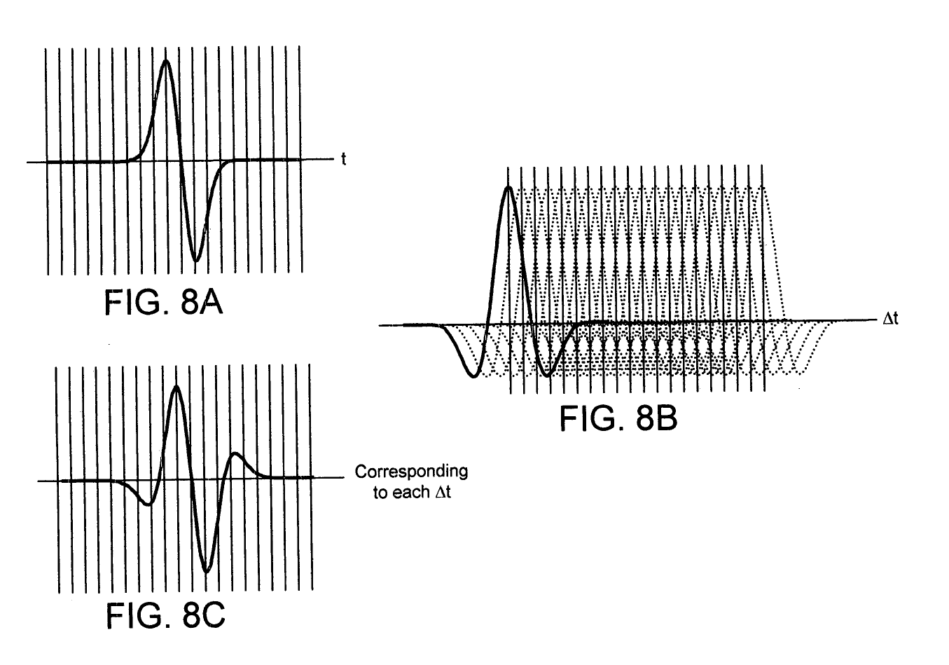

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the correlator (multiplier and short time integrator) for each of the time offsets of FIG. 8B. Thus, this graph does not show a waveform that is a function of time, but rather a function of time-offset. For any given pulse received, there is only one corresponding point that is applicable on this graph. This is the point corresponding to the time offset of the template signal used to receive that pulse. Further examples and details of precision timing can be found described in U.S. Pat. No. 5,677,927 (issued Oct. 14, 1997) and U.S. Pat. No. 6,304,623 (issued Oct. 16, 2001) both of which are incorporated herein by reference.

Recent Advances in Impulse Radio Communication

Modulation Techniques

To improve the placement and modulation of pulses and to find new and improved ways that those pulses transmit information, various modulation techniques have been developed. The modulation techniques articulated above as well as the recent modulation techniques invented and summarized below are incorporated herein by reference.

FLIP Modulation

An impulse radio communications system can employ FLIP modulation techniques to transmit and receive flip modulated impulse radio signals. Further, it can transmit and receive flip with shift modulated (also referred to as quadrature flip time modulated (QFTM)) impulse radio signals. Thus, FLIP modulation techniques can be used to create two, four, or more different data states.

Flip modulators include an impulse radio receiver with a time base, a precision timing generator, a template generator, a delay, first and second correlators, a data detector and a time base adjustor. The time base produces a periodic timing signal that is used by the precision timing generator to produce a timing trigger signal. The template generator uses the timing trigger signal to produce a template signal. A delay receives the template signal and outputs a delayed template signal. When an impulse radio signal is received, the first correlator correlates the received impulse radio signal with the template signal to produce a first correlator output signal, and the second correlator correlates the received impulse radio signal with the delayed template signal to produce a second correlator output signal. The data detector produces a data signal based on at least the first correlator output signal. The time base adjustor produces a time base adjustment signal based on at least the second correlator output signal. The time base adjustment signal is used to synchronize the time base with the received impulse radio signal.

For greater elaboration of FLIP modulation techniques, the reader is directed to the patent application entitled, “Apparatus, System and Method for FLIP Modulation in an Impulse Radio Communication System”, U.S. patent application Ser. No. 09/537,692, filed Mar. 29, 2000. This patent application is incorporated herein by reference.

Vector Modulation

Vector Modulation is a modulation technique which includes the steps of generating and transmitting a series of time-modulated pulses, each pulse delayed by one of four pre-determined time delay periods and representative of at least two data bits of information, and receiving and demodulating the series of time-modulated pulses to estimate the data bits associated with each pulse. The apparatus includes an impulse radio transmitter and an impulse radio receiver.

The transmitter transmits the series of time-modulated pulses and includes a transmitter time base, a time delay modulator, a code time modulator, an output stage, and a transmitting antenna. The receiver receives and demodulates the series of time-modulated pulses using a receiver time base and two correlators, one correlator designed to operate after a pre-determined delay with respect to the other correlator. Each correlator includes an integrator and a comparator, and may also include an averaging circuit that calculates an average output for each correlator, as well as a track and hold circuit for holding the output of the integrators. The receiver further includes an adjustable time delay circuit that may be used to adjust the pre-determined delay between the correlators in order to improve detection of the series of time-modulated pulses.

For greater elaboration of Vector modulation techniques, the reader is directed to the patent application entitled, “Vector Modulation System and Method for Wideband Impulse Radio Communications”, U.S. patent application Ser. No. 09/169,765, filed Dec. 9, 1999. This patent application is incorporated herein by reference.

Receivers

Because of the unique nature of impulse radio receivers several modifications have been recently made to enhance system capabilities.

Multiple Correlator Receivers

Multiple correlator receivers utilize multiple correlators that precisely measure the impulse response of a channel and wherein measurements can extend to the maximum communications range of a system, thus, not only capturing ultra-wideband propagation waveforms, but also information on data symbol statistics. Further, multiple correlators enable rake acquisition of pulses and thus faster acquisition, tracking implementations to maintain lock and enable various modulation schemes. Once a tracking correlator is synchronized and locked to an incoming signal, the scanning correlator can sample the received waveform at precise time delays relative to the tracking point. By successively increasing the time delay while sampling the waveform, a complete, time-calibrated picture of the waveform can be collected.

For greater elaboration of utilizing multiple correlator techniques, the reader is directed to the patent application entitled, “System and Method of using Multiple Correlator Receivers in an Impulse Radio System”, U.S. patent application Ser. No. 09/537,264, filed Mar. 29, 2000. This patent application is incorporated herein by reference.

Fast Locking Mechanisms

Methods to improve the speed at which a receiver can acquire and lock onto an incoming impulse radio signal have been developed. In one approach, a receiver comprises an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in detail in U.S. Pat. No. 5,832,035 to Fullerton, incorporated herein by reference.

In another approach, a receiver obtains a template pulse train and a received impulse radio signal. The receiver compares the template pulse train and the received impulse radio signal to obtain a comparison result. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, the reader is directed to the patent application entitled, “Method and System for Fast Acquisition of Ultra Wideband Signals”, U.S. patent application Ser. No. 09/538,292, filed Mar. 29, 2000, now U.S. Pat. No. 6,556,621, issued Apr. 29, 2003. This patent application is incorporated herein by reference.

Baseband Signal Converters

A receiver has been developed which includes a baseband signal converter device and combines multiple converter circuits and an RF amplifier in a single integrated circuit package. Each converter circuit includes an integrator circuit that integrates a portion of each RF pulse during a sampling period triggered by a timing pulse generator. The integrator capacitor is isolated by a pair of Schottky diodes connected to a pair of load resistors. A current equalizer circuit equalizes the current flowing through the load resistors when the integrator is not sampling. Current steering logic transfers load current between the diodes and a constant bias circuit depending on whether a sampling pulse is present.

For greater elaboration of utilizing baseband signal converters, the reader is directed to the patent application entitled, “Baseband Signal Converter for a Wideband Impulse Radio Receiver”, U.S. patent application Ser. No. 09/356,384, filed Jul. 16, 1999, now U.S. Pat. No. 6,421,389, issued Jul. 16, 2002. This patent application is incorporated herein by reference.

Power Control and Interference

Power Control

Power control improvements have been invented with respect to impulse radios. The power control systems comprise a first transceiver that transmits an impulse radio signal to a second transceiver. A power control update is calculated according to a performance measurement of the signal received at the second transceiver. The transmitter power of either transceiver, depending on the particular embodiment, is adjusted according to the power control update. Various performance measurements are employed according to the current invention to calculate a power control update, including bit error rate, signal-to-noise ratio, and received signal strength, used alone or in combination. Interference is thereby reduced, which is particularly important where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of utilizing baseband signal converters, the reader is directed to the patent application entitled, “System and Method for Impulse Radio Power Control”, U.S. patent application Ser. No. 09/332,501, filed Jun. 14, 1999, now U.S. Pat. No. 6,539,213, issued Mar. 25, 2003. This patent application is incorporated herein by reference.

Mitigating Effects of Interference

To assist in mitigating interference to impulse radio systems a methodology has been invented. The method comprises the steps of: (a) conveying the message in packets; (b) repeating conveyance of selected packets to make up a repeat package; and (c) conveying the repeat package a plurality of times at a repeat period greater than twice the occurrence period of the interference. The communication may convey a message from a proximate transmitter to a distal receiver, and receive a message by a proximate receiver from a distal transmitter. In such a system, the method comprises the steps of: (a) providing interference indications by the distal receiver to the proximate transmitter; (b) using the interference indications to determine predicted noise periods; and (c) operating the proximate transmitter to convey the message according to at least one of the following: (1) avoiding conveying the message during noise periods; (2) conveying the message at a higher power during noise periods; (3) increasing error detection coding in the message during noise periods; (4) re-transmitting the message following noise periods; (5) avoiding conveying the message when interference is greater than a first strength; (6) conveying the message at a higher power when the interference is greater than a second strength; (7) increasing error detection coding in the message when the interference is greater than a third strength; and (8) re-transmitting a portion of the message after interference has subsided to less than a predetermined strength.

For greater elaboration of mitigating interference to impulse radio systems, the reader is directed to the patent application entitled, “Method for Mitigating Effects of Interference in Impulse Radio Communication”, U.S. patent application Ser. No. 09/587,033, filed Jun. 2, 2000. This patent application is incorporated herein by reference.

Moderating Interference while Controlling Equipment

Yet another improvement to impulse radio includes moderating interference with impulse radio wireless control of an appliance; the control is affected by a controller remote from the appliance transmitting impulse radio digital control signals to the appliance. The control signals have a transmission power and a data rate. The method comprises the steps of: (a) in no particular order: (1) establishing a maximum acceptable noise value for a parameter relating to interfering signals; (2) establishing a frequency range for measuring the interfering signals; (b) measuring the parameter for the interference signals within the frequency range; and (c) when the parameter exceeds the maximum acceptable noise value, effecting an alteration of transmission of the control signals.

For greater elaboration of moderating interference while effecting impulse radio wireless control of equipment, the reader is directed to the patent application entitled, “Method and Apparatus for Moderating Interference While Effecting Impulse Radio Wireless Control of Equipment”, U.S. patent application Ser. No. 09/586,163, filed Jun. 2, 1999, now U.S. Pat. No. 6,571,089 issued May 27, 2000. This patent application is incorporated herein by reference.

Coding Advances

The improvements made in coding can directly improve the characteristics of impulse radio as used in the present invention. Specialized coding techniques may be employed to establish temporal and/or non-temporal pulse characteristics such that a pulse train will possess desirable properties. Coding methods for specifying temporal and non-temporal pulse characteristics are described in applications entitled “A Method and Apparatus for Positioning Pulses in Time”, U.S. patent application Ser. No. 09/592,249, and “A Method for Specifying Non-Temporal Pulse Characteristics”, U.S. patent application Ser. No. 09/592,250, both filed Jun. 12, 2000, and both of which are incorporated herein by reference. Essentially, a temporal or non-temporal pulse characteristic value layout is defined, an approach for mapping a code to the layout is specified, a code is generated using a numerical code generation technique, and the code is mapped to the defined layout per the specified mapping approach.

A temporal or non-temporal pulse characteristic value layout may be fixed or non-fixed and may involve value ranges, discrete values, or a combination of value ranges and discrete values. A value range layout specifies a range of values for a pulse characteristic that is divided into components that are each subdivided into subcomponents, which can be further subdivided, ad infinitum. In contrast, a discrete value layout involves uniformly or non-uniformly distributed discrete pulse characteristic values. A non-fixed layout (also referred to as a delta layout) involves delta values relative to some reference value such as the characteristic value of the preceding pulse. Fixed and non-fixed layouts, and approaches for mapping code element values to them, are described in applications, entitled “Method for Specifying Pulse Characteristics using Codes”, U.S. patent application Ser. No. 09/592,290 and “A Method and Apparatus for Mapping Pulses to a Non-Fixed Layout”, U.S. patent application Ser. No. 09/591,691, both filed on Jun. 12, 2000 and both of which are incorporated herein by reference.

A fixed or non-fixed characteristic value layout may include one or more non-allowable regions within which a characteristic value of a pulse is not allowed. A method for specifying non-allowable regions to prevent code elements from mapping to non-allowed characteristic values is described in application entitled “A Method for Specifying Non-Allowable Pulse Characteristics”, U.S. patent application Ser. No. 09/592,289, filed Jun. 12, 2000, now U.S. Pat. No. 6,636,567 (issued Oct. 21, 2003) and incorporated herein by reference. A related method that conditionally positions pulses depending on whether or not code elements map to non-allowable regions is described in application, entitled “A Method and Apparatus for Positioning Pulses Using a Layout having Non-Allowable Regions”, U.S. patent application Ser. No. 09/592,248 and incorporated herein by reference.

Typically, a code consists of a number of code elements having integer or floating-point values. A code element value may specify a single pulse characteristic (e.g., pulse position in time) or may be subdivided into multiple components, each specifying a different pulse characteristic. For example, a code having seven code elements each subdivided into five components (c0-c4) could specify five different characteristics of seven pulses. A method for subdividing code elements into components is described in application entitled “Method for Specifying Pulse Characteristics using Codes”, U.S. patent application Ser. No. 09/592,290, filed Jun. 12, 2000 previously incorporated herein by reference. Essentially, the value of each code element or code element component (if subdivided) maps to a value range or discrete value within the defined characteristic value layout. If a value range layout is used an offset value is typically employed to specify an exact value within the value range mapped to by the code element or code element component.

The signal of a coded pulse train can be generally expressed:

$${s}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, cⱼ^{(k)}, and bⱼ^{(k)} are the coded polarity, amplitude, width, and waveform of the jth pulse of the kth transmitter, and Tⱼ^{(k)} is the coded time shift of the jth pulse of the kth transmitter. Note that when a given non-temporal characteristic does not vary (i.e., remains constant for all pulses in the pulse train), the corresponding code element component is removed from the above expression and the non-temporal characteristic value becomes a constant in front of the summation sign.

Various numerical code generation methods can be employed to produce codes having certain correlation and spectral properties. Such codes typically fall into one of two categories: designed codes and pseudorandom codes.

A designed code may be generated using a quadratic congruential, hyperbolic congiuential, linear congruential, Costas array or other such numerical code generation technique designed to generate codes guaranteed to have certain correlation properties. Each of these alternative code generation techniques has certain characteristics to be considered in relation to the application of the pulse transmission system employing the code. For example, Costas codes have nearly ideal autocorrelation properties but somewhat less than ideal cross-correlation properties, while linear congruential codes have nearly ideal cross-correlation properties but less than ideal autocorrelation properties. In some cases, design tradeoffs may require that a compromise between two or more code generation techniques be made such that a code is generated using a combination of two or more techniques. An example of such a compromise is an extended quadratic congruential code generation approach that uses two ‘independent’ operators, where the first operator is linear and the second operator is quadratic. Accordingly, one, two, or more code generation techniques or combinations of such techniques can be employed to generate a code without departing from the scope of the invention.

A pseudorandom code may be generated using a computer's random number generator, binary shift-register(s) mapped to binary words, a chaotic code generation scheme, or another well-known technique. Such ‘random-like’ codes are attractive for certain applications since they tend to spread spectral energy over multiple frequencies while having ‘good enough’ correlation properties, whereas designed codes may have superior correlation properties but have spectral properties that may not be as suitable for a given application.

Computer random number generator functions commonly employ the linear congruential generation (LCG) method or the Additive Lagged-Fibonacci Generator (ALFG) method. Alternative methods include inversive congruential generators, explicit-inversive congruential generators, multiple recursive generators, combined LCGs, chaotic code generators, and Optimal Golomb Ruler (OGR) code generators. Any of these or other similar methods can be used to generate a pseudorandom code without departing from the scope of the invention, as will be apparent to those skilled in the relevant art.

Detailed descriptions of code generation and mapping techniques are included in patent application entitled “A Method and Apparatus for Positioning Pulses in Time”, U.S. patent application Ser. No. 09/592,248, filed Jun. 12, 2000, which is incorporated herein by reference.

It may be necessary to apply predefined criteria to determine whether a generated code, code family, or a subset of a code is acceptable for use with a given UWB application. Criteria to consider may include correlation properties, spectral properties, code length, non-allowable regions, number of code family members, or other pulse characteristics. A method for applying predefined criteria to codes is described in application, entitled “A Method and Apparatus for Specifying Pulse Characteristics using a Code that Satisfies Predefined Criteria,” U.S. patent application Ser. No. 09/592,288, filed Jun. 12, 2000, now U.S. Pat. No. 6,636,566 (issued Oct. 21, 2003) and is incorporated herein by reference.

In some applications, it may be desirable to employ a combination of two or more codes. Codes may be combined sequentially, nested, or sequentially nested, and code combinations may be repeated. Sequential code combinations typically involve transitioning from one code to the next after the occurrence of some event. For example, a code with properties beneficial to signal acquisition might be employed until a signal is acquired, at which time a different code with more ideal channelization properties might be used. Sequential code combinations may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in desirable spectral properties. A method for applying code combinations is described in application, entitled “A Method and Apparatus for Applying Codes Having Pre-Defined Properties”, U.S. patent application Ser. No. 09/591,690, filed Jun. 12, 2000, now U.S. Pat. No. 6,671,310 (issued Dec. 30, 2003) which is incorporated herein by reference.

Impulse Radio Power Control

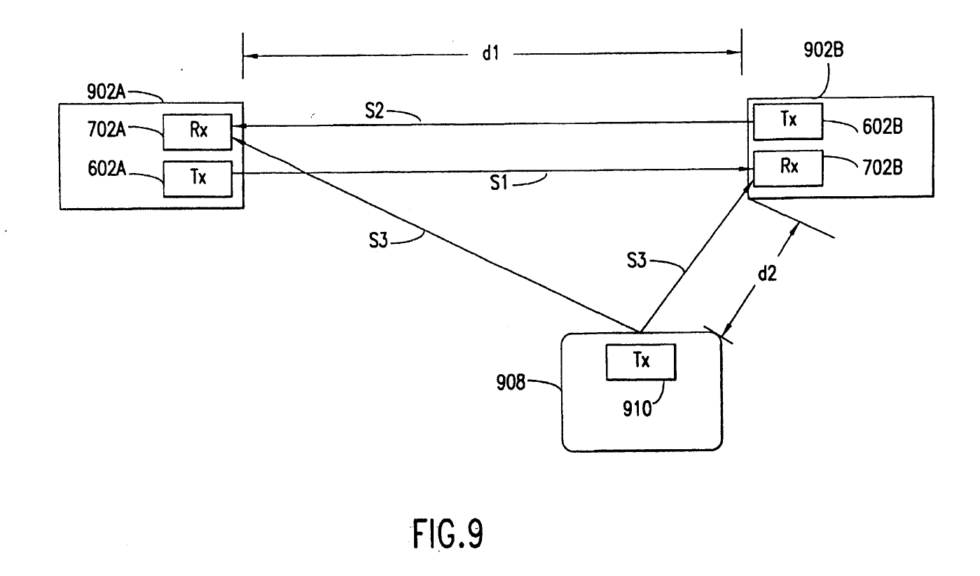

FIG. 9 depicts an example communications environment that uses impulse radio power control. Two or more impulse radio transceivers 902A, 902B communicate with one another, possibly in the presence of an interfering transmitter 908. Each transceiver 902A, 902B includes an impulse radio receiver 702 and an impulse radio transmitter 602. FIG. 9 depicts two transceivers 902A and 902B, separated by a distance d1. As shown, transmitter 602A transmits a signal S1 that is received by receiver 702B. Transmitter 602B transmits a signal S2 that is received by receiver 702A. Interfering transmitter 908, if present, transmits an interfering signal S3 that is received by both receiver 702A and receiver 702B. Interfering transmitter 908 is situated a distance d2 from transceiver 902B.

The output power of transmitters 602A, 602B is adjusted, according to a preferred embodiment of the present invention, based on a performance measurement(s) of the received signals. In one embodiment, the output power of transmitter 602B is adjusted based on a performance measurement of signal S2 as received by receiver 702A. In an alternative embodiment, the output power of transmitter 602B is adjusted based on a performance measurement of signal S1 received by receiver 702B. In both cases, the output power of transmitter 602B is increased when the performance measurement of the received signal drops below a threshold, and is decreased when the performance measurement rises above a threshold. Several alternative embodiments are described below for calculating this power control update.

Power control refers to the control of the output power of a transmitter. However, it is noted that this is usually implemented as a voltage control proportional to the output signal voltage.

Different measurements of performance can be used as the basis for calculating a power control update. As discussed in detail below, examples of such performance measurements include signal strength, signal-to-noise ratio (SNR), and bit error rate (BER), used either alone or in combination.

For the sake of clarity, FIG. 9 depicts two transceivers 902A, 902B in two-way communication with one another. Those skilled in the art will recognize that the principles discussed herein apply equally well to multiple transceivers 902 in communication with each other. Transceiver 902 can represent any transceiver employing impulse radio technology (for examples, see U.S. Pat. No. 5,677,927, incorporated by reference above). Transceiver 902 can be a hand-held unit, or mounted in some fashion, e.g., a transceiver mounted in a base station. For example, referring to FIG. 9, transceiver 902A can represent a hand-held phone communicating a transceiver 902B that is part of a base station. Alternatively, both transceivers 902A and 902B can represent hand-held phones communicating with each other. A plethora of further alternatives are envisioned.

Interfering transmitter 908 includes transmitter 910 that transmits electromagnetic energy in the same or a nearby frequency band as that used by transceivers 902A and 902B, thereby possibly interfering with the communications of transceivers 902A and 902B. Interfering transmitter 908 might also include a receiver, although the receiver function does not impact interference analysis. For example, interfering transmitter 908 could represent an impulse radio communicating with another impulse radio (not shown). Alternatively, interfering transmitter 908 could represent any arbitrary transmitter that transmits electromagnetic energy in some portion of the frequency spectrum used by transceivers 902. Those skilled in the art will recognize that many such transmitters can exist, given the ultra-wideband nature of the signals transmitted by transceivers 902.

For those environments where multiple impulse radios of similar design are operating in close geographic proximity, interference between the impulse radios is minimized by controlling the transmitter power in each transceiver according to the present invention. Consider the example environment depicted in FIG. 9 where interfering transmitter 908 represents an impulse radio transceiver similar in design to transceivers 902A and 902B. Lowering the output power of interfering transmitter 908 reduces the extent to which S3 interferes with the communication between transceivers 902A and 902B. Similarly, lowering the power of transmitters 602A and 602B reduces the extent to which S1 and S2 interfere with the communications of transmitter 908. According to the present invention, each transmitter (602A, 602B, and 910 in those situations where interfering transmitter 908 represents an impulse radio) maintains its output power to achieve a satisfactory signal reception. The present invention is therefore particularly well suited to a crowded impulse radio environment.

Power Control Process

Power Control Overview

Generally speaking, impulse radio power control methods utilize a performance measurement indicative of the quality of the communications process where the quality is power dependent. This quality measurement is compared with a quality reference in order to determine a power control update. Various performance measurements can be used, individually or in combination. Each has slightly different characteristics, which can be utilized in different combinations to construct an optimum system for a given application. Specific performance measurements that are discussed below include signal strength, signal to noise ratio (SNR), and bit error rate (BER). These performance measurements are discussed in an idealized embodiment. However, great accuracy is generally not required in the measurement of these values. Thus, signals approximating these quantities can be substituted as equivalent. Other performance measurements related to these or equivalent to these would be apparent to one skilled in the relevant art. Accordingly, the use of other measurements of performance are within the spirit and scope of the present invention.

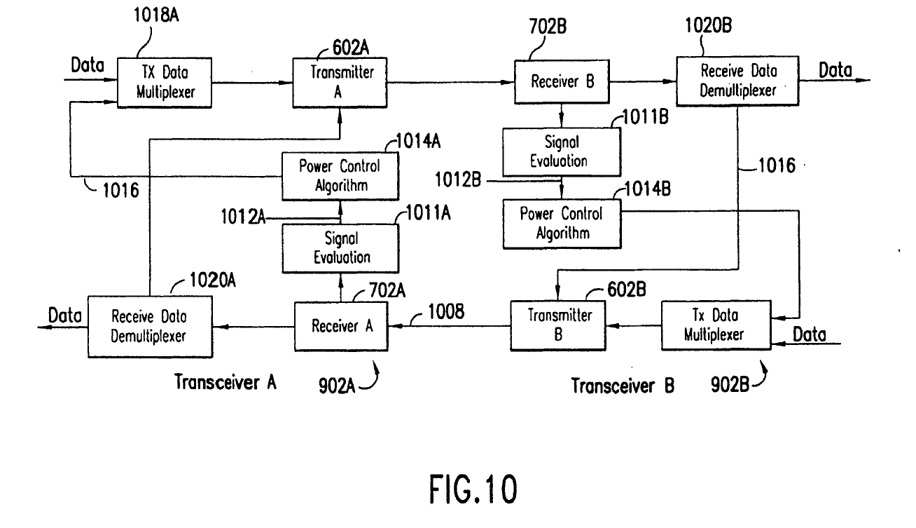

FIG. 10 illustrates a typical two transceiver system comprising transceiver 902A and transceiver 902B and utilizing power control according to an embodiment of the present invention. Referring to FIG. 10, receiver 702A receives the transmission 1008 from transmitter 602B of transceiver 902B. Signal evaluation function 1011A evaluates the signal quality, and quality measurement(s) 1012A are provided to the power control algorithm 1014A. Power control algorithm 1014A then determines a power control update 1016 according to the current received signal quality measurement(s) 1012A determined by signal evaluation function 1011A. This update 1016 is added to the signal data stream in the transmitter data multiplexer 1018A and then transmitted via transmitter 602A to transceiver 902B. Receiver 702B of transceiver 902B receives a data stream and demultiplexer 1020B separates the user data and power control command 1016, sending the power control command 1016 to transmitter 602B (or to power control function 1126 as discussed below in connection with FIG. 11). Transmitter 602B (or power control function 1126) then adjusts the transmission output level of signal 1008 according to the power control command, which is based on the received signal quality measurement(s) 1012A determined by transceiver 902A. A similar control loop operates to control transmitter 602A according to the received signal quality measurement(s) 1012B determined by signal evaluation function 1011B of transceiver 902B.

FIG. 11 illustrates a transceiver 902 modified to measure signal strength, SNR, and BER according to an embodiment of the present invention. According to this embodiment, an originating transmitter transmits the RF signal 706, which is received by the antenna 704. The resulting received signal 708 is then provided to the correlator 710 where it is multiplied according to the template signal 730 and then short term integrated (or alternatively sampled) to produce a baseband output 712. This baseband output is provided to the optional subcarrier demodulator 732, which demodulates a subcarrier as applied to the transmitted signal 706. This output is then long term integrated in the pulse summation stage 734, which is typically an integrate and dump stage that produces a ramp shape output waveform when the receiver 702 is receiving a transmitted signal 706, or is typically a random walk type waveform when receiving pure noise. This output 735 (after it is sampled by sample and hold state 736) is fed to a detector 738 having an output 739, which represents the detection of the logic state of the transmitted signal 706.

The output of the correlator 710 is also coupled to a lock loop comprising a lock loop filter 742, an adjustable time base 718, a precision timing generator 714, a template generator 728, and the correlator 710. The lock loop maintains a stable quiescent operating point on the correlation function in the presence of variations in the transmitter time base frequency and variations due to Doppler effects.

The adjustable time base 718 drives the precision timing generator 714, which provides timing to the code generator 722, which in turn, provides timing commands back to the timing generator 714 according to the selected code. The timing generator 714 then provides timing signals to the template generator 728 according to the timing commands, and the template generator 728 generates the proper template waveform 730 for the correlation process. Further examples and discussion of these processes can be found in the patents incorporated by reference above.

It is noted that coding is optional. Accordingly, it should be appreciated that the present invention covers non-coded implementations that do not incorporate code source 722.

Referring again to FIG. 11, the output 735 of the pulse summation stage 734 is sampled by the sample and hold stage 736 producing an output 1102 which is then processed by a signal evaluation stage 1011 that determines a measure of the signal strength 1106, received noise 1108, and SNR 1110. These values are passed to the power control algorithm 1014, which may combine this information with a BER measurement 1112 provided by a BER evaluation function 1116. The power control algorithm 1014 generates a power control update 1016 value according to one or more of the performance measurements. This value is combined with the information signal 616 and sent to the transceiver which is originating the received signal 706. One method of combining this information is to divide the data stream into time division blocks using a multiplexer 1018. A portion of the data stream 1122 contains user data (i.e., information signal 616) and a portion contains control information, which includes power control update information 1016. The combined data stream 1122 is then provided to the transmitter precision timing generator 608, which may optionally include a subcarrier modulation process. This timing generator is driven by a transmitter time base 604 and interfaces with a code generator 612, which provides pulse position commands according to a PN code. The timing generator 608 provides timing signals 618 to the pulse generator 622, which generates pulses 626 of proper amplitude and waveform according to the timing signals 618. These pulses are then transmitted by the antenna 624.

It is noted that BER 1112 is a measure of signal quality that is related to the ratio of error bits to the total number of bits transmitted. The use of other signal quality measurements, which are apparent to one skilled in the relevant art, are within the spirit and scope of the present invention.

It should be apparent to one of ordinary skill in the art that the system functions such as power command 1124 and power control 1126 can be implemented into either the transmitter 602 or receiver 702 of a transceiver, at the convenience of the designer. For example, power control 1126 is shown as being part of transmitter 602 in FIG. 10.

The transceiver originating the RF signal 706 has a similar architecture. Thus, the received data stream 739 contains both user data and power control commands, which are intended to control the pulse generator 622. These power control commands are selected from the data stream by a power command function 1124, which includes the function of receive data demultiplexer 1020, and delivered to a power control function 1126 that controls the output power of the pulse generator 622.

Impulse Radio Performance Measurements

The output 1102 of the sample and hold stage 736 is evaluated to determine signal performance criteria necessary for calculation of power control updates 1016. The signal performance criteria can include signal strength, noise, SNR and/or BER.

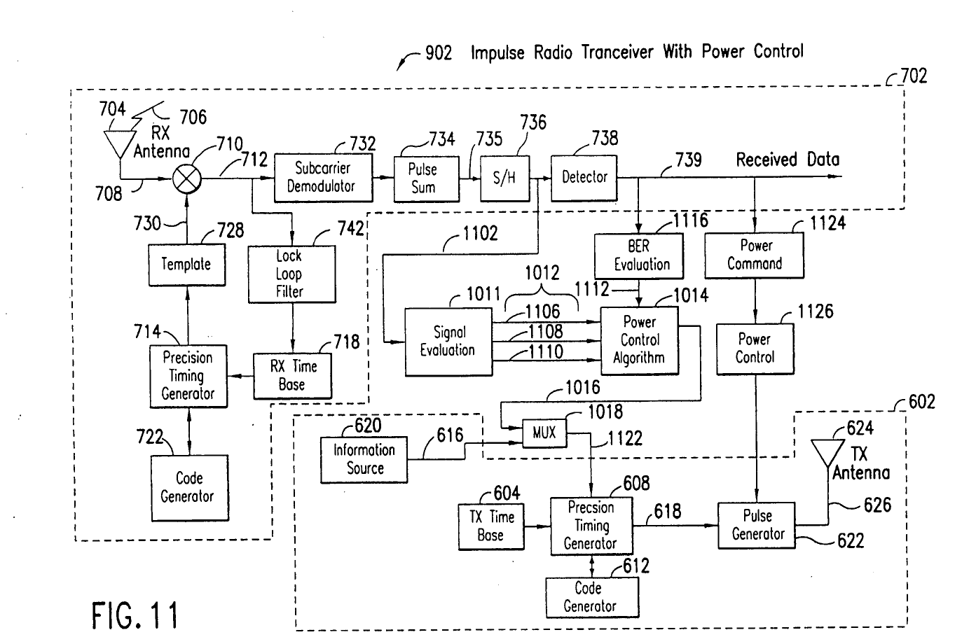

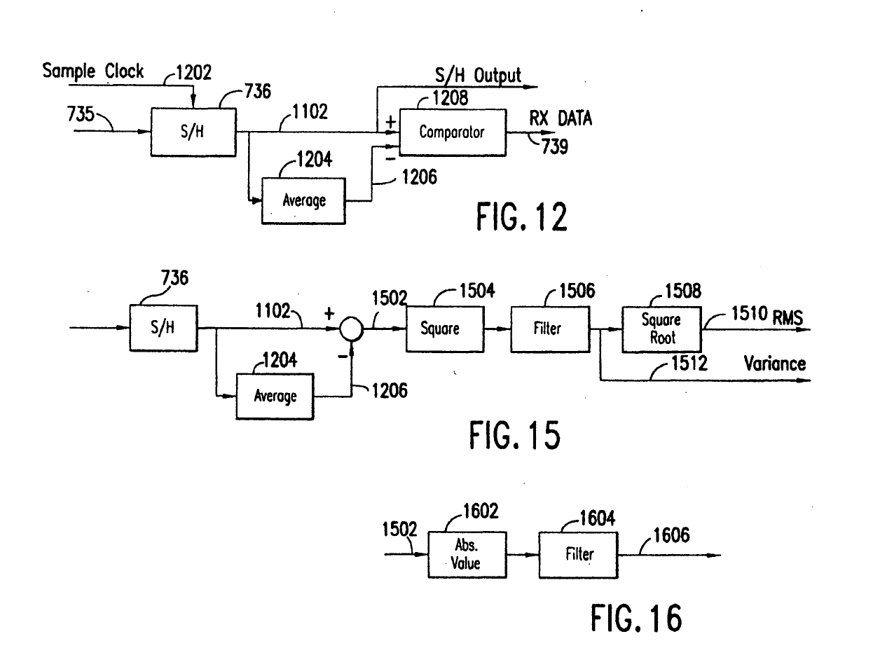

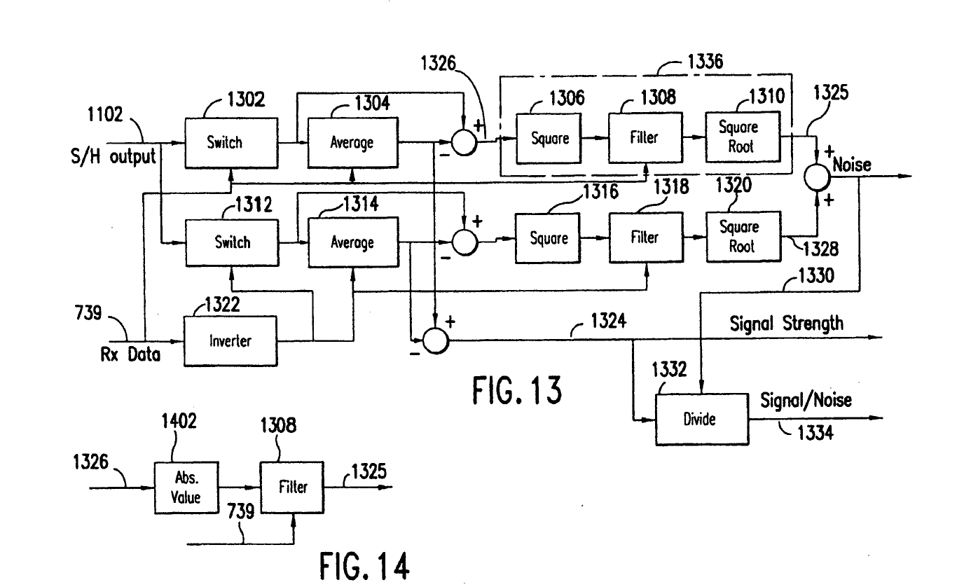

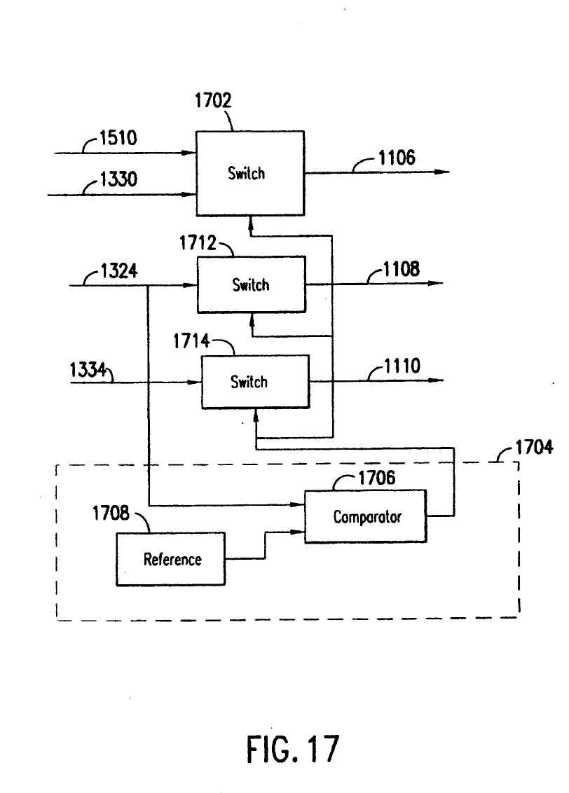

First, the signal detection process is described in greater detail in accordance with FIG. 12, which describes the workings of the detector 738 of FIGS. 7 and 11. The output 735 of the pulse summation stage 734 is provided to the input of the sample and hold 736, which is clocked by a sample clock signal 1202 at the end of the integration period (pulse summation period) for a data bit. This samples the final voltage level, which represents the integration result, and holds it until the integration of the next data bit is complete. The output 1102 of this sample and hold 736, is supplied to an averaging function 1204, which determines the average value 1206 of this signal 1102. This average function 1204 may be a running average, a single pole low pass filter, a simple RC filter (a filter including a resistor(s) and capacitor(s)), or any number of equivalent averaging functions as would be known by one of ordinary skill in the art. This average value 1206 represents the DC (direct current) value of the output 1102 of sample and hold 736 and is used as the reference for comparator 1208 in the determination of the digital value of the instant signal which is output as Received Data 739. The advantage of averaging function 1204 is to eliminate DC offsets in the circuits leading up to sample and hold 736. This function, however, depends on a relatively equal number of ones and zeroes in the data stream. An alternative method is to evaluate the average only when no signal is in lock, as evidenced by low signal strength, and then to hold this value when a signal is in lock. This will be discussed later in detail with reference to FIG. 17. This depends on the assumption that the DC offset will be stable over the period of the transmission. A further alternative is to build low offset circuits such that a fixed value, e.g., zero, may be substituted for the average. This is potentially more expensive, but has no signal dependencies. A fourth alternative is to split the difference between the average voltage detected as a data “one” and the average voltage detected as a data “zero” to determine a reference value for bit comparison. This difference is available from a signal strength measurement process, which is now described in greater detail in the discussion of FIG. 13.

Signal Strength Measurement

FIG. 13 illustrates the details of the signal evaluation function 1011 of FIG. 11. This function determines signal strength by measuring the difference between the average voltage associated with a digital “one” and the average voltage associated with a digital “zero”. Noise is determined by measuring the variation of these signals, and “signal to noise” is determined by finding the ratio between the signal strength and the noise.

The process for finding signal strength will now be described with reference to FIG. 13, which includes two signal paths, each for determining the average characteristics of the output voltage associated with a detected digital “one” or “zero” respectively. The upper path comprising switch 1302, average function 1304, square function 1306, filter 1308, and square root function 1310 operates when the receive data detects a digital “one.” The lower path, comprising switch 1312, average function 1314, square function 1316, filter 1318, and square root function 1320 operates when the receive data detects a digital “zero” according to inverter 1322. It would be appreciated by one skilled in the art that multiple such paths may be implemented corresponding to multiple states of modulation, should such multiple states be implemented in the particular transceiver system. It should also be noted that a single path might be sufficient for many applications, resulting in possible cost savings with potentially some performance degradation.

More specifically, the output 1102 of the sample and hold 736 is fed to either average function 1304 or average function 1314, according to the receive data 739 and inverter 1322, which determines whether the instant signal summation (i.e., the instant of receive data 739) is detected as a “one” or a “zero”. If the signal is detected as a digital “one”, switch 1302 is closed and average function 1304 receives this signal, while average function 1314 receives no signal and holds its value. If the signal is detected as a digital “zero”, switch 1312 is closed and average function 1314 receives this signal, while average function 1304 receives no signal and holds its value.

Average functions 1304 and 1314 determine the average value of their respective inputs over the number of input samples when their respective switch is closed. This is not strictly an averaging over time, but an average over the number of input samples. Thus, if there are more ones than zeroes in a given time interval, the average for the ones would reflect the sum of the voltage values for the ones over that interval divided by the number of ones detected in that interval rather than simply dividing by the length of the interval or number of total samples in the interval. Again this average may be performed by running average, or filter elements modified to be responsive to the number of samples rather than time. Whereas, the average over the number of samples represents the best mode in that it corrects for an imbalance between the number of ones and zeroes, a simple average over time or filter over time may be adequate for many applications. It should also be noted that a number of averaging functions including, but not limited to, running average, boxcar average, low pass filter, and others can be used or easily adapted to be used in a manner similar to the examples by one of ordinary skill in the art.

It should also be appreciated that a simple average based strictly on digital “ones” or “zeroes”, rather than the composite that includes both “ones” and “zeroes”, can be evaluated with a slight loss of performance to the degree that the average voltage associated with “ones” or the average voltage associated with “zeros” are not symmetrical.

The outputs of averaging functions 1304 and 1314 are combined to achieve a signal strength measurement 1324. In the embodiment illustrated, the voltage associated with digital “one” is positive, and the voltage associated with digital zero is negative, thus the subtraction indicated in the diagram, is equivalent to a summation of the two absolute values of the voltages. It should also be noted that this summation is equal to twice the average of these two values. A divide by two at this point would be important only in a definitional sense as this factor will be accommodated by the total loop gain in the power control system.

The purpose of square functions 1306 and 1316, filters 1308 and 1318, and square root functions 1310, 1320 shall be described below in the following section relating to noise measurements.

Noise Measurement

FIG. 15 and FIG. 13 illustrate a noise measurement process in accordance with an embodiment of the present invention. This noise measurement process is contained within the signal evaluation function 1011 of FIG. 11. The noise measurement is combined with the signal strength measurement to derive a signal to noise measurement 1110. There are two modes that must be considered when determining the noise value.

The first mode is now described with reference to FIG. 15. This mode is used before a signal is in lock. In this situation, the pulse summation function is not generating ramps because there is no coherent signal being received. To measure noise in this mode, the samples from sample and hold 736 are evaluated for statistical standard deviation, i.e., the RMS (root mean square) AC (alternating current) voltage. This value is then averaged by an average function to provide a stable measure of the noise. The averaged value can then be used as an initial value for the noise after a signal is captured and locked.

More specifically, referring to FIG. 15, the output 1102 of sample and hold 736 is averaged in the average function 1204 to remove any DC offset that may be associated with the signal. The output of average function 1204 is then subtracted from the sample and hold output producing a zero mean signal 1502. The zero mean signal 1502 is then squared by square function 1504 and filtered by filter 1506. This result (the output of filter 1506) represents the variance 1512 of the noise. A square root function 1508 is also applied, resulting in the RMS value 1510 of the noise.

FIG. 16 illustrates an alternate processing method which may afford some implementation economies. Referring to FIG. 16, the zero mean signal 1502 is provided to an absolute value function 1602 which is then filtered by filter 1604, resulting in an output 1606 that may be used in place of the RMS value 1510.

The second mode to be considered occurs when the receiver is locked to a received signal. In this mode, the pulse summation function is generating a generally ramp shaped time function signal due to the coherent detection of modulated data “ones” and “zeroes”. In this mode the desired noise value measurement is the statistical standard deviation of the voltage associated with either the data “ones” or data “zeros”. Alternatively, as discussed below in the description of FIG. 14, the absolute value of the voltage associated with either the data “ones” or data “zeros” can be used in place of standard deviation.

Referring again to FIG. 13, the output of average function 1304 is subtracted from each sample resulting in a value 1326 that is then squared by square function 1306, and filtered by filter 1308. The filtered result is then processed by square root function 1310, resulting in an RMS AC value 1325 representing the noise associated with the “ones”. A similar process is performed on the output of average function 1314 by the square function 1316, filter 1318, and square root function 1320, resulting in a value 1328 representing the noise associated with the data “zeroes”. These two values 1325 and 1328 are combined resulting in a value 1330 representing the noise in the reception process. If the noise for the “ones” is equal to the noise for the “zeroes”, then this method of adding the values results in a sum equivalent to twice the average of the noise value for the “ones.”

The noise value 1330 is combined with the signal strength value 1324 in a divide function 1332 to derive a signal-to-noise value 1334 result. As with the signal strength measurement 1324, computational economies may be achieved by using only the result of the data “ones” or data “zeros” processing for the standard deviation computation, or by using average absolute value in the place of standard deviation.

The use of absolute value in place of standard deviation is now described with reference to FIG. 14. FIG. 14 illustrates an alternate solution to the square function 1306, filter 1308, and square root function 1310 sequence identified as 1336 in FIG. 13. The output of average function 1304 is subtracted from each sample resulting in a value 1326 that is provided to the absolute value function 1402 and the result is then filtered by filter 1308 to produce an alternative to the RMS value 1325. Other methods of achieving computational efficiency would be apparent to one of ordinary skill in the art.

The terminology data “ones” and data “zeroes” refers to the logic states passed through the impulse radio receiver. In a typical system, however, there may be a Forward Error Correction (hereinafter called FEC) function that follows the impulse receiver. In such a system, the data “ones” and “zeroes” in the impulse receiver would not be final user data, but instead would be symbol “ones” and “zeros” which would be input to the FEC function to produce final user data “ones” and “zeros.”

An output combiner for the two noise measurement modes together with a mode logic method is shown with reference to FIG. 17. In FIG. 17 the output of the noise measurement 1510 from the algorithm of FIG. 15, which is valid for the unlocked case and the output of the noise measurement 1330 from the algorithm of FIG. 13, which is valid for the locked case, are provided to the two alternative inputs of a selector switch 1702. The switch 1702 is controlled by the output of a lock detector 1704, which determines the mode. The selected output is then supplied to the noise output 1106 of the signal evaluation block 1011 of FIG. 11.

The lock detector 1704 comprises a comparator 1706 connected to the signal strength output 1324 of FIG. 13. A reference value 1708 supplied to the comparator 1706 is a value that is slightly higher than the ambient noise. For an impulse radio, and for digital radios in general, a 10 dB signal to noise ratio is generally required in order to achieve acceptable reception. Thus, it is feasible to place a threshold (that is, the reference value 1708) between the no-signal and the acceptable-signal level.

In a simple receiver, the reference value 1708 may be fixed. In a more advanced radio, the reference value 1708 may be determined by placing the receiver in a state where lock is not possible due to, for instance, a frequency offset, and then setting the reference value 1708 such that the lock detector 1704 shows a stable unlocked state. In another embodiment, the reference value 1708 is set to a factor (e.g., two) times the unlocked noise value 1510.

In the embodiment of FIG. 17, the output of lock detector 1704 is also shown switching (enabling) the outputs of the signal strength 1324 and signal to noise 1334 signals using switches 1712 and 1714, since these outputs are not meaningful until a significant signal is received and in lock. These outputs 1324, 1334 are then supplied to the outputs 1108, 1110 of the signal evaluation function 1011 of FIG. 11.

Bit Error Rate (BER)

Referring again to FIG. 11, the Bit Error Rate (BER) is measured directly from the received data stream 739. The result 1112 is provided to the power control algorithm 1014. BER can be measured by a number of methods depending on the configuration of the system. In an embodiment adaptable for a block oriented data transmission system, BER is measured periodically, by sending a known bit pattern and determining the number of bits in error. For example, a known one-thousand bit message could be sent ten times a second, and the result examined for errors. The error rate could be directly calculated as the number of errors divided by the total bits sent. This block of known BER pattern data may be broken into sub-blocks and sent as part of the data contained in block or packet headers. Both of these methods require considerable overhead in the form of known data sent on the link in order to calculate the error rate.

In a system adapted to use forward error correction (FEC), the error correction rate can be used as the raw BER measurement representative of signal quality. Suitable algorithms including Reed Soloman, Viterbi, and other convolutional codes, or generally any FEC method that yields an error correction rate can be used.

In a preferred embodiment, parity or check sums are used as a measure of errors, even though they alone are insufficient to correct errors. With this method, the user data is used to measure the error rate and a very small overhead of one percent or less is required for the parity to detect normal error rates. For example, one parity bit added to each block of 128 data bits could measure error rates to 10⁻², which would be sufficient to control to a BER of 10⁻³. Although double bit errors within a block will go unnoticed, this is not of much consequence since the average of many blocks is the value used in the power control loop.

Performance Measurement Summary

In the preferred embodiment, the signal strength measurement 1324 could be fairly responsive, i.e., have very little averaging or filtering, in fact it may have no filtering and depend on the power control loop or algorithm 1014 to provide the necessary filtering. The signal to noise measurement 1334 also could be fairly responsive to power changes because the signal measurement is simply propagated through the signal to noise divide operation 1332. The noise measurement 1330, however, typically needs significant filtering 1308 to provide a stable base for the divide operation 1332. Otherwise, the SNR value 1334 will vary wildly due to fluctuations in the noise measurement 1330.

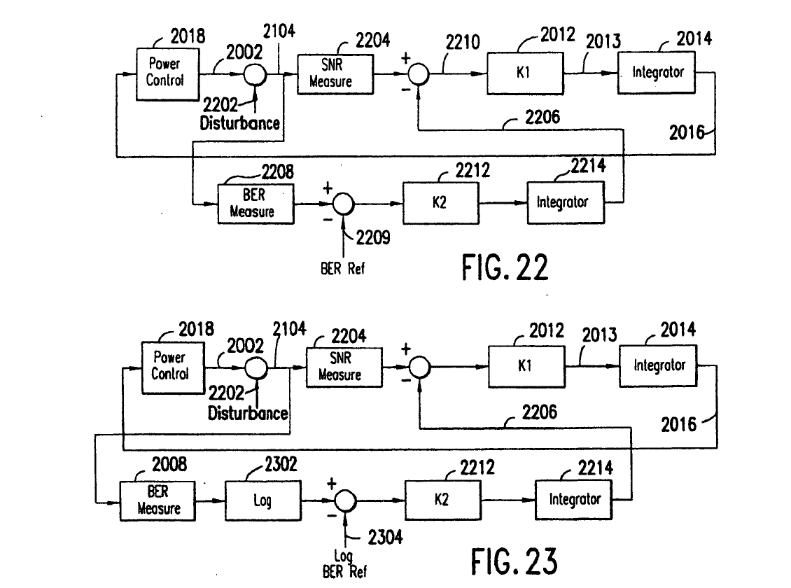

The evaluation of BER 1116 requires a large quantity of data in order to achieve a statistically significant result. For example, if a maximum of 10⁻³ BER is desired (e.g., in FIG. 22 discussed below, BER reference 2210=10⁻³), 1000 data bits must be received to have a likely chance of a single error. 30,000 to 100,000 bits are needed to have a smooth statistical measure at this error rate. Thus, the averaging requirements for BER 1116 are much longer than for signal strength 1324 or SNR 1334, yet BER 1116 is typically the most meaningful measure of channel quality.

It should be apparent to one of ordinary skill in the art that, where some of the diagrams and description may seem to describe an analog implementation, both an analog or a digital implementation are intended. Indeed, the digital implementation, where the functions such as switches, filters, comparators, and gain constants are performed by digital computation is a preferred embodiment.

Impulse Radio Power Control

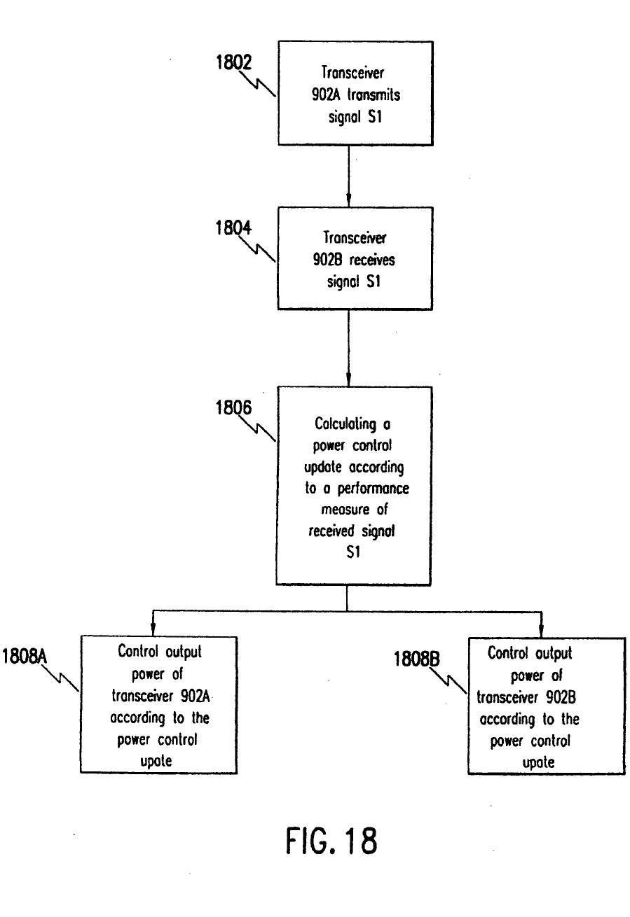

FIG. 18 is a flowchart that describes a method of power control according to the present invention. FIG. 18 is described with reference to the example environment depicted FIGS. 9 and 10. In step 1802, transceiver 902A transmits a signal S1. In step 1804, transceiver 902B receives signal S1. In step 1806, a power control update 1016 is calculated according to a performance measurement(s) of received signal S1. Various performance measurements are discussed below, such as received signal strength, BER, and SNR, can be used either alone or in combination.

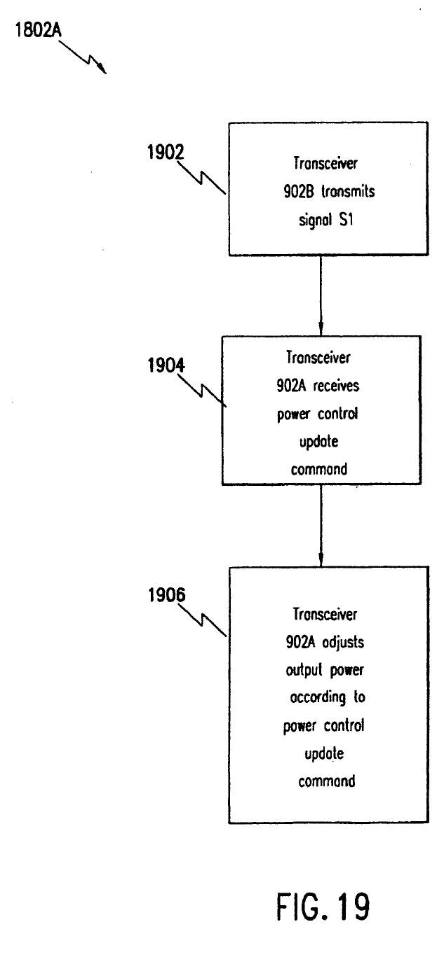

In steps 1808A and 1808B, the output power of either transmitter 602A of transceiver 902A or transmitter 602B of transceiver 902B (or both) is controlled according to the power control update 1016. In step 1808A, the power of transmitter 602A of transceiver 902A is controlled according to the power control update 1016, which is preferably calculated (in step 1806) at transceiver 902B and transmitted from transceiver 902B to 902A. Step 1808A is described in additional detail in FIG. 19.

Referring to FIG. 19, transceiver 902B transmits a power control update, in step 1902. In step 1904, transceiver 902A receives the power control update from transceiver 902B. Then, in step 1906, transceiver 902A adjusts its output power (of transmitter 602A) according to the received power control update 1016. According to this embodiment, the power control for a particular transceiver is therefore determined by the performance (measured by another transceiver receiving the signals) of signals it transmits.

Alternatively, in step 1808B, the output power of transmitter 602B of transceiver 902B is controlled according to the power control update 1016. According to this embodiment, the power control for a particular transceiver is therefore determined by the performance of signals it receives from another transceiver. This embodiment assumes that the propagation path between transceivers in communication is bilaterally symmetric, i.e., that signals transmitted between the pair of transceivers undergo the same path loss in both directions. Consider the example environment depicted in FIG. 9. The propagation path between transceivers 902A and 902B is bilateral symmetric if signal S1 undergoes the same path loss as signal S2. The path loss of S1 therefore provides an accurate estimate of the path loss of S2 to the extent that the propagation path approaches bilateral symmetry. According to this embodiment, the power control of transceiver 902B is determined by the performance of received signal S1 (which is transmitted by transceiver 902A and received by transceiver 902B) in lieu of evaluating received signal S2 (which is transmitted by transceiver 902B and received by transceiver 902A). Impulse radio provides a unique capability for implementing this kind of system. In an impulse radio, the multipath signals are delayed from the direct path signal. Thus the first received pulse in a multipath group will be the direct path signal. If both transceivers in a transceiver system are configured to find and lock on the earliest signal in a multipath group, then the symmetry will be assured, assuming the direct path exists. If the direct path does not exist because of obstruction, then both transceivers will still likely lock on the same early multipath reflection—resulting in a bilateral symmetric propagation configuration.

The following two sections describe steps 1806 and 1808 in greater detail.

Calculate Power Control Update

As described above, in step 1806 a power control update is calculated according to a performance measurement(s) of received signal S1. Those skilled in the art will recognize that many different measurements of performance are possible. Several performance measurements are discussed herein, along with their relative advantages and disadvantages.

Using Signal Strength Measurements

In a first embodiment, the signal strength of the received signal is used as a performance measurement. The power control update, dP, is given by:
dP=K(P_{ref}−P_{S1})
where K is a gain constant;
P_{S1} is the signal strength of received signal S1;
P_{ref} is a signal strength reference; and
dP is the power control update (which is preferable in the unit of Volts).

The output level of transmitter 602A (of transceiver 902A) is therefore increased when P_{S1} falls below P_{ref}, and decreased when P_{S1} rises above P_{ref}. The magnitude of the update is linearly proportional to the difference between these two signals. Note that the power control update can be equivalently expressed as an absolute rather than a differential value. This can be achieved by accumulating the differential values dP and communicating the resulting output level P as follows:
Pₙ=Pₙ₋₁+dP,
Where Pₙ is the output level (e.g., voltage level or power level) to be transmitted during the next evaluation interval;
Pₙ₋₁ is the output level transmitted during the last evaluation interval; and
dP is the output level increment computed as a result of the signal evaluation during the last interval.

Note also that the power control update could be quantized to two or more levels.

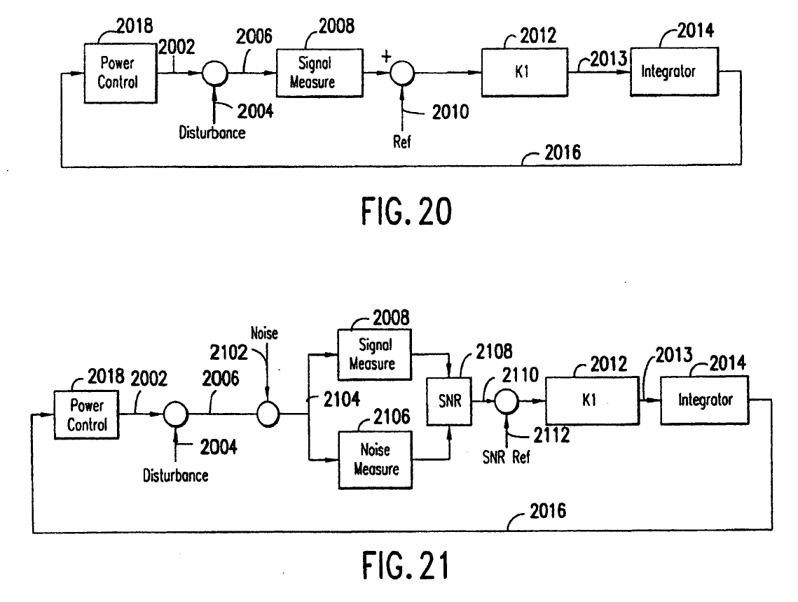

A control loop diagram illustrating this embodiment will now be described with reference to FIG. 20. A signal 2002 (e.g., signal 2002 is transmitted by transmitter 602A of transceiver 902A) having a transmitted output level is disturbed by the propagation path according to a disturbance 2004. This disturbance 2004 may be modeled as either an additive process or a multiplicative process. The multiplicative process is generally more representative of the attenuation process for large disturbances 2004. The resulting received signal 2006 (received by receiver 702B or transceiver 902B) is evaluated for signal strength 2008 (Pₛ₁) and compared with the desired signal strength reference 2010 (P_{ref}). The result is then scaled by K₁ 2012 (K) to produce power control update 2013 (dP). Power control update 2013 (dP) is summed or integrated or possibly filtered over time by, for example, integrator 2014 to produce a power control command signal 2016 to command the power control function 2018 (1126 in FIG. 11) of the transmitter (transmitter 602A of transceiver 902A if the embodiment including step 1808A is implemented, or transmitter 602B of transceiver 902B if the embodiment including step 1808B is implemented) to output a signal 2002 having a new output level (e.g., voltage level or power level). Note that this diagram ignores a nominal path loss and receiver gain which may overcome this path loss. This diagram focuses on the disturbance from the nominal.

If the receiver contains an automatic gain control (AGC), the operation of this AGC must be taken into account in the measurement of signal strength. Indeed, some AGC control signals are suitable for use as a signal strength indicator.

Where the embodiment of 1808B is implemented, the integrating step 2014 should preferably be a filter rather than a perfect integrator and the gain K1 should be low such that the gain correction is less than sufficient to fully level the power, preferably less than half of what would level the power. This will prevent instability in the system. Such low gain K1 would likely be discarded as unworkable in conventional spread spectrum systems, but because of the potentially very high processing gain available in an impulse radio systems, and impulse radio system can tolerate gain control errors of much greater magnitude than conventional spread spectrum systems, making this method potentially viable for such impulse radio systems.

It should be apparent to one skilled in the art that the system functions including the reference 2010, the K₁ scaling function 2012, and the integrator 2014, can be partitioned into either the transmitter or receiver at the convenience of the designer.

Those skilled in the art will recognize that many different formulations are possible for calculating a power control update according to received signal strength. For instance, the performance measurement might be compared against one or more threshold values. For example, if one threshold value is used the output power is increased if the measurement falls below the threshold and decreased if the measurement rise above the threshold. Alternatively, for example, the performance measurement is compared against two threshold values, where output power is increased if the measurement falls below a low threshold, decreased if the measurement rises above a high threshold, or held steady if between the two thresholds. This alternative method is often referred to as being based on hysteresis.

These two thresholding methods could also be used with the remaining performance measurements discussed below.

In another embodiment, transceiver 902A does not evaluate the signal. Transceiver 902B evaluates the signal strength of S1 and computes a power control update command for transmitter 602B and for transmitter 602A. The power control update (dP) command for transmitter 602A is sent to transceiver 902A and used to control transmitter 602A.

Using SNR Measurements

In a second embodiment, the SNR of the received signal is used as a performance measurement. The power control update, dP, is given by:
dP=K(SNR_{ref}−SNR_{S1})
where K is a gain constant;
SNR_{S1} is the signal-to-noise ratio of received signal S1; and
SNR_{ref} is a signal-to-noise ratio reference.

The power of transmitter 602A (of transceiver 902A) is therefore increased when SNR_{S1} falls below SNR_{ref}, and decreased when SNR_{S1} rises above SNR_{ref}. The magnitude of the update is linearly proportional to the difference between these two signals. Note that the power control update can be equivalently expressed as an absolute rather than a differential value. As described above, those skilled in the art will recognize that many alternative equivalent formulations are possible for calculating a power control update according to received signal SNR.

A control loop diagram illustrating the functionality of this embodiment will now be described with reference to FIG. 21. A signal 2002 (e.g., signal 2002 is transmitted by transmitter 602A of transceiver 902A) having a transmitted power level is disturbed by the propagation path according to a disturbance 2004. This disturbance 2004 may be modeled as either an additive process or a multiplicative process; however, the multiplicative process is generally more representative of the attenuation process for large disturbances 2004. The resulting signal 2006 is then combined with additive noise 2102 representing thermal and interference effects to yield a combined signal 2104 which is received by the receiver (receiver 702B of transceiver 902B), where signal strength 2008 and noise 2106 are measured. These values are combined 2108 to yield a signal to noise measurement 2110 (SNR_{S1}). The signal to noise measurement 2110 is then compared with a signal to noise reference value 2112 (SNR_{ref}). The result is then scaled by K₁ 2012 (K) to produce power control update 2013 (dP). Power control update (dP) is summed or integrated 2014 over time to produce a power control command signal 2016 to command the power control function 2018 (1126 in FIG. 11) of the transmitter (transmitter 602A of transceiver 902A if the embodiment including step 1808A is implemented, or transmitter 602B of transceiver 902B if the embodiment including step 1808B is implemented) to output a signal 2002 having a new power level.

Again, it should be apparent to one skilled in the art that the system functions including the reference 2010, the K₁ scaling function 2012, and the integrator 2014, as well as part of the signal evaluation calculations, can be partitioned into either the transmitter or receiver at the convenience of the designer.

Using BER Measurements

In a third embodiment, the BER of the received signal is used as a performance measurement. The power control update, dP, is given by:
dP=K(BER_{S1}−BER_{ref})
where K is a gain constant;
BER_{S1} is the bit error rate of received signal S1; and
BER_{ref} is a bit error rate reference.

Note that the sign is reversed in this case because the performance indicator, BER is reverse sensed, i.e., a high BER implies a weak signal. The power of transmitter 602A (of transceiver 902A) is therefore decreased when BER_{S1} falls below BER_{ref}, and increased when BER_{S1} rises above BER_{ref}. The magnitude of the update is linearly proportional to the difference between these two signals. Note that the power control update can be equivalently expressed as an absolute rather than a differential value. As described above, many alternative formulations are possible for calculating a power control update according to received signal BER.

Note that BER measurements span a large dynamic range, e.g., from 10⁻⁶ to 10⁻¹, even where the received signal power may vary by only a few dB. BER measurements are therefore preferably compressed to avoid the wide variation in control loop responsiveness that would otherwise occur. One method of compressing the range is given by:
dP=K(log(BER_{S1})−log(BER_{ref})),

Where log( ) is the logarithm function and the other variables are defined above.

Thus five orders of dynamic range are compressed into the range from −1 to −6, which makes the control loop stability manageable for typical systems. An alternative compression function can be generated by mapping BER into equivalent dB gain for a given system. This function can be based on theoretical white Gaussian noise, or can be based on measurements of environmental noise for a given system.

Using BER as the measure of performance provides meaningful power control in digital systems. However, calculating BER requires a relatively long time to develop reliable statistics. SNR is not as meaningful as BER, but may be determined more quickly. Signal strength is less meaningful still because it does not account for the effects of noise and interference, but may be determined with only a single sample. Those skilled in the art will recognize that one would use these performance measurements to trade accuracy for speed, and that the particular environment in which the transceivers will be used can help determine which measurement is the most appropriate. For example, received signal variations in a mobile application due to attenuation and multipath signals demand high update rates, whereas high noise environments tend to need more filtering to prevent erratic behavior.

Combining BER, SNR, and/or signal strength can produce other useful performance measurements.

BER and Signal Strength

In a fourth embodiment, BER and signal strength are combined to form a performance measurement, where the power control update, dP, is given by:
P_{ref}=K₂(log(BER_{S1})−log(BER_{ref}))
dP=K₁(P_{ref}−P_{S1})
where K₁ and K₂ are gain constants;
BER_{S1} is the bit error rate of received signal S1;
BER_{ref} is a bit error rate reference; and
P_{S1} is the signal strength of received signal S1.

P_{ref}, a signal strength reference, is calculated according to the first formula and substituted into the second to determine the power control update. This composite performance measurement combines the more accurate BER measurement with the more responsive signal strength measurement. Note that the power control update might be equivalently expressed as an absolute rather than a differential value.

BER and SNR

In a fifth embodiment and a sixth embodiment, BER and SNR are combined to form a performance measurement. In the fifth embodiment, the power control update, dP, is given by:
SNR_{ref}=K₂(BER_{S1}−BER_{ref})
dP=K₁(SNR_{ref}−SNR_{S1})
where K₁ and K₂ are gain constants;
BER_{S1} is the bit error rate of received signal S1;
BER_{ref} is a bit error rate reference; and
SNR_{S1} is the signal-to-noise ratio of received signal S1.

In the sixth embodiment, the power control update, dP, is given by:
SNR_{ref}=K₂(log(BER_{S1})−log(BER_{ref}))
dP=K₁(SNR_{ref}−SNR_{S1})
where K₁ and K₂ are gain constants;
BER_{S1} is the bit error rate of received signal S1;
BER_{ref} is a bit error rate reference; and
SNR_{S1} is the signal-to-noise ratio of received signal S1.

SNR_{ref}, a signal-to-noise ratio reference, is calculated according to the first formula and substituted into the second to determine the power control update. This composite performance measurement combines the more accurate BER measurement with the more responsive SNR measurement. Note that the power control update might be equivalently expressed as an absolute rather than a differential value.

A control loop simulation diagram illustrating the functionality of an embodiment based on BER and SNR will now be described with reference to FIG. 22. A signal 2002 (e.g., signal 2002 is transmitted by transmitter 602A of transceiver 902A) having transmitted power level is disturbed by the propagation path according to a disturbance 2202, which may include both propagation and noise effects as in FIG. 21 yielding a combined signal 2104 which is received by the receiver (receiver 702B of transceiver 902B). This signal 2104 is evaluated for signal to noise ratio 2204 (combined functions of 2008, 2106 and 2108) and then compared with a reference 2206 to yield a result 2210. This result 2210 is then scaled by scaling function K₁ 2012 (K₁) and summed or integrated over time by integrator 2014 to produce a power control command signal 2016 to command the power control function 2018 (1126 in FIG. 1) of the transmitter (transmitter 602A of transceiver 902A if the embodiment including step 1808A is implemented, or transmitter 602B of transceiver 902B if the embodiment including step 1808B is implemented) to output a signal 2002 having a new power level. The embodiment including step 1808A is preferred, because the embodiment including step 1808B is susceptible to errors from non-symmetrical noise and interference as in the case where interfering transmitter 910 is closer to receiver 702B than to receiver 702A. The embodiment including step 1808B may be used in applications that do not need precise power control by using low gain factors (K₁ and K₂).

Reference 2206 is based on BER measurement 2208 (BER_{S1}) of signal 2104. More specifically, signal 2104 is evaluated for BER 2208 and then compared to desired BER reference 2209 (BER_{ref}). The result is then scaled by K₂ 2212 and filtered or integrated over time by integrator 2214 to produce reference 2206 (SNR_{ref}). This process results in the SNR reference 2206 used by the SNR power control loop. The BER path is adjusted by scaling function K₂ 2212 (K₂) and by the bandwidth of the filter 2214 (when a filter is used for this function) to be a more slowly responding path than the SNR loop for loop dynamic stability reasons and because BER requires a much longer time to achieve a statistically smooth and steady result. Note also that to implement the integrator 2214 as a pure integrator rather than a filter the equations may be modified to include an additional summation stage:
dSNR_{ref}=K₁(log(BER_{S1})−log(BER_{ref}))
SNR_{ref}=dSNR_{ref}+SNR_{ref}
dP=K₂(SNR_{ref}−SNR_{S1})
where K₁ and K₂ are gain constants;
BER_{S1} is the bit error rate of received signal S1;
BER_{ref} is a bit error rate reference;
dSNR_{ref} is an incremental change in SNR_{ref};
SNR_{ref} is a calculated reference used in the SNR loop; and
SNR_{S1} is the signal-to-noise ratio of received signal S1.

Again, it should be apparent to one skilled in the art that the system functions illustrated on FIG. 22 from the references 2206 and 2209 to the integrator 2014 as well as part of the signal evaluation calculations 2204 and 2208, can be partitioned into either the transmitter or receiver at the convenience of the designer.

A control loop simulation diagram illustrating the addition of the log(BER) function will now be described with reference to FIG. 23. It can be seen that this Figure is substantially similar to FIG. 22 except that the BER measurement 2208 is processed by a log function 2302 (log(BER_{S1})) and compared with a reference 2304 (log(BER_{ref})) suitable for the log(BER) value before being scaled by scaling function K₂ 2212 (K₂) and integrated or filtered by integrator 2214 and used as the reference 2206 (SNR_{ref}) for the SNR control loop.

One should note that strong signals result in small BER measurement values or large magnitude negative log(BER) values and that control loop gain factor polarities need to be adjusted to account for this characteristic.

Calculate Power Control Update Using Measurements of a Signal Transmitted by another Transceiver

In each of the above discussed embodiments for performing power control, power control for a particular transceiver (e.g., transceiver 902A) can be determined based on the performance (i.e., signal strength, SNR and/or BER) of signals transmitted by the particular transceiver and received by another transceiver (e.g., transceiver 902B), as specified in step 1808A of FIG. 18. More specifically, in step 1808A, the power of transmitter 602A of transceiver 902A is controlled according to a power control update, which is preferably calculated at transceiver 902B and transmitted from transceiver 902B to transceiver 902A.

Alternatively, as briefly discussed above, each of the above discussed embodiments for performing power control for a particular transceiver can be determined based on the performance (i.e., signal strength, SNR and/or BER), of signals it receives, as in step 1808B of FIG. 18. More specifically, according to this embodiment, the power control for a particular transceiver (e.g., transceiver 902A) is determined by the performance of signals it receives from another transceiver (e.g., signals transmitted from transceiver 902B and received by transceiver 902A).

This power control embodiment assumes that the propagation path between transceivers in communication is bilaterally symmetric. However, an interfering transmitter (e.g., transmitter 908), when present, will disturb the system asymmetrically when it is nearer to one transceiver. As shown in FIG. 9, interfering transmitter 908 is nearer to transceiver 902B. Thus, when interfering transmitter 908 turns on, the noise level at transceiver 902B will increase more than the noise level at transceiver 902A. The response of the power control system can vary depending on the performance measurement utilized. If the power control system is using signal strength, the control system would be unaffected by the interference, but if the system is using signal to noise ratio, the nearby transceiver 902B would increase power to overcome the performance degradation. In this case, it is an unnecessary increase in power. This increase in power would be seen as a propagation improvement at transceiver 902A, which would decrease power, resulting in an even lower SNR at 902B, which would increase power further. Clearly this is not workable.

In a preferred embodiment, this can be overcome by communicating to transceiver 902B the power (e.g., relative power or absolute power) transmitted by transceiver 902A. This allows transceiver 902B to separate power changes due to power control from changes due to propagation. This communication can be accomplished according to conventional techniques, such as transmitting a digital message in a link control header, or transmitting a periodic power reference. With this information, transceiver 902B may adjust its power based only on propagation changes and not on power control adjustments made by transceiver 902A.

Multi-path environments can also disturb system symmetry. A transceiver 902 can lock onto various multi-path signals as the transceivers in communication move in relation to one another. If the two transceivers are not locked on to signals from the same path, the signals will not necessarily match in attenuation patterns. This can cause erroneous power control actions in the affected transceiver 902.

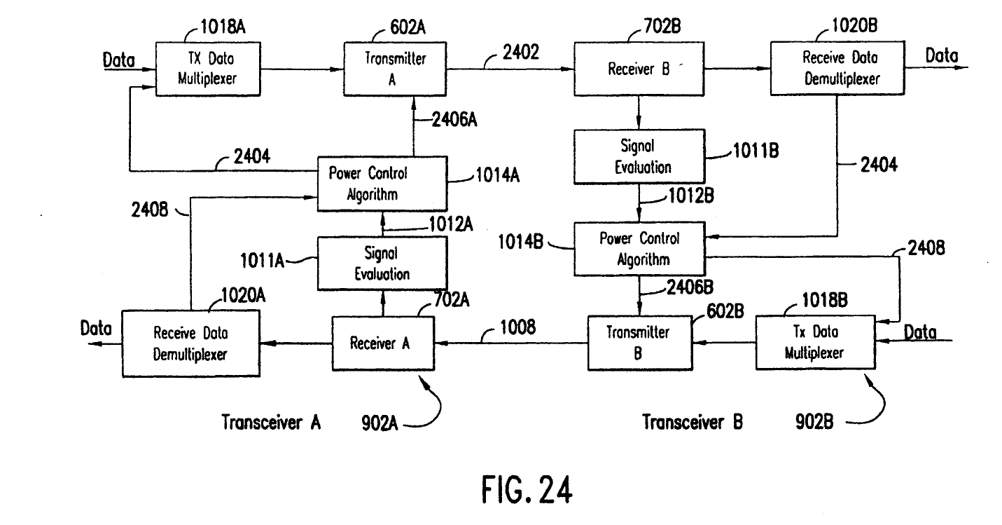

A more general block diagram of a transceiver power control system including power control of both transmitters (i.e., transmitter 602A of transceiver 902A and transmitter 602B of transceiver 902B) from signal evaluations from both transceivers (i.e., transceivers 902A and 902B) is shown in FIG. 24. For this discussion, auto-power control refers to power control of a first transceiver's (e.g., transceiver 902A) output according to the evaluation of a signal transmitted by a second transceiver (e.g., transceiver 902B) and received by the first transceiver (e.g., transceiver 902A). Thus, auto power control relates to step 1808B discussed above. Cross power control refers to the control of a first transceiver's (e.g., transceiver 902A) output according to the evaluation of the first transceiver's transmitted signal as received at a second transceiver (e.g., transceiver 902B). Thus cross power control relates to step 1808A discussed above.

Referring to FIG. 24, transmitter 602A transmits a signal 2402 to receiver 702B of transceiver 902B. This signal 2402 is evaluated by signal evaluation function 1011B resulting in performance measurement(s) 1012B (e.g., signal strength, SNR and/or BER) which are delivered to the power control algorithm 1014B. The power control algorithm 1014B also receives power control messages 2404 from transmitter 602A via the receiver data demultiplexer 1020B, which separates user data and power control messages 2404. These power control update messages 2404 can comprise data related to the power level of transmitter 602A and/or signal evaluations (e.g., signal strength, SNR, and/or BER) of signals 1008 received by receiver 702A (i.e., signals transmitted by transceiver 902B and received by transceiver 902A).

The power control algorithm 1014B then computes a new power level 2406B to be transmitted and delivers this value to transmitter 602B. Power control algorithm 1014B can also deliver signal evaluations 2408, which are based on measurements determined by signal evaluation function 1011B, to the TX data multiplexer 1018B. Alternatively, signal evaluation function 1011B can deliver this information 2408 directly to TX data multiplexer 1018B. This signal evaluation data 2408 is then added to the input data stream and transmitted at the commanded power level 2406B.

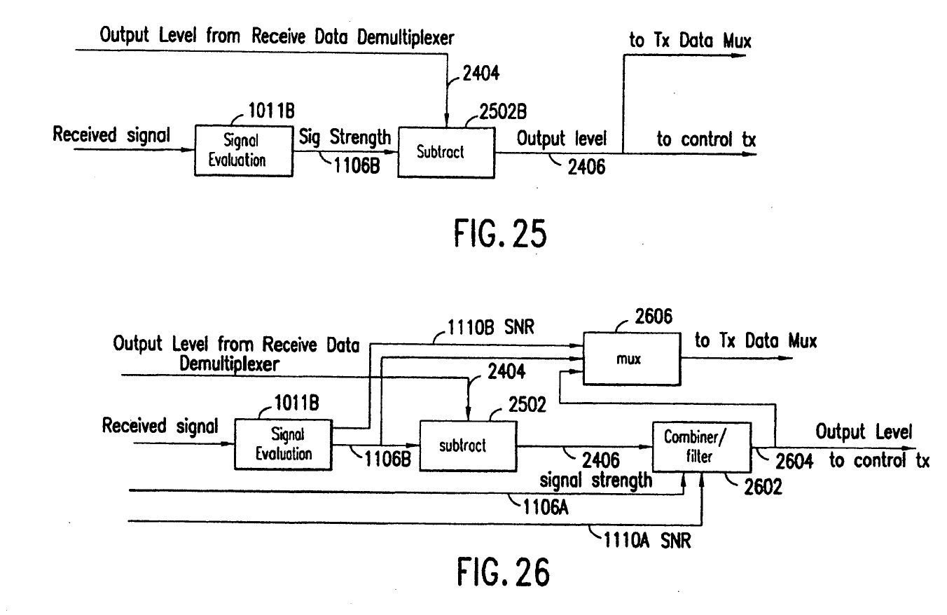

FIG. 25 illustrates an embodiment of the power control algorithm 1014B (of transceiver 902B) employing auto-control with power level messaging. Referring to FIG. 25, the received signal (transmitted by transmitter 702A and received by receiver 602B) is evaluated for signal strength 1106B by signal evaluation function 1011B. Additionally, receive data demultiplexer 1020B (See FIG. 24) separates user data and power control messages 2404 and delivers the power control messages 2404 to subtract function 2502B. The power control message value 2404 (representing the output level of transmitter 602A) is then subtracted by subtractor 2502 from the signal strength measurement 1106 (which is based on the strength of a signal transmitted by transceiver 902A). The result 2406 is used to deviate (e.g., decrease or increase) the transmitter output from a nominal output level. Additionally, a message value that represents the transmitted output level is generated and sent to the other transceiver 902A.

Thus, it can be seen that if the signal becomes attenuated, the output of the subtractor 2504 will decrease, resulting in an increase in the transmitted output level (e.g., voltage level or output level) and a message to that effect. On the other hand if transmitter 602A decreases its output level due to a measured signal condition, both the received signal and output level signals will decrease such that there is no change in the difference resulting in no change to the output power. This mechanism prevents a runaway positive feedback loop between the two transceivers and allows higher control loop gains than would be workable without the message.

FIG. 26 illustrates an embodiment where auto and cross control are implemented in combination. Referring to FIG. 26, the received signal is evaluated by signal evaluation function 1011B for signal strength 1106B and SNR 1110B. The output level signal 2404 (representing the output level of transmitter 602A) is subtracted from the signal strength 1106B resulting in an auto control signal 2406. This auto control signal 2406 is combined with a signal strength 1106A or SNR measurement 1110A determined by the signal evaluation function 1011A of the other transceiver 902A and further filtered by combiner/filer 2602 to produce an output level value 2604 used to control the output level of transmitter 602B. This output level value 2604 is combined with the signal strength 1106B and SNR 1110B measurements by multiplexer 2606, and then further combined with the transmitted data stream by transmit data multiplexer 1018B. This system takes full advantage of both the auto and cross power control methods, with the auto power control generally offering speed of response, and the cross power control offering precision together with tolerance of link imbalance and asymmetry.

In a preferred embodiment, the power control update is calculated at the transceiver receiving the signals upon which the update is based. Alternatively, the data required to calculate the power control update may be transmitted to another transceiver and calculated there.

Transceiver Power Control

Returning to FIG. 18, in steps 1808A and 1808B, the output power of either transceiver 902A or 902B (or both) is controlled according to the power control update calculated in step 1806.

In step 1808A, the power of transmitter 602A of transceiver 902A is controlled according to the power control update. FIG. 19, briefly discussed above, is a flowchart that depicts step 1808A in greater detail according to a preferred embodiment. In step 1902, transceiver 902B transmits the power control update calculated in step 1806 (assuming that, according to a preferred embodiment, the power control update is calculated at transceiver 902B). In step 1904, transceiver 902A receives the power control update. In step 1906, transceiver 902A adjusts its output level (e.g., voltage level or power level) according to the received power control update, as described in detail below.

Alternatively, in step 1808B, the power of transmitter 602B of transceiver 902B is controlled according to the power control update. Thus here, the power level of the signal S1 (sent by transceiver 902A and received by transceiver 902B) is used to control the output level of transmitter 602B. As a result, there is no requirement that the update be transmitted between transceiver 902A and 902B. Rather, transceiver 902B preferably calculates the power control update and adjusts the power of its transmitter 602B accordingly.

Again, it is noted that while power control refers to the control of the output power of a transmitter, this is usually implemented as a voltage control proportional to the output signal voltage.

Integration Gain Power Control

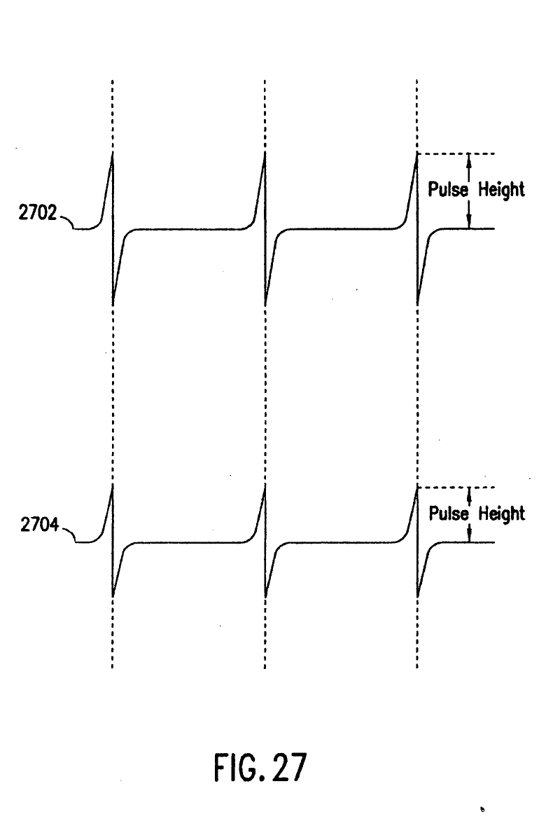

In both steps 1808A and 1808B, power control of a transmitter 902 can be accomplished by controlling any parameter that affects power. In a first embodiment, the pulse peak power (e.g., the height of pulses) of the transmitted signal is controlled while keeping the timing parameters constant. For example, FIG. 27 shows two signals 2702 and 2704 having different pulse peak powers but the same timing parameters. Note that signal 2702 has a greater pulse height and thus corresponds to a greater transmitter power than signal 2704.

In a preferred embodiment, however, the number of pulses per bit is controlled, thereby controlling the integration gain while keeping pulse peak power constant. Integration gain relates to (e.g., is proportional to) the number of pulses summed or integrated in the receiver for each data bit. For a constant data rate, the transmitted power is directly proportional to the number of pulses per bit transmitted. Referring to FIG. 11, in one embodiment where power control commands (e.g., differential commands) are selected from the data stream by a power command function 1124 (which includes the function of receive data demultiplexer 1020) and delivered to a power control function 1126 (that controls the output power of the pulse generator 622), the number of pulses may be found by first, summing the differential commands, and then computing the number of pulses based on this summation, as in the following:
Pₙ=Pₙ₋₁+dP
Nₜᵣₐᵢₙ=KₚPₙ

Where, Pₙ is the present commanded output level (e.g., voltage level or power level);

Pₙ₋₁ is the output level transmitted during the just completed evaluation interval;

dP is the output level increment commanded (also referred to as the power update command 1016) as a result of the just completed evaluation interval;

Nₜᵣₐᵢₙ is the number of pulses per data bit (also referred to as the number of pulses in a pulse train) to be transmitted during the present evaluation interval; and

Kₚ is a constant relating power to number of pulses per bit.

Note that a check for limits is necessary. Nₜᵣₐᵢₙ cannot be greater than full power, nor can Nₜᵣₐᵢₙ be less than one. In some cases, Nₜᵣₐᵢₙ must be an even integer or some other quantized level.

In a system with a subcarrier as disclosed in the U.S. Pat. No. 5,677,927 patent, it may be preferable to increment pulses according to complete subcarrier cycles in order to keep the subcarrier signal balanced. This can be accomplished by adjusting subcarrier cycle length or by adjusting the number of subcarrier cycles. This can be illustrated by example.

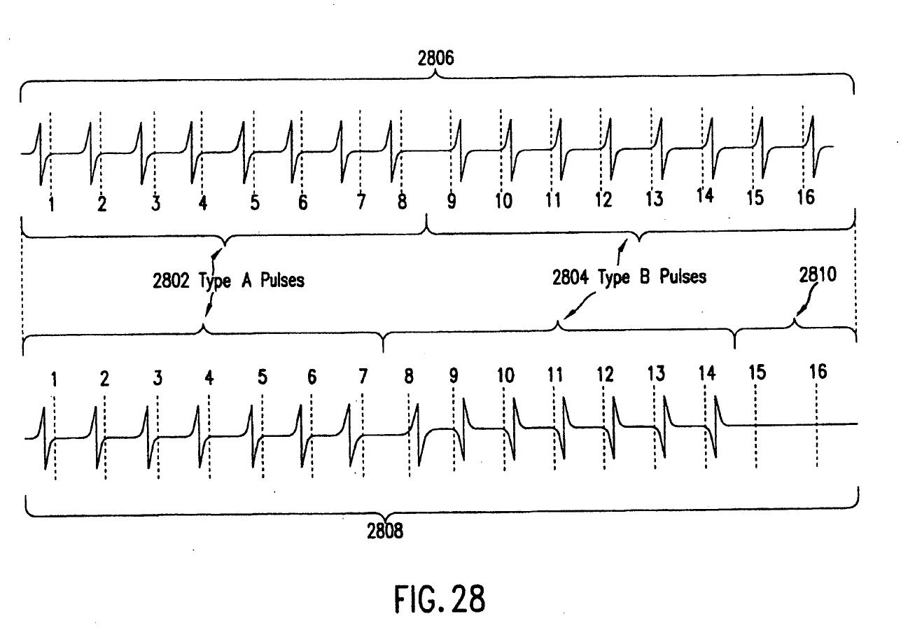

For the example shown in FIG. 28, type A pulses 2802 shall be defined as pulses delayed from nominal by ½ modulation time and type B pulses 2804 shall be defined as pulses advanced from nominal by ½ modulation time. Thus, the difference between type A pulses 2802 and type B pulses 2804 is one full modulation time. Using this nomenclature, with reference to an example system with 128 pulses per data bit (i.e., Nₜᵣₐᵢₙ=128 pulses/bit), a suitable subcarrier might comprise eight periods 2806 (i.e., N_{period}=8) of 16 pulses (i.e., N_{pulses-per-period}=16 pulses/period) where each period 2806 comprises eight type A pulses 2802 followed by eight type B pulses 2804 when a data “one” is transmitted. Power can be reduced by adjusting the subcarrier cycle length by, for example, changing to eight periods 2808 of 14 pulses each (i.e., N_{pulses-per-period} is reduced from 16 pulses/period to 14 pulses/period), where each period 2808 comprises seven type A pulses 2802 followed by seven type B pulses 2804 and two empty pulses 2810. This maintains the balance of pulse types (same number of each type) within each subcarrier cycle, and thus, the whole data bit interval results in a total of 112 pulses per data bit (i.e., Nₜᵣₐᵢₙ is reduced from 128 pulses/bit to 112 pulse/bit) excluding empty pulses 2810. It is noted that the location of the empty pulses can be changed. For example, each period 2808 can comprise seven type A pulses 2802, followed by one empty pulse 2810, followed by seven type B pulses 2804, followed by one empty pulse 2810.

Alternatively, the power may be reduced by reducing the number of subcarrier cycles. According to this embodiment, to reduce power the example system could transmit seven (instead of eight) periods of 16 pulses (i.e., N_{period} is reduced from 8 periods to 7 periods), where each period comprises eight type A pulses followed by eight type B pulses when a data “one” is transmitted. This would result in a total of 112 pulses per data bit, as opposed to 128 pulses per data bit (i.e., Nₜᵣₐᵢₙ is reduced from 128 pulses/bit to 112 pulses/bit). For example, referring to FIG. 28, to reduce power, a subcarrier cycle can be reduced from eight periods 2806 of 16 pulses to seven periods 2806 of 16 pulses.

Whereas the balance of subcarrier cycles is preferred, it is not required. Patterns may be generated that balance the pulse types over the data bit, wherein one or more subcarrier periods may be unbalanced. Some systems may even tolerate an unbalance of pulse types over a data bit, but this will usually come with some performance degradation. Other patterns can be easily implemented by one of ordinary skill in the art following the principles outlined in these examples.

The receiver integration gain should ideally track the number of pulses transmitted. If these values are not coordinated, loss of performance may result. For example, if the receiver is receiving 128 pulses for each data bit and the transmitter is only transmitting the first 64 of these pulses, the receiver will be adding noise without signal for the second half of the integration time. This will result in a loss of receiver performance and will result in more power transmitted than necessary. This can be prevented by coordinating the number of pulses between the transmitter and receiver. In one embodiment, this information is placed in the headers or other control signals transmitted so that the receiver can determine exactly how many pulses are being sent.

In another embodiment, the receiver employs multiple parallel bit summation evaluations, each for a different possible integration gain pulse configuration. The SNR 1110 is evaluated for each summation evaluation path, and the path with the best SNR is selected for data reception. In this way, the receiver can adaptively detect which pulse pattern is being transmitted and adjust accordingly.

Gain Expansion Power Control

Power control can be improved by expanding the gain control sensitivity at high levels relative to low levels. For illustration, an unexpanded gain control function would be one where the voltage or power output would be simply proportional to the voltage or power control input signal:
Vₒᵤₜ=K_{ctl}V_{ctl}

Where Vₒᵤₜ is the pulse voltage output;

K_{ctl} is a gain constant (within power control block 1014, not to be confused with K₁); and

V_{ctl} is the control voltage input (power control command signal).

An example of an expanded gain control function could be:
Vₒᵤₜ=K_{ctl}V_{ctl}²

With this function, a control input increment of one volt from nine to ten volts produces a greater power output change than a control input increment of one volt from one to two volts, hence gain expansion.

An excellent expansion function is exponential:
Vₒᵤₜ=K_{ctl}exp(V_{ctl})

With this function, the output fractional (percentage) change is the same for a given input control voltage difference at any control level. This stabilizes the responsiveness of the power control loop over many orders of magnitude of signal strength.

This function can be implemented with a exponential gain control device, or a separate exponential function device together with a linear gain control device. An embodiment using a exponential gain control device is described in relation to FIG. 20. In this embodiment, operation is much the same as previously described for the linear power control case except that now the power control function 2018 controls the power output in a manner such that the power output, expressed in decibels (dB), is substantially proportional to the power control input voltage 2016 (V_{ctl}) (also referred to as, the power control command signal).

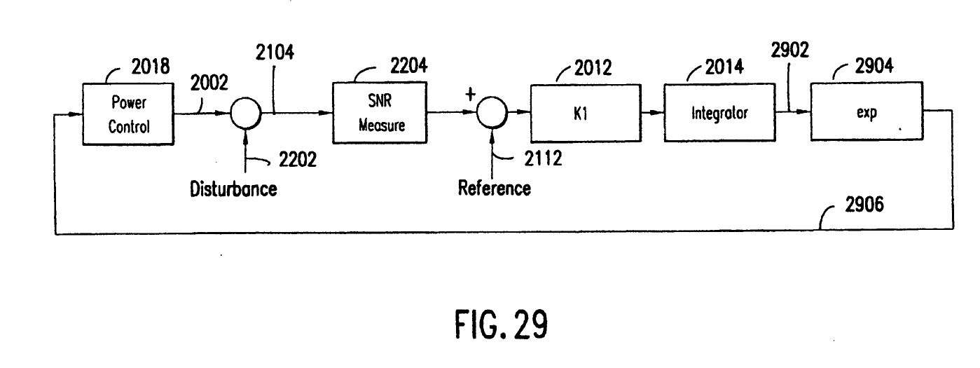

An alternative embodiment employing a separate exponential function and a linear gain control device will now be described with reference to FIG. 29. A signal 2002 (Vₒᵤₜ) having a transmitted power level is disturbed by the propagation path according to a disturbance 2202. The resulting received signal 2104 is evaluated for signal to noise ratio 2204 and compared with the desired signal to noise reference 2112. The result is then scaled by K₁ 2012 and summed or integrated over time by integrator 2014 to produce an output 2902. This output 2902 drives an exponential function 2904 to yield a power control command signal 2906 to command the power control function 2018 (1126 in FIG. 11) of a transmitter to output a signal 2002 (Vₒᵤₜ) having a new power level.

It should be apparent to one skilled in the art that the system functions illustrated in FIG. 29 from the reference 2112 to the exponential function 2904 can be partitioned into either the transmitter or receiver at the convenience of the designer. This embodiment can be modified to use BER information and log(BER) information as shown in FIGS. 22 and 23.

Where exponential power control and integration gain power control methods are combined, algorithm simplicity can result. The number of pulses is determined by the following relationship:
Np=2^{Kp P}
Where Np is the number of pulses per data bit to be transmitted;
P is the power control command; and
Kp is a scaling constant.

In one embodiment, Np is the only value in the above equation that is rounded to an integer. In another embodiment, greater implementation simplicity may be achieved by rounding the product KpP to an integer value. Thus, only power of two values need to be generated. In this embodiment, a command for lower power results in half of the present number of pulses per data bit being transmitted. Conversely, a command for more power results in twice the present number of pulses per data bit being transmitted. For example, in a system designed for full power at 128 pulses per bit, the product KpP=7 commands full power. Thus Kp=7/Pₘₐₓ such that the maximum value of P yields KpP=7. Because this represents fairly coarse steps in power increment, hysteresis can be used to advantage in the rounding of the KpP value to prevent instability at the rounding threshold.

Power Control in Combination with Variable Data Rate

Impulse radio systems lend themselves to adaptively changing the data rate according to data needs and link propagation conditions. The combination of power control methods and variable data rate methods requires special considerations. This is because it is not always advantageous to use power control to reduce signal power and minimize interference.

For example, in data systems, it is advantageous to use the maximum data rate possible for the link range and interference conditions, keeping the power at the maximum. Thus, power control would only be used where there is excess received signal at the maximum data rate available to the transceiver system. That is, where a transceiver is already transmitting at its maximum data rate, power control could be used to decrease power so long as such a decrease in power does not cause the data rate to decrease. For a constant message rate, the average interference is the same whether a high power/high data rate message is transmitted for a short time or whether a low power/low data rate message is transmitted over a longer time. The user of a computer system, however, would usually prefer the message to be transmitted in a short time.

In digital voice systems with constant data rate modems and compression/expansion algorithms, power control is the only option. In such systems, the power should be minimized. (It is, however, possible to send the data in blocks or packets at a burst rate higher than the average data rate.)

In digital voice systems with variable data rate modems and compression/expansion algorithms, the power can be minimized during low data rate intervals to minimize interference. In this case, it is also possible to maintain maximum power and maximum data rate, but to turn off the transmitter for intervals when no data is available.

Time-Domain Modulated TDMA Packet Radio

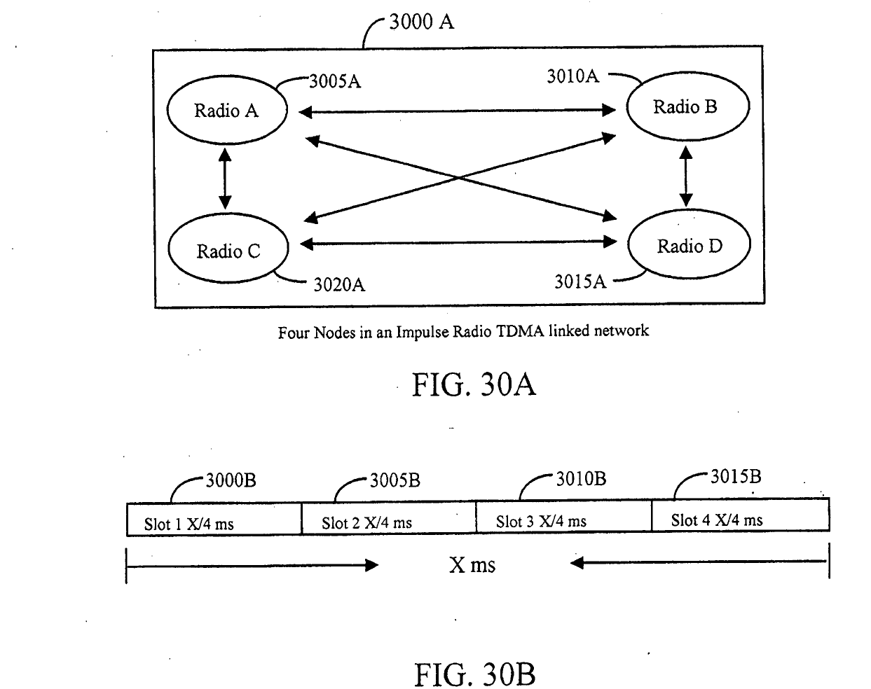

FIG. 30A illustrates an example of a four slot TDMA network 3000A. We begin with all radios off the air. As the first radio, 3005A, comes on, it pauses to listen to the current network traffic. After a reasonable delay, it powers on and, having heard no other traffic, takes control of the first slot shown in FIG. 30B as 3000B. While online, it will periodically send a hello request containing identifying information showing it owns slot 1. Although the network is considered ad hoc, the radio that owns the first TDMA slot has some unique responsibilities.

Radio B, 3010A, powers up next and begins to listen to network traffic. It notes that Radio A, 3005A, is on the air in the first slot. Radio B, 3010A, acquires slot 2, 3005B, and transmits a hello request at the slot two position 2, 3005B. The hello request prompts an exchange with Radio A, 3005A, as soon as his slot comes available. Radio A transmits a packet that will result in the acquisition of two pieces of information. Radio A, 3005A, sends a SYNC packet containing a request for an immediate acknowledgement. Radio B, 3010A, is thereby given permission to respond during Radio A's slot time. Radio B, 3010A, transmits a SYNC ACK packet in return. Radio A, 3005A, then calculates the distance to Radio B, 3010A, and properly adjusts the synchronization clock for the distance and sends the current time, adjusted for distance, to Radio B, 3010A. At this point Radio A's, 3005A, clock is synchronized with Radio B, 3010A. Once this occurs, any time Radio A, 3005A, transmits, Radio B, 3010A, is capable of calculating the distance to Radio A, 3005A, without a full duplex exchange. Also any time Radio B, 3010A, transmits, Radio A, 3005A, is capable of calculating the distance to Radio B, 3010A.

Through periodic SYNC packets to radio C, 3020A, and radio D, 3015A, on the network, clock synchronization could be maintained throughout the entire network of radios. Assuming that radio A, 3005A, radio B, 3010A, radio C, 3020A and radio D, 3015A, always transmit packets at the immediate start of their slot times 3000B, 3005B, 3010B, and 3015B, this system would allow all radios on a network to immediately calculate the distance to any other radio on the network whenever a radio transmitted a packet.

Multiple Correlator Receiver

With the development of precision, low noise synchronous programmable time delay integrated circuits, it is now feasible to build customized time modulated ultra-wideband systems that measure propagation and enable more accurate analysis and capture of incoming waveforms utilizing multiple correlators.

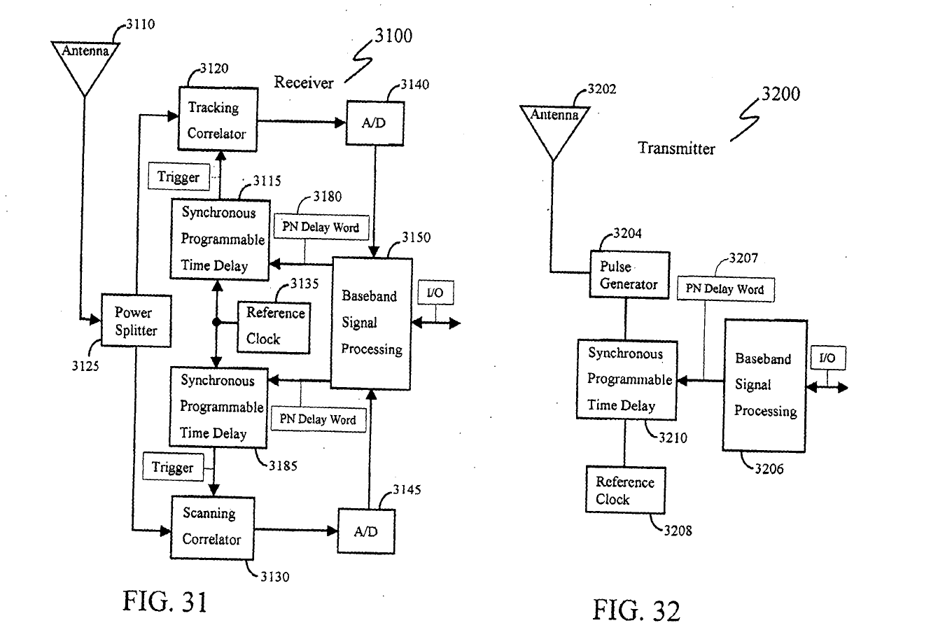

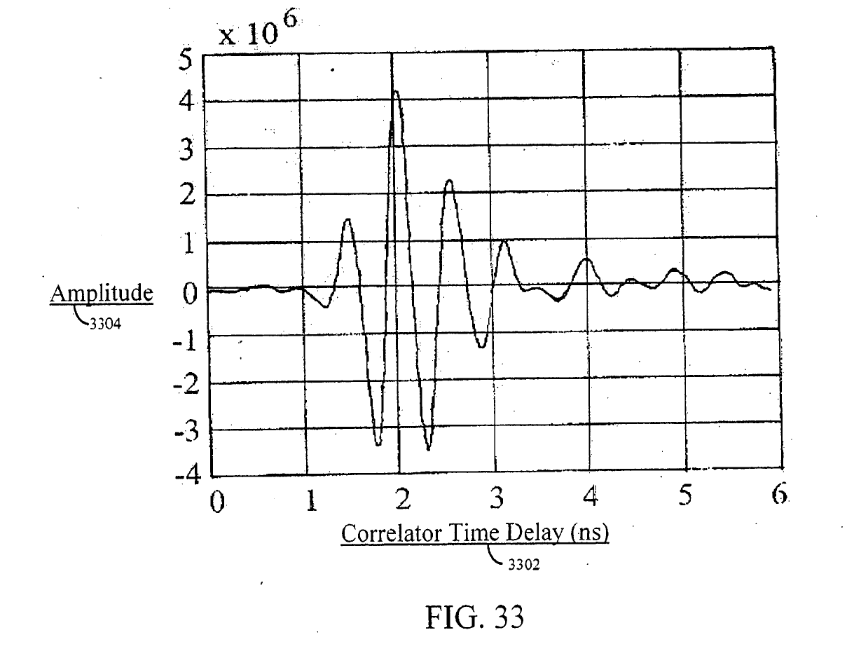

FIG. 31 illustrates at 3100 a block diagram for the multiple correlator scanning receiver. FIG. 32 illustrates at 3200 a corresponding impulse radio transmitter. In this implementation, the transmitter emits a 500 ps (measured trough to peak) ultra-wideband pulse at a 10 MHz pulse repetition frequency. FIG. 33 shows the output of the scanning receiver when it scans a single transmitted pulse with amplitude 3304 on the vertical axis and time 3302 on the horizontal axis. This measurement shows the filtering impact of the receive antenna, the correlation process, and that the transmitted pulse was filtered to reduce emissions below 1 GHz.

The present embodiment illustrates a scanning receiver comprising two correlators 3120, 3130 controlled by two timing systems 3115 and 3185. However, it is understood that any number of correlators (as illustrated hereinafter) can be used to achieve particular correlation results. One of the correlators is a tracking correlator 3120, which varies the phase of its internal coded template until it synchronizes with and is able to track the received pulse train. Any offset between the transmitted pulse repetition frequency and the receiver's internal pulse repetition frequency is detected as an error voltage in the correlation lock loop. Correlation lock loop as used in UWB is described fully in U.S. Pat. No. 5,832,035 entitled, “Fast Locking Mechanism for Channelized Ultrawide-Band Communications” and is incorporated herein by reference. Correlation Lock loop provides for acquisition and lock of an impulse radio signal.

Further, as referenced above, U.S. patent application Ser. No. 09/538,292, filed on Mar. 29, 2000, now U.S. Pat. No. 6,556,621 (issued Apr. 29, 2003) and entitled, “System for Fast Lock and Acquisition of Ultra-Wideband Signals” describes the most current methodologies for acquisition and fast lock and has been incorporated herein by reference.

This error in the correlation lock loop is corrected by synthesizing a frequency offset in the pseudo-random time hopping word 3180. This adjustment ensures the receiver's clock is within approximately 20 ps RMS of the received signal.

Once the tracking correlator 3120 is synchronized and locked to the incoming signal, the scanning correlator 3130 can sample the received waveform at precise time delays relative to the tracking point. By successively increasing the time delay while sampling the waveform, a complete, time-calibrated picture of the waveform can be collected. Also, scanning correlator 3130 can scan prior to the tracking correlator, thus the tracking correlator will be delayed in respect to the scanning correlator. Hence, the wave form information of FIG. 33 (with the Y-axis representing amplitude 3304 and X-axis representing correlator time delay 3302) can be accurately ascertained.

At the same time that waveform data is being captured, samples from the tracking correlator 3120 are also being collected. Samples from the tracking correlator represent integrated, demodulated data symbols prior to processing by the symbol decision logic. Samples from the scanning correlator 3130 and tracking correlator 3120 are collected in pairs so that events in the waveform sample set are time correlated with events in the data symbol set.

Although it is understood that any means of control can be utilized, in this embodiment, control of the system and data storage is provided by a Personal Computer or the like externally connected to the scanning receiver 3100. Several parameters can be varied when capturing a waveform. The scanning correlator 3130 can dwell at a time position for a specified number of pulses, allowing the baseband signal processor 3150 to integrate samples and minimize distortion due to noise. Sample time steps as small as 3.052 ps can be specified, but more typical step sizes are around 60 ps. Time delays of up to 13 ms before or after the tracking point can be specified for start of the waveform capture.

Functionally, and specifically in this embodiment, the incoming impulse RF signal is received via ultra wide band antenna 3110. The signal is split in power splitter 13125 thereby being split among the designed number of correlators. In this case there are two correlators (tracking correlator 3120 and scanning correlator 3130). The tracking correlator 1020 is triggered by a programmable synchronous time delay 3115 driven by reference clock 3135. The scanning correlator 3130 is triggered by synchronous programmable time delay 1085 which can be driven by the same reference clock 3135. The output of the tracking correlator passes to analog to digital converter 3140 with the digital signal passing to baseband signal processing 3150. The scanning correlator output also passes to analog to digital converter 3145 for input into baseband signal processing 3150.

FIG. 32 illustrates one possible impulse radio transmitter 3200 for transmission of the RF pulses received by the multiple correlator impulse radio receiver 3100. Baseband signal processor 3206 transmits PN delay word 3207 to synchronous programmable time delay 3210, which is driven by reference clock 3208. The output of synchronous programmable time delay 3210 passes to pulse generator 3204 for transmission by ultra-wideband antenna 3202.

There are a number of different RF front-end options which are defined by the configuration of the correlation circuits. The correlation function can be implemented in a custom silicon-germanium monolithic integrated circuit which has a single RF input and three independently triggered correlator circuits. One option uses a single integrated circuit for both the tracking and scanning function, providing a single RF input for both functions. Another option uses separate integrated circuits for the tracking and scanning functions, providing independent RF inputs and therefore separate antennas for tracking and scanning. Fixing the location of the tracking channel antenna creates a fixed time reference for the scanning channel, allowing the performance of antenna arrays to be estimated.

The ability of the scanning receiver 3100 to capture data symbols in parallel with waveform data allows it to be used not only for propagation studies but also as a complete link budget analysis tool.

As a propagation tool, the scanning receiver 3100 can be used to measure the impulse response of the environment between any two locations within the communication range of the radio link. In conjunction with application specific requirements, the response data can guide the selection of signal acquisition and tracking algorithms. For environments with significant multipath effects, it allows estimation of the marginal value of additional correlators for rake receiver applications. As used herein, rake receiver means utilizing a plurality of correlators simultaneously to improve acquisition and lock. Also, if the locations at which measurements are taken are closely spaced, i.e., the antenna is moved less than a pulse width between scans, then individual paths may be analyzed for amplitude fluctuations.

Because data capture is synchronized to always start at the same phase of the bit error test pattern, the user has a priori knowledge of the bit sequence and can compare expected data symbols to actual received symbols. This allows characterization of bit errors, guiding selection of error detection and correction techniques.

Symbol data captured from the tracking channel can be used to calculate the signal to noise ratio for the tracking point. Because the scanning channel is time-calibrated to the tracking channel, the location of the tracking point on the scanned waveform is known. The amplitude ratio of the actual tracking point to other potential tracking points on the waveform can be used to determine the achievable SNR for all other paths. This allows the benefit of coherent (rake) combining of multiple signal paths to be estimated.

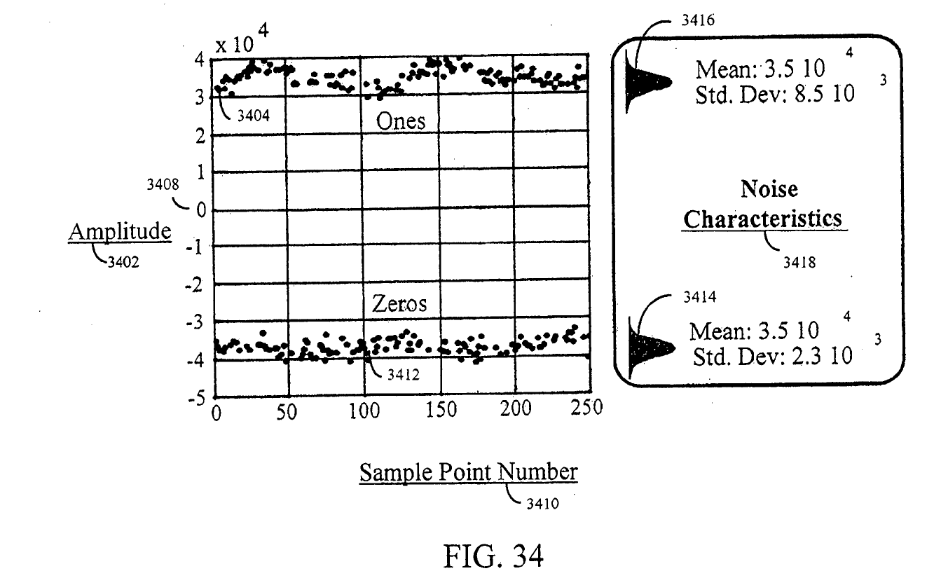

FIG. 34 illustrates the output of the tracking correlator for a 250 point scan. The Y-Axis 3402 is the amplitude of the voltage as represented by a binary count and the X-Axis 3410 is the sample point number. In this case there is little noise in the channel, since both the zero bits mean 3412 and the ones bit mean 3404 are at least four times the standard deviation away from the zero threshold 3408. Each of the tracking channel samples occurs as the scanning correlator dwells on a single point in time. Thus, each tracking correlator sample is a measure of the ambient noise during the scan. The noise characteristics 3418 mean for the “ones” are shown at 3416 and the mean for the “zeros” are shown at 3414.

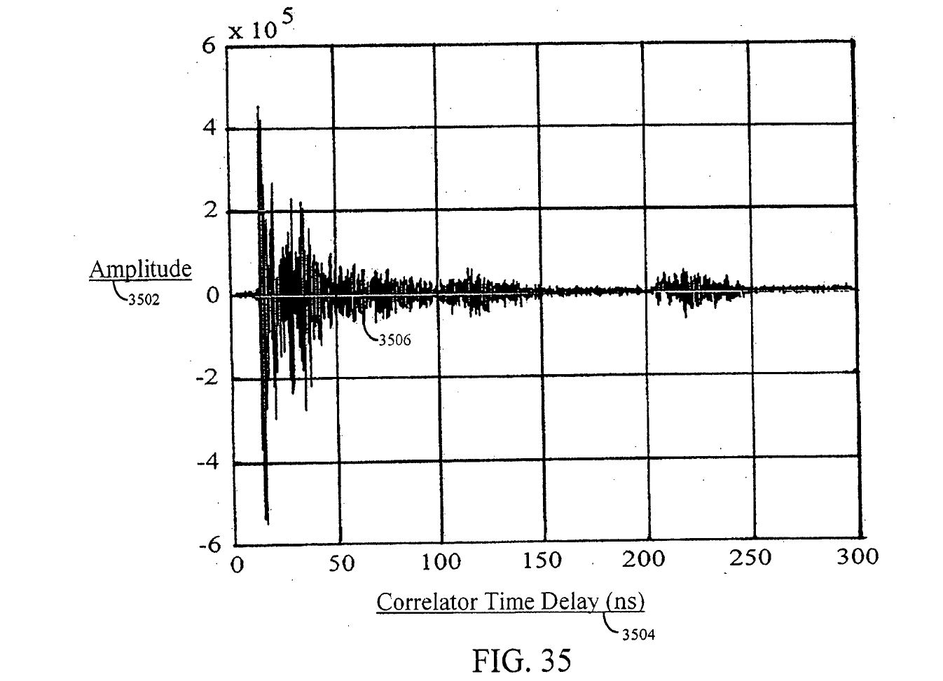

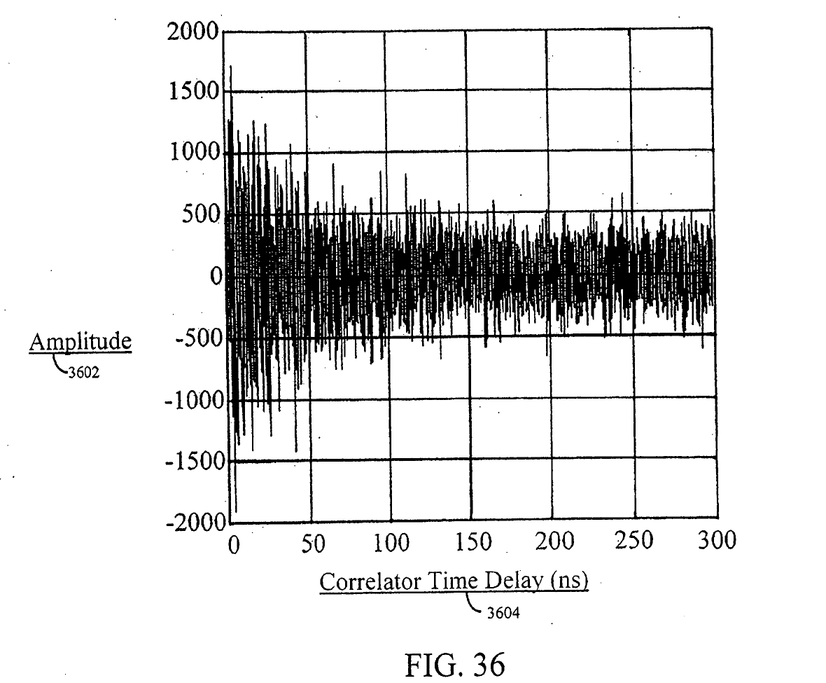

Illustrating the importance of determining waveform variations, FIGS. 35 and 36 show the impulse response measurements for two different in-building scans. FIG. 35 is the first scan is at a range of approximately 4 meters through a single wall (sheet rock over metal studs) with the Y-Axis 3502 representing Amplitude of the voltage as represented by a binary count and the X-Axis 3504 representing correlator time delay.

FIG. 36 is the second scan, again with the Y-Axis 3602 representing the amplitude of the voltage as represented by a binary count and the X-Axis 3604 representing correlator time delay, at a range of 21 meters through five walls of similar construction (i.e., sheet rock over metal studs). From these scans it becomes possible to evaluate the delay spread and an estimate of the number and quality of signal paths.

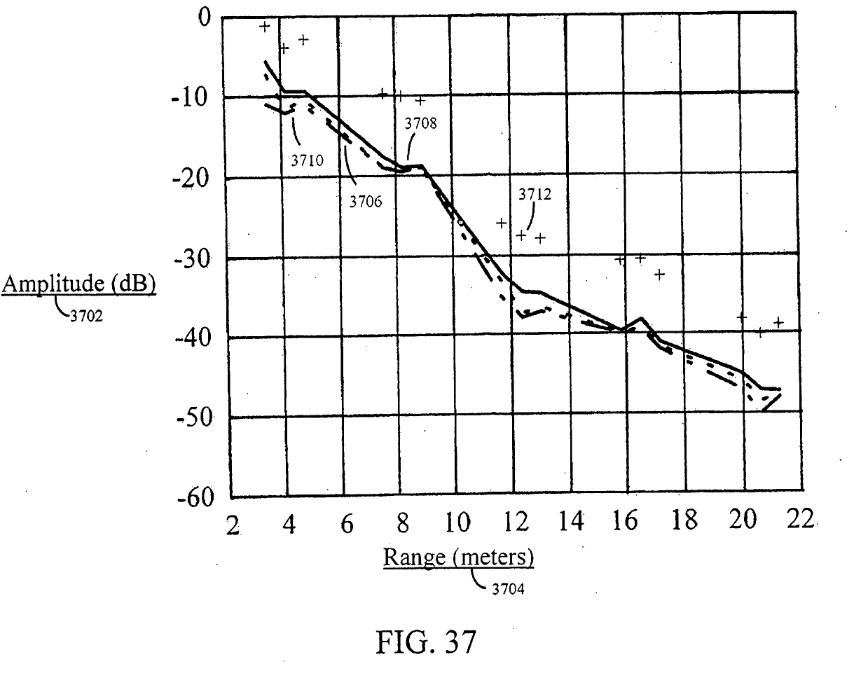

As mentioned above, the present scanning and tracking multiple correlator configuration can ascertain path characteristics. FIG. 37 presents the variation in power of the three best paths 3706, 3708 and 3710 at different distances; with the Y-Axis 3702 representing amplitude and the X-Axis 3704 representing range. Also shown is the coherent sum of the ten largest correlations 3712 as might be obtained with a variable tap rake receiver. The “+” sign indicates the coherent sum of the top ten correlation values as might be obtained from a variable tap rake receiver.

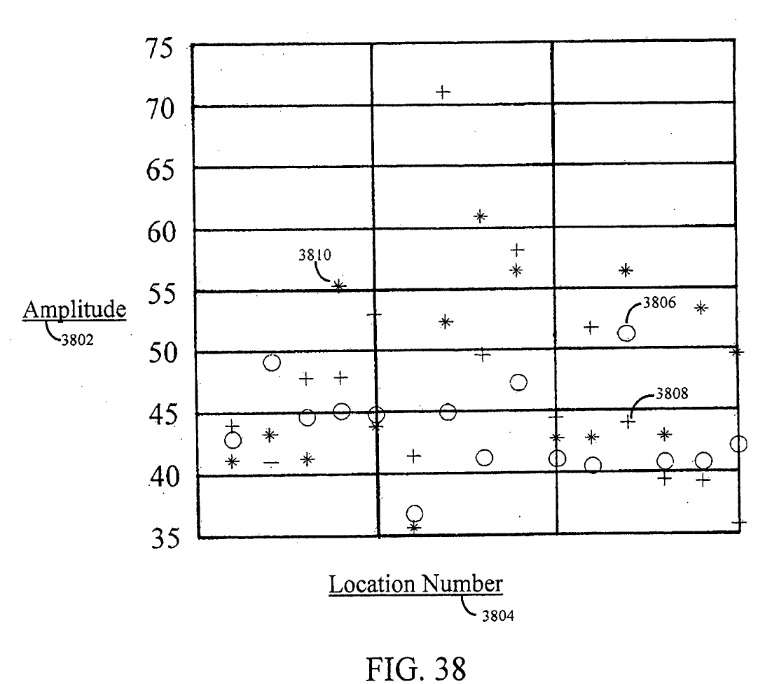

FIG. 38 shows the time of arrival of the three best correlations (time relative to scan start time) in a variable position testing environment. The Y-Axis 3802 represents the Time of Arrival and the X-Axis 3804 represents the Location Number. The location number corresponds to a different testing position throughout a testing environment. The largest (i.e., best or strongest) correlation is marked with “O” 3806, the second largest with “+’ 3808, and the third largest with “*” 3804. From this figure it can be seen that sometimes the strongest correlation is not the earliest arriving signal, e.g., at the third location, the strongest correlation occurred three nanoseconds after the third best correlation. By providing a scanning correlator in addition to a tracking correlator, the best correlation times can be ascertained.

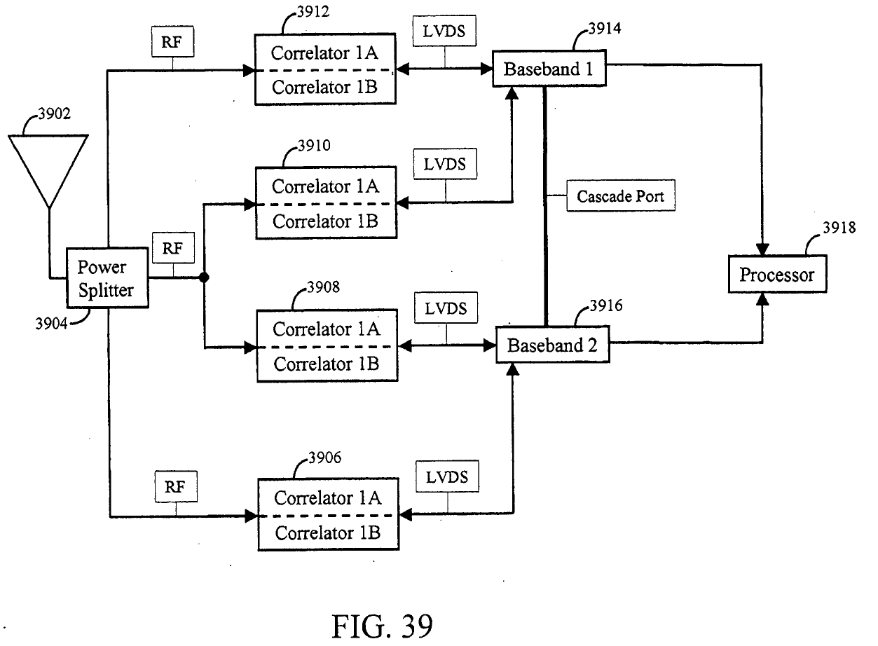

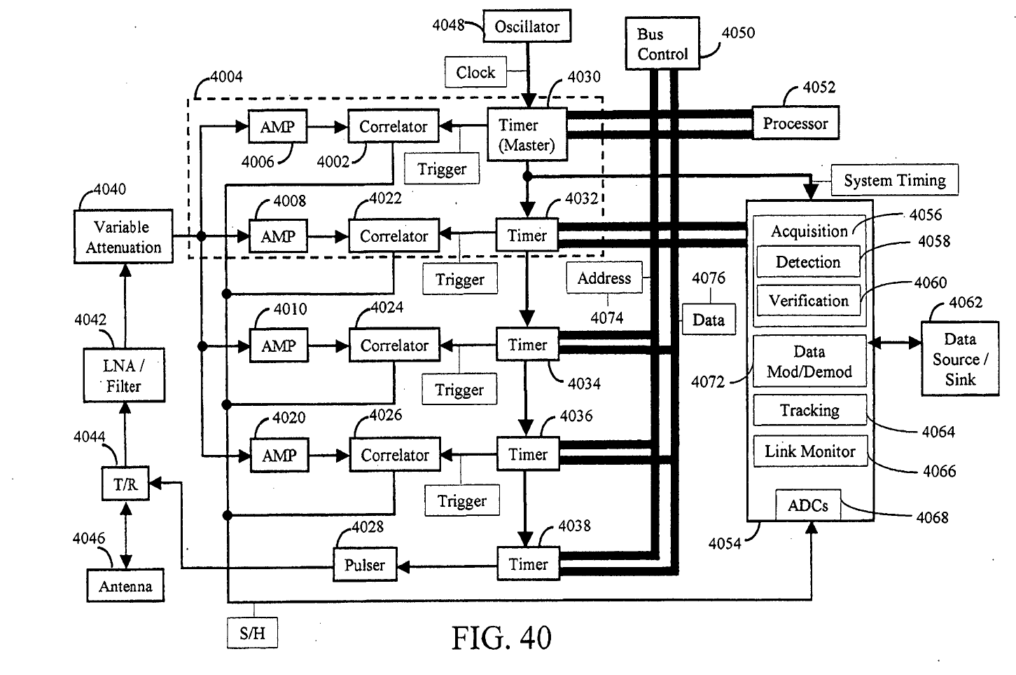

As mentioned above, the multiple correlator receiver can have great flexibility with respect to the number of timing generators and correlators in a given receiver. This determination will be based on design factors. FIG. 39 is an overview block diagram illustrating eight correlators—one of the correlators may be used as a pulser as illustrated in FIG. 40. In this design there are eight channels with one transmit channel, one scan channel and six receive channels. Impulse radio signals will be received by antenna 3902 and passed to power splitter 3904 whereafter RF Signals are passed to the plurality of correlators 3912, 3910, 3908, 3906 (in this case seven). Correlators 1A and 1B are at 3912 and provide transmitting and scanning functionality, Correlators 2A and 2B are at 3910 and provide 2 receive channels, Correlators 3A and 3B are at 3908 and provide two additional receive channels, Correlators 4A and 4B are at 3906 and provide another two receive channels.

The output of each correlator passes to baseband 1, 3914 or baseband 2, 3916, which can be connected via a cascade port (or any other interface between basebands to pass signal information). The output of the basebands, 3914 and 3916, are then sent to the processor 3918.

FIG. 40 more particularly sets forth the correlator configuration within a digital impulse radio architecture. Dashed line 4004 illustrates the components that would be included in blocks 3912, 3910, 3908 and 3906 of FIG. 39. Oscillator 4048 drives the master timer 4030 which triggers correlator 4002 and controls timer 4032 that triggers correlator 4022. It also triggers timer 4034 which triggers correlator 4024; triggers timer 4036 that triggers correlator 4026; and triggers timer 4038 which triggers pulser 4028.

Bus control 4050 controls address 4074 and data 4076 information between the timers 4030-4038, the processor 4052 and baseband 4054. The master timer also controls the system timing of the baseband 4054. The functionality included in the baseband is acquisition 4056 (both detection 4058 and verification 4060), data modulation and demodulation 4072, tracking 4064, link monitoring 4066 and analog to digital conversion 4068. A data source/link 4062 is interfaced with data modulation and demodulation 4072. The correlators 4002, 4022, 4024 and 4026 can go through a sample and hold process prior to communication with baseband 4054 via ADC 4068. The link monitor monitors the signal to noise ratio and/or the bit error rate to determine signal quality. If the bit error rate or signal to noise ratio fall below a preset criteria another acquisition and lock will be required. The signals received by the correlators originated from antenna 4046 which then pass through the transmit/receive switch 4044, which is in receive mode, through a low noise amplifier/filter 4042, a variable attenuator 4040 and finally through amplifiers 4006, 4008, 4010, and 4020, with each connected with respective correlators.

If the radio is in transmit mode, the timers 4030-4038 connect directly with pulser 4028 which emits pulses through antenna 4046 via transmit/receive switch 4044.

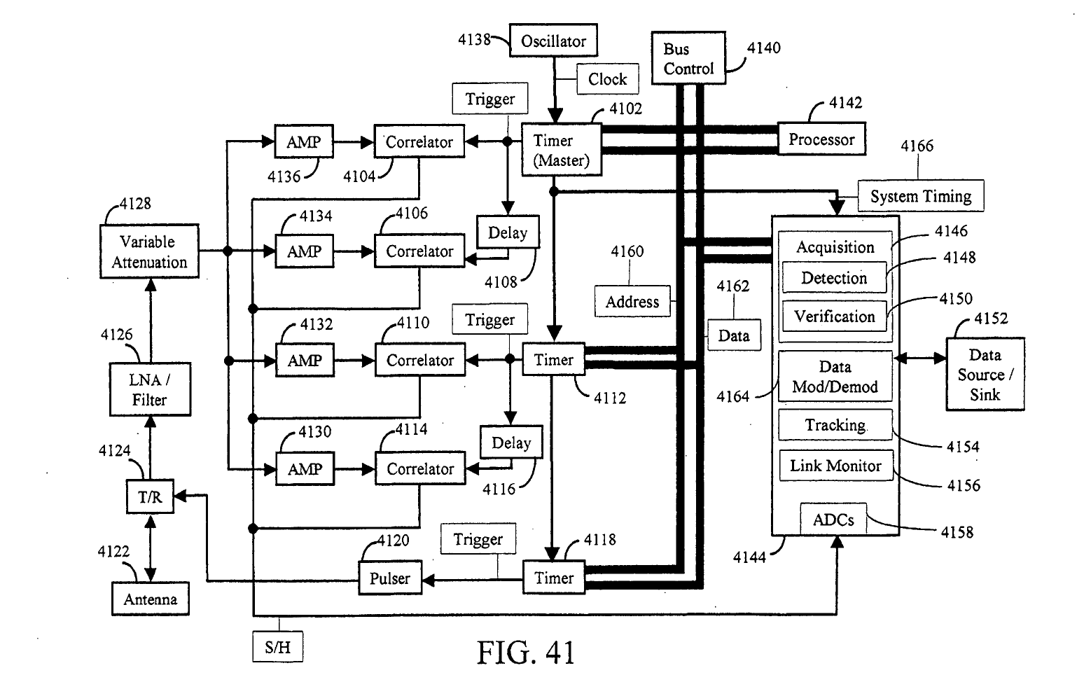

FIG. 41 illustrates the flexibility of the design wherein a distinct timer configuration is used. In this case, a separate timer is not associated with a given correlator, but rather timing master 4102 triggers correlator 4104 and, after delay 4108, also triggers correlator 4106. Thus, in essence correlator 4106 can be a slave of correlator 4104. Another timer 4112, driven by master timer 4102, triggers correlator 4110 and also, again after another delay 4116, triggers correlator 4114. A last timer 4118 can drive the pulser 4120 if the transceiver is acting as a transmitter. The remainder of the diagram is similar to FIG. 40, as addressed by the following description.

When transmit/receive switch 4124 is in receive mode, impulse radio antenna 4122 receives RF pulses, whereafter they pass to low noise amplifier/filter 4126. After passing through variable attenuator 4128, the RF signal passes through amplifiers 4130-4136 and into correlators 4104, 4106, 4110 and 4114. The correlator trigger timing is according to the aforementioned with correlator 4106 being a slave according to delay 4108 of correlator 4104 and correlator 4114 being a slave according to delay 4116 of correlator 4110. Again, the above configuration is for illustration only as any number of configurations are anticipated.

After correlation has occurred in each respective correlator, the correlated analog signal goes through an optional sample and hold and passes to analog to digital converter 4158 located in baseband 4144. As with the impulse radio of FIG. 40, the baseband provides link monitoring 4156, tracking 4154 and data modulation and demodulation 4164. The baseband also takes care of the acquisition 4146 functions of detection 4148 and verification 4150. A data source/link 4152 is also connected to baseband 4152.

Again, as with the multiple correlator impulse radio architecture of FIG. 40, bus control 4140 controls address and data information to and from the master timer 4102, timer 4112, timer 4118, processor 4142 and baseband 4144. The timing for the baseband is provided by master timer 4102 as depicted at 4166, which is driven by oscillator 4138.

If the impulse radio is in transmit mode then the oscillator 4138 drives the master timer 4102 which drives timer 4118 which triggers the pulser 4120, which transmits RF pulses to antenna 4122 via transmit/receive switch 4124.

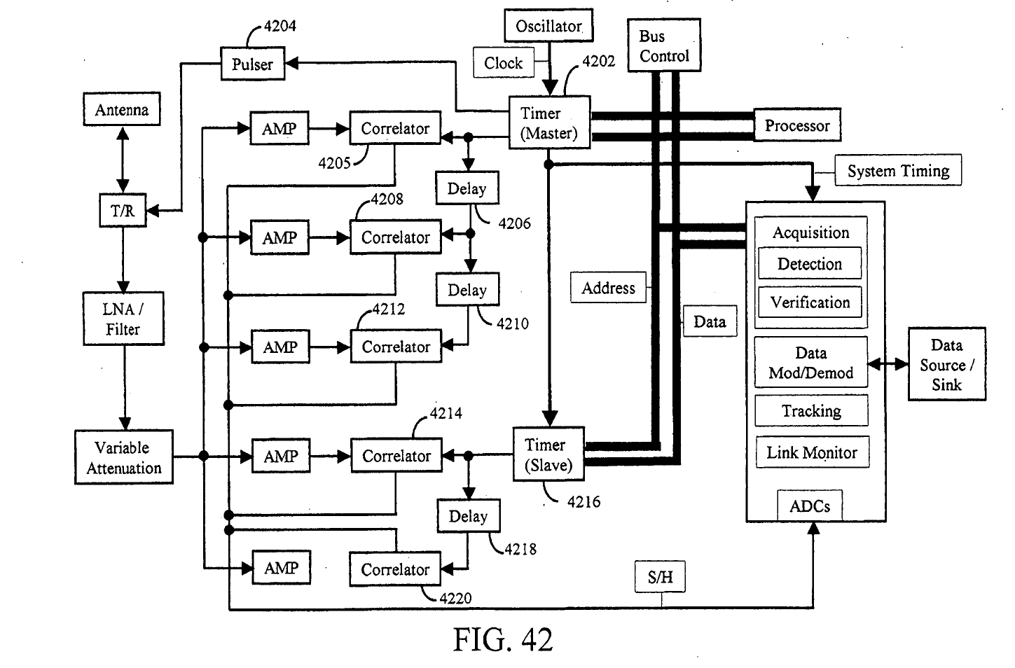

FIG. 42 is yet another distinct configuration of a multiple correlator receiver wherein slaved correlators are utilized and driven by the same timer as the master correlator with a delay there between. Herein master timer 4102 triggers correlator 4104. Correlator 4108 is slaved to correlator 4104 via delay 4106. Further, correlator 4112 is slaved to correlator 4104 via delay 4110. Correlator 4114 is triggered by slave timer 4116 which is driven by master timer 4102. Correlator 4120 is triggered by and slaved to via delay 4118, correlator 4114. The remainder of the diagram remains as in FIG. 40 and FIG. 41. As demonstrated, the number of correlators, whether or not they are slaved to preceding or subsequent correlators, the number of timers and whether they are slaved are all design options built according to the parameters dictated and the results desired.

Novel Transmit-Rake Apparatus

The disclosed novel transmit-rake apparatus overcomes the disadvantages associated with improving the signal-to-noise ratio in communication systems. An improved signal-to-noise ratio would allow transmission of information at higher speed, through higher interference, or to receivers at longer distances.

The transmit-rake apparatus according to the invention can improve the signal-to-noise ratio in a communication system without increasing the transmitted output RF power. It achieves that result by providing to a receiver a plurality of transmitted pulses that have individually selected timing and amplitudes. To achieve an even higher improvement in the signal-to-noise ratio, the transmit-rake apparatus according to the invention may individually select the polarity, as well as the timing and amplitude, of each of the plurality of pulses. The transmit-rake apparatus according to the invention preferably operates in ultra-wideband (also known as time-domain or impulse radio) communication systems that employ ultra-wideband signals.

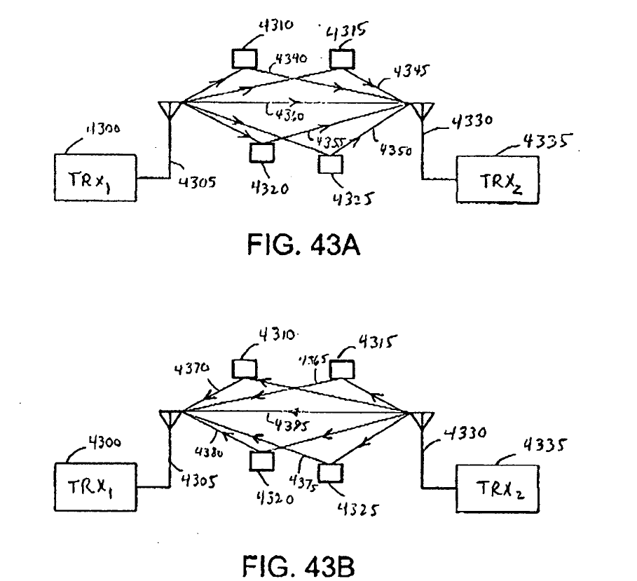

FIG. 43A shows a first transceiver 4300, TRX₁, transmitting, and a second transceiver 4335, TRX₂, receiving, in a multipath environment. The multipath environment includes a first obstruction 4310, a second obstruction 4315, a third obstruction 4320, and a fourth obstruction 4325. Each of the obstructions 4310, 4315, 4320, and 4325 typically reflects a signal that impacts the obstruction.

In FIG. 43A, the first transceiver 4300 transmits a signal via a first antenna 4305. A second antenna 4330 at the second transceiver 4335 receives from the first transceiver 4300 the direct-path signal 4360, as well as a first reflected signal 4340, a second reflected signal 4345, a third reflected signal 4350, and a fourth reflected signal 4355. Because each of the signals travels along a different path, each signal arrives at the second transceiver 4335 at a different time.

FIG. 43B shows the reciprocal of the situation depicted in FIG. 43A. Here, the second transceiver 4335 transmits a signal to the first transceiver 4300. Again, five signals arrive at the first transceiver 4300: a direct-path signal 4385, a first reflected signal 4365, a second reflected signal 4370, a third reflected signal 4375, and a fourth reflected signal 4380.

Because of the reciprocal nature of the multipath environment, the first transceiver 4300 may determine the time of arrival of each signal if it knows the characteristics of the multipath environment (e.g., the delays associated with each of the reflected signals because of the path obstructions, and the scaling of the amplitude of each signal because of its interaction with the multipath environment). The first transceiver 4300 may use the characteristics of the multipath environment to send signals to the second transceiver 4335 that take advantage of those characteristics. As described in more detail below, communication systems according to the invention include transmit-rake apparatus that takes advantage of the characteristics of the multipath environment.

The first transceiver 4300 may ascertain the characteristics of the multipath environment by receiving the multipath characteristics from an external source, for example, the second transceiver 4335, or a receiver. In this scenario, the external source determines the characteristics of the multipath and sends the multipath information to the first transceiver 4300. Such an arrangement allows the first transceiver 4300 to be a cheaper, less complex transceiver than one capable of determining multipath characteristics. The multipath information may contain characteristics of the multipath environment, for example, the number and magnitudes of delays, the amplitude scaling of signals because of the path obstructions, and the like. The first transceiver 4300 may receive the multipath information from the external source either over the air (i.e., through signals transmitted from the external source that contain the multipath information), or through wire lines (e.g., telephone lines, network lines, and the like). Generally, a first transceiver, or receiver, having capabilities to determine multipath characteristics can receive signals from a second transceiver or a transmitter, determine the multipath characteristics of the received signals, and send information pertaining to the determined multipath characteristics to the second transceiver or transmitter in support of a transmit rake approach or rake receiver approach, or to be used for some other purpose.

Alternatively, the first transceiver 4300 may determine the characteristics of the multipath environment by analyzing the multipath signals it receives from an external source, for example, the second transceiver 4335, or a receiver. In this mode, the first transceiver 4300 may use the multiple-correlator techniques (i.e., using a plurality of correlators in a rake receiver to perform scanning and locking) described above to determine the multipath information.

As yet another alternative, the first transceiver 4300 may receive signal-quality information from an external source, for example, the second transceiver 4335, or a receiver. The signal-quality information is derived using power-control techniques described above, and may include, among other things, signal quality measures, signal-to-noise ratio, and bit-error rate.

Alternatively, the first transceiver 4300 may derive the signal-quality information locally from signals it receives from an external source, for example, the second transceiver 4335, or a receiver.

Note that FIGS. 43A and 43B show two transceivers and a multipath environment with four obstructions for illustrative purposes only. The principles described above and shown in FIGS. 43A and 43B apply also to configurations that include a different number of transceivers, a different number of obstructions, or both. Moreover, although FIGS. 43A and 43B show a communication system including transceivers, the described concepts apply to other configurations. For example, rather than transceivers, one may use separate, but communicating, transmitters and receivers. In other words, referring to FIGS. 43A and 43B, one may replace the first transceiver 4300 and the second transceiver 4335 with a transmitter and a receiver, respectively. In that case, the transmitter and the receiver may communicate either through an RF link or through a wire-line link, as persons skilled in the art would understand.

Multipath analysis of the multipath signals preferably operates on the tallest signals (i.e., those signals with the largest amplitudes), as FIGS. 44A and 44B illustrate. FIG. 44A shows a signal comprising a series of pulses 4405, transmitted in a multipath environment. The pulses preferably constitute ultra-wideband signals and may incorporate modulation. One may analyze various numbers of pulses, depending on system design considerations, for example, cost, complexity, and performance, as persons skilled in the art would understand.

FIG. 44B shows a received signal 4410 in a multipath environment. Because of the interaction of the transmitted pulses 4405 with the multipath obstructions, the received signal 4410 includes a plurality of pulses with varying amplitudes and timing. The complex shape of the received signal 4410 results from the interaction at the receiver of the direct-path signal and the reflected signals. To improve the signal-to-noise ratio at the receiver, the transmit-rake apparatus identifies some of the pulses with large amplitudes, labeled as A, B, C, and D in FIG. 44B, in the received signal 4410. Note that FIG. 44B identifies four of the taller peaks for illustration purpose only; one may identify and use other numbers of pulses with large amplitudes, as desired. The transmit-rake apparatus improves the signal-to-noise ratio as follows.

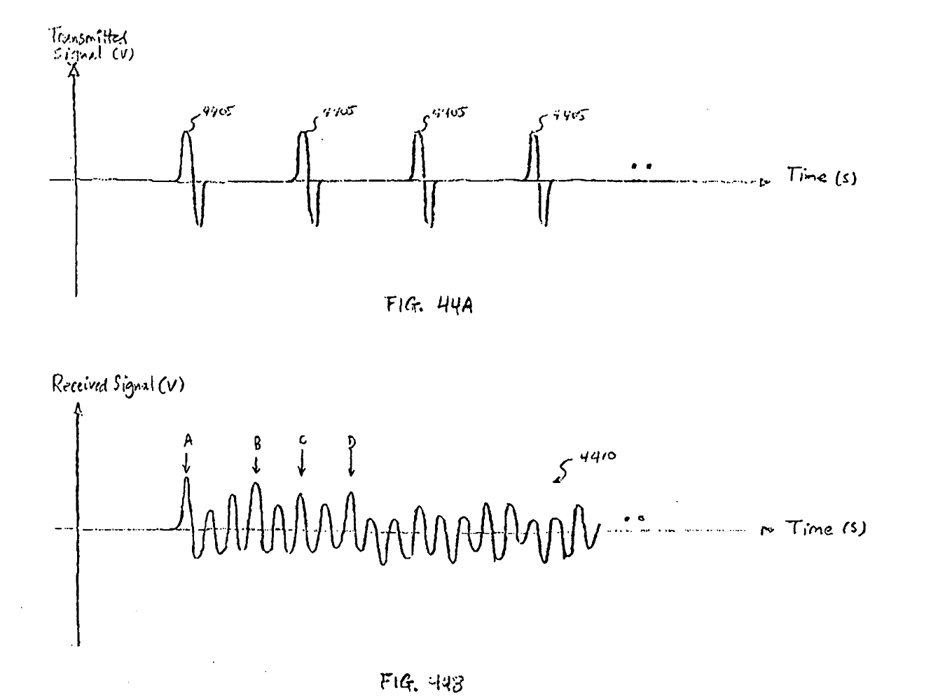

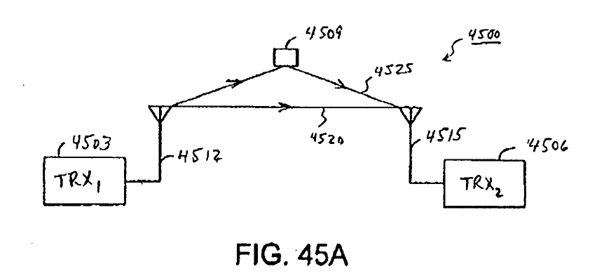

FIG. 45A shows a communication system 4500 that includes a first transceiver 4503 that includes transmit-rake apparatus according to the invention (not shown explicitly), and a second transceiver 4506. The communication system 4500 preferably employs ultra-wideband signals. As noted above, rather than using the first transceiver 4503 and the second transceiver 4506, one may use a transmitter and a receiver, as desired. The communication system 4500 operates in a multipath environment that includes an obstruction 4509.

The first transceiver 4503 transmits via antenna 4512 a signal to the second transceiver 4506. Because of the obstruction 4509, the antenna 4515 of the second transceiver 4506 receives a direct-path signal 4520 and a multipath (or reflected-path) signal 4525. Because the direct-path signal 4520 and the reflected-path signal 4525 travel along paths with different lengths, they arrive at antenna 4515 at different points in time.

FIG. 45B illustrates as a function of time a signal, P, that the first transceiver 4503 (see FIG. 45A) transmits in the multipath environment. FIG. 45C shows as a function of time the signals that the antenna 4515 (see FIG. 45A) receives. The received signal includes a direct-path signal, A, and a reflected-path signal, B. Because of the interaction of signals with the multipath environment, the reflected-path signal B may have a different amplitude than the direct-path signal A. In other words, the multipath environment has a gain ratio, g, given by

$$g = \frac{{V}_{B}}{{V}_{A}} ,$$

where V_{B} denotes the amplitude of the reflected-path signal and V_{A} denotes the amplitude of the direct-path signal. The direct-path signal A arrives at antenna 4515 (see FIG. 45A) first. After a time period, τ, the reflect-path signal, B, arrives at antenna 4515. According to the invention, using the characteristics of the multipath environment, the first transceiver 4503 may transmit a plurality of pulses that, because of their selected timing and amplitudes, improve the signal-to-noise ratio at the second transceiver 4506.

The first transceiver 4503 selects the timing and amplitudes of the plurality of pulses by employing transmit-rake apparatus (not shown explicitly in FIG. 45A). To improve the signal-to-noise ratio, the transmit-rake apparatus according to invention uses the characteristics of the multipath environment (e.g., the location in time and amplitudes of the pulses in the multipath signal and the gain ratio of the multipath environment). The first transceiver 4503 may obtain the characteristics of the multipath environment using one of the techniques discussed above.

Referring to FIG. 45C, assume that the transmit-rake apparatus has obtained the amplitudes of the signals A and B, and their respective timing and, thus, the time period τ. The transmit-rake apparatus causes the transmission of a plurality of pulses, having selected timing and amplitudes, as shown in FIG. 45D. The transmitted signal in FIG. 45D comprises two signals, P₁ and P₂. The transmit-rake apparatus preferably selects the amplitudes of the transmitted signals so that the total transmitted power is below a pre-determined level, for example, a level prescribed by regulatory authorities or a level intended to minimize interference with other impulse radios.

Signal P₁ has an amplitude proportional to signal B (see FIG. 45C) and signal P₂ has an amplitude proportional to signal A (see FIG. 45C). Signal P₁ and P₂, however, have a reverse timing relation compared to signals A and B. In other words, signal P₂ lags signal P₁ by a time period τ. The transmit-rake apparatus causes the transmission of signal P₁ before signal P₂ by the time period τ. This arrangement of the transmitted signals improves the signal-to-noise ratio at the signal destination, as described in more detail below.

FIG. 45E shows the direct-path signal, RX_{A}, arriving at antenna 4515. The direct-path signal RX_{A} comprises signals P_{1A} and P_{2A}. Signal P_{1A} constitutes the received direct-path signal, and corresponds to transmitted signal P₁. Signal P_{2A} constitutes the received direct-path signal, and corresponds to transmitted signal P₂. Note that signal P_{1A} leads signal P_{2A} by the time period τ.

FIG. 45F illustrates the reflected-path signal, RX_{B}, arriving at antenna 4515. The reflected-path signal RX_{B} comprises signals P_{1B} and P_{2B}. Signal P_{1B} constitutes the received direct-path signal, and corresponds to transmitted signal P₁. Signal P_{2B} constitutes the received direct-path signal, and corresponds to transmitted signal P₂. Note again that signal P_{1B} leads signal P_{2B} by the time period τ.

Finally, FIG. 45G shows the sum or composite signal, RXₛᵤₘ, that the antenna 4515 receives. Because of the particular timing of the transmitted signals based on the characteristics of the multipath environment, signals P_{2A} and P_{1B} coincide with each other and, therefore, add. As a result, the sum signal RXₛᵤₘ comprises signals P_{1A}, P_{2A}+P_{1B}, and P_{2B}. Note that signal P_{1A} leads signal P_{2A}+P_{1B} by the time period τ. Note also that signal P_{2B} lags signal P_{2A}+P_{1B} by the time period τ.

The second transceiver 4506 (see FIG. 45A) locks onto and receives signal P_{2A}+P_{1B}. Because signal P_{2A}+P_{1B} has a larger amplitude than either transmitted signal (i.e., larger than either signal P₁ or signal P₂), it provides a higher received power at the antenna 4506 (see FIG. 45A). The increased power in turn results in a higher signal power relative to noise power. Thus, the particular arrangement by the transmit-rake apparatus of the timing and amplitudes of the plurality of transmitted signals improves the signal-to-noise ratio at the second transceiver 4506 without increasing the total transmitted power.

To facilitate the description of the invention, the communication system 4500 in FIG. 45A and the corresponding signals shown in FIGS. 45B-45G assume using two transceivers (4503 and 4506) operating in a multipath environment that includes a single obstruction 4509 that generates a multipath reflection. Note, however, that one may use a different number of transceivers (or transmitters and receivers), a different number of obstructions, or both, as desired, and still obtain an improvement in the signal-to-noise ratio. For example, if the signal path includes more than one obstruction, the receiver's antenna would typically receive a plurality of reflected-path pulses that would produce a complex received signal. Even in that case, the transmit-rake apparatus according to the invention would improve the signal-to-noise ratio at the receiver.

Starting with the characteristics of the multipath environment, the transmit-rake apparatus would identify and select the timing and amplitude corresponding to the direct-path signal that a receiver would receive in the particular multipath environment. The transmit-rake apparatus would also identify and select the timing and amplitudes corresponding to one or more of the largest signals that the receiver would receive in the particular multipath environment. The transmit-rake apparatus would select the amplitudes of the selected signals according to their magnitude relative to the direct-path signal. Finally, the transmit-rake apparatus would transmit a plurality of pulses having the selected timing and amplitudes. The transmitted signals would have a reverse timing relationship, similar to the system described above with reference to FIGS. 45A-45G. Note that one may select a suitable number of signals, depending on the desired characteristics of the overall communication system, such as cost, complexity, and the desired improvement in signal-to-noise ratio.

TABLE 1

| | | | | Gain at Receiver | |
|---|---|---|---|---|---|
| | | | P1\hat{ }2 + P2\hat{ }2 | (P1 + g*P2)\hat{ }2 | P1 + g*P2 |
| g | P1 | P2 | Radiated Power | Power Gain | Gain in dB |
| 0.00 | 1.000 | 0.000 | 1.00 | 1.000 | 0.0 |
| 0.10 | 0.995 | 0.100 | 1.00 | 1.198 | 0.8 |
| 0.20 | 0.981 | 0.196 | 1.00 | 1.385 | 1.4 |
| 0.30 | 0.958 | 0.287 | 1.00 | 1.550 | 1.9 |
| 0.40 | 0.928 | 0.371 | 1.00 | 1.690 | 2.3 |
| 0.50 | 0.894 | 0.447 | 1.00 | 1.800 | 2.6 |
| 0.60 | 0.857 | 0.514 | 1.00 | 1.882 | 2.7 |
| 0.70 | 0.819 | 0.573 | 1.00 | 1.940 | 2.9 |
| 0.80 | 0.781 | 0.625 | 1.00 | 1.976 | 3.0 |
| 0.90 | 0.743 | 0.669 | 1.00 | 1.994 | 3.0 |
| 1.00 | 0.707 | 0.707 | 1.00 | 2.000 | 3.0 |

Table 1 shows the power of the received signal for various amplitudes of two transmitted pulses P₁ and P₂ as shown in FIG. 45D. In the first column the value of g varies from 0.00 to 1.00 in increments of 0.1, where the value of g is determined by, for example, a multipath analyzer. Knowing the value of g, the transceiver can control amplitudes of the signals P₁ and P₂ in FIG. 45D. The value of P₁ is determined from g using the following equation:

$${P}_{1} = \sqrt{1 / 1 + {g}^{2}}$$

Under this arrangement, P₁ always has the largest amplitude. The value of P₂ is then determined from P₁ where P₁²+P₂²=1 (i.e., the squares of the magnitudes of signals P₁ and P₂ add to unity). Accordingly, the radiated power is equal in all cases (as shown in the fourth column). The fifth and sixth columns represent the gain achieved by using rake transmitting. This gain is expressed as a linear power ratio in column 5 and as dB in column 6.

Generally, the gain that can be achieved increases with the number of rake-transmitted signals. In an ideal case, the transmitted signal would comprise a sequence of pulses, each proportional to its corresponding multipath reflection, but in reverse order in time. This would result in a time reverse copy of the multipath response waveform as received by the receiver, resulting from a single transmitted pulse. In one embodiment, a first transceiver or transmitter transmits a sequence of pulses, which may be monocycle pulses or have some other form. A second transceiver or a receiver uses the multiple-correlator techniques described above or comparable techniques to determine the multipath response of the signals received from the first transceiver or transmitter. The second transceiver or receiver provides the multipath signal information to the first transceiver or transmitter. The first transceiver or transmitter then transmits signals that are identical to the provided multipath signal but reversed in time such that the transmitted signals resemble mirror images of the multipath signal. The second transceiver or receiver then detects the received pulse as described previously.

In another embodiment of the present invention, rake-transmitted signals are varied over time to remove periodicity of the rake-transmitted signals. By varying the rake-transmitted pulses, spectral lines in the frequency domain are avoided, the likelihood of causing interference to other devices is reduced, and the signal becomes less observable Under this arrangement, some number of the largest signals that the receiver would receive in the particular multipath environment are selected. Some number of combinations of rake-transmitted signals is determined involving different signals of the largest signals and/or different numbers of rake-transmitted signals. For example, if six of the largest reflection signals that the receiver would receive in the particular environment are selected and numbered 1 through 6, each of these signals can separately or in various combinations be used to produce different composite rake-transmitted signals. Furthermore, sequences of these different composite rake-transmitted signals can be transmitted in some order, for example, a pseudorandom order. The different composite signals and order of the rake-transmitted signals may also be coordinated between two transceivers, or the transmitter and the receiver.

In one embodiment of the present invention that utilizes sets of composite signals, it is desirable that the amplitude of each transmitted composite signal be the same. (e.g. a composite signal comprising pulses 1, 3, and 6 should have the same transmitted energy as a composite signal comprising pulses 1, 2, and 5.) In this embodiment, the ideal receive weighting factor for each composite signal is potentially different from one to another, even though the transmit energy is the same. This can be illustrated by comparing a composite signal comprising a single pulse with a composite signal comprising two pulses of the same amplitude. This is the case illustrated in table 1, the result being double the power, or 3 dB gain for the double pulse composite signal. This is somewhat surprising considering the transmit power is the same in both cases. In another example, a composite signal of four equal pulses may be compared with one with a single pulse. For this example, there is a six dB gain. It follows, that a favorable configuration is one that provides a large set of reflections that are nearly equal in amplitude, as large a set as the transceiver is designed to handle, that is. Since each composite signal may have a different signal to noise ratio at the receiver, it may be desirable to assign a correspondingly variable information rate to the transmitted data or to provide this signal to noise data to an error correction algorithm to optimize the resulting decoded data.

In one embodiment, sets of composite signals having the same transmit power are transmitted, and the received composite signals are weighted and summed such that the sum of the weighted, received composite signals is substantially the same for each data bit. For example, a first data bit may be transmitted by sending a sequence of composite signals that is received using weighting factors 1, 3, 2 and the next data bit may be sent by sending a reordered sequence of composite signals that is received using weighting factors of 2, 1, 3. Note that the second data bit may instead be transmitted using the same sequence of composite signals and received using the same weighting factors as the first data bit, or may be transmitted using a different sequence of composite signals and weighting factors such that the sum of the weighted, received composite signals is substantially the same as for the first data bit.

With this approach, weighting factors may be determined which scale the received composite signals to a selected received composite signal used as a reference, for example, the received composite signal having the greatest gain. Specifically, weighting factors may be determined for the composite signals by dividing the gain of the selected received composite signal by the gain of the composite signals. The transceiver or receiver receiving the composite signals then uses a variable amplifier to amplify them in accordance with the weighting factors before their energy is summed. For example, if composite signals corresponding to a g of 0.3, 0.5, and 1 are used in accordance with Table 1, gains of 1.55, 1.8, and 2, may be expected at the receiver. The received composite signal having a gain of 2 may be selected as a reference. Thus, weighting factors of 2/1.55, 2/1.8, and 2/2, or 1.29, 1.1111, 1, respectively, can be used to amplify the corresponding received composite signals such that their amplitude is the same before being contributed to an integration ramp. Alternative approaches for determining weighting factors may also be used.

In another embodiment of the present invention that utilizes sets of composite signals, it is desirable that the transmit power vary from one composite signal to another such that the received weighting factor is the same for each composite signal. In the example comparing a single pulse to a pair of equal pulses, the gain was found to be 3 dB. Accordingly for the present embodiment, the transmit power for the double pulse signal would be reduced 3 dB to maintain equal received signal to noise ratio. Likewise, in the four pulse example, the transmitter power would be reduced by six dB. Since this system has a constant signal to noise for each sample, it makes sense to assign a constant information rate to the composite signals, e.g. one bit; or one chip or ¼ bit per composite signal, according to the system design.

For these embodiments, the multipath reflection configuration is usually dependent on the environment and it is up to the transceiver to detect the environment and utilize the reflections that are available. Some systems, however, may allow positioning of reflectors or positioning of the transceiver to maximize or optimize this effect. It becomes possible with this technique to bring reflectors into the vacinity of a transceiver and obtain gain from their proximate presence. The reflectors do not need to be carefully aimed as in a conventional dish or other directional antenna.

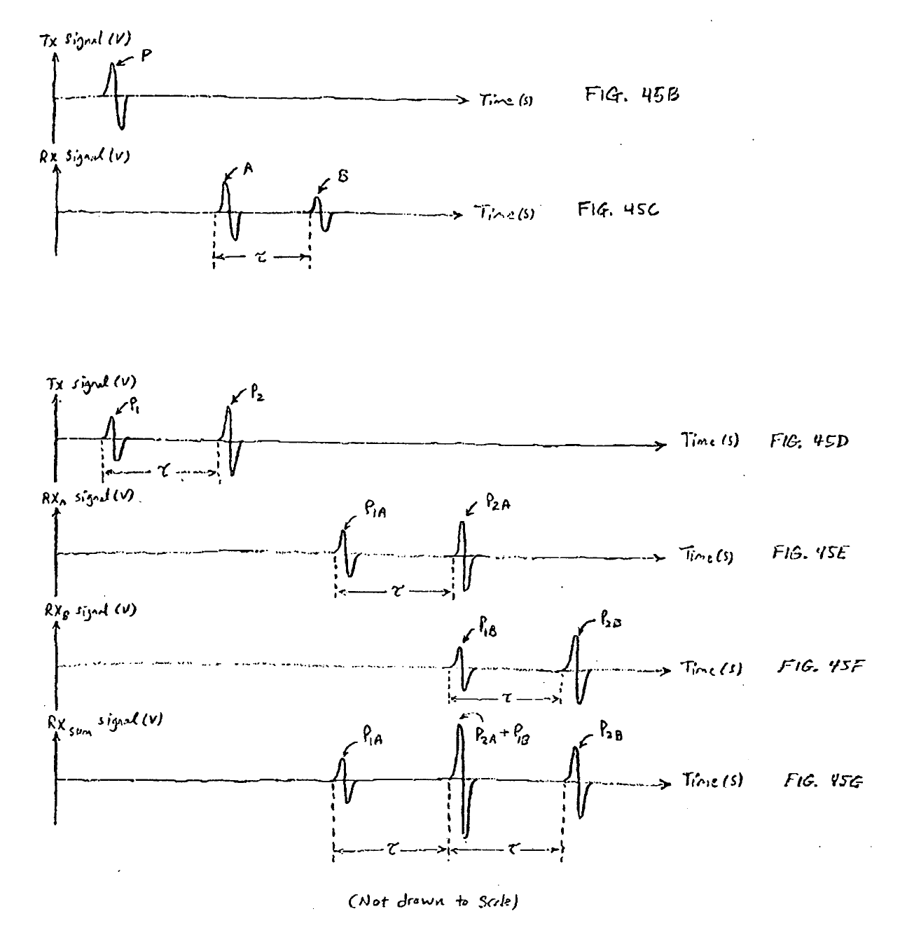

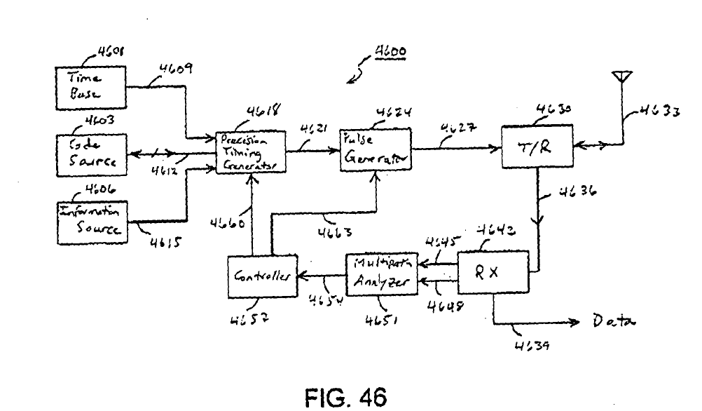

FIG. 46 illustrates an embodiment of a transceiver 4600 that includes transmit-rake apparatus according to the invention. The transceiver 4600 includes a time base 4601, a code source 4603, and an information source 4606. The time base 4601, the code source 4603, and the information source 4606 couple to a precision-timing generator 4618. As described above, the time base 4601 provides a periodic timing signal 4609 to the precision-timing generator 4618.

The precision-timing generator 4618 exchanges synchronization/code signals 4612 with the code source 4603. The synchronization/code signals 4612 comprise synchronization signals that the precision-timing generator 4618 provides to the code source 4603. The synchronization/code signals 4612 also comprise code source signals provided to the precision-timing generator 4618.

The precision-timing generator 4618 uses the code source signals received from the code source 4603 and an information signal 4615 from an information source 4606 to generate a modulated, coded timing signal 4621. The information source 4606 may supply a variety of information signals 4615, for example, analog signals, digital signals, or both. The information signals 4615 may include voice, data, graphics, or complex signals.

The precision-timing signal generator 4618 supplies the timing signal 4621 to a pulse generator 4624. The pulse generator 4624 supplies output pulses 4627 to a transmit/receive switch 4630. The function of the transmit/receive switch 4630 depends on the mode of the transceiver 4600, i.e., whether the transceiver 4600 operates in the transmit mode or the receive mode. When the transceiver 4600 operates in its transmit mode, the transmit/receive switch 4630 supplies the output pulses 4627 to an antenna 4633. The antenna 4633 radiates the output pulses into a communication medium.

When the transceiver 4600 operates in its receive mode, the antenna 4633 receives a signal from the communication medium and provides it to the transmit/receive switch 4630. The transmit/receive switch 4630 supplies the received signal 4636 to a receiver 4642. The receiver 4642 demodulates and decodes the received signal 4636. The receiver 4642 extracts user data from the received signal 4636 and provides a data signal 4639 to the transceiver's user.

The received signal 4636 may include control data, for example, header or control information, as desired. The control data may include multipath information, signal-quality information, or both, in addition to other data, depending on a particular application. The receiver 4642 extracts the control data from the received signal 4636 and provides a control data signal 4645 to a multipath analyzer 4651. The receiver 4642 may alternatively receive the control data signal 4645 from an external source (not shown explicitly in FIG. 46) and provide that signal to the multipath analyzer 4651. The receiver 4642 may receive the control data signal 4645 through an RF link (e.g., through antenna 4633) or through a wire line (e.g., telephone lines, land-wire connections, or network connections).

The receiver 4642 may also provide signal-quality information 4648 to the multipath analyzer 4651, as desired. The signal-quality information 4648 may include information about the signal strength and quality, the signal-to-noise ratio, the bit-error rate, or a combination of those measures. Similar to the control data signal 4645, the receiver 4642 may receive the signal-quality information 4648 through an RF link (e.g., through antenna 4633) or through a wire line (e.g., telephone lines, land-wire connections, or network connections).

Transmit-rake apparatus according to the invention may use the signal-quality information adaptively, as desired. To use the information adaptively, the transceiver 4600 first selects the timing and amplitude of at least one of the plurality of the pulses that it transmits. The transceiver 4600 then receives and evaluates the signal-quality information. Based on the signal-quality information, the transceiver 4600 alters the selected timing, amplitude, or both, of the pulse or pulses, and transmits at least one pulse. The transceiver 4600 repeats this process as desired until it obtains an optimal set of timing and amplitude values for the plurality of signals that it transmits to improve the signal-to-noise ratio. Adaptive use of the signal-quality information applies generally to any of the embodiments shown in FIGS. 46-53.

The multipath analyzer 4651 selects the timing and the amplitudes of a plurality of pulses that, when transmitted, cause an improvement in the signal-to-noise ratio at an external receiver (not shown in FIG. 46). The plurality of transmitted pulses cause the improvement in the signal-to-noise ratio because of the signal addition at the external receiver's antenna, as described above (see, for example, the description of FIGS. 45A-45G).

The multipath analyzer 4651 selects the timing and amplitudes of the plurality of transmitted pulses based on one or more of several techniques, as described above. To reiterate, the multipath analyzer 4651 may ascertain the characteristics of the multipath environment in which the transceiver 4600 operates by receiving the multipath characteristics from an external source. In this scenario, the external source determines the characteristics of the multipath environment and provides the multipath information to the transceiver 4600. The transceiver 4600 may receive the multipath information from the external source through an RF link (i.e., through signals transmitted from the external source that communicate the multipath information; the RF link may be a similar UWB link or RF link of other technology), or through wire lines (e.g., telephone lines, network lines, and the like).

Alternatively, the multipath analyzer 4651 may determine the characteristics of the multipath environment by analyzing signals it receives from an external source, for example, a second transceiver or a receiver. In this case, the transceiver 4600 may use the multiple-correlator techniques (i.e., using a plurality of correlators to perform scanning and locking) described above to determine the multipath information.

As yet another alternative, the transceiver 4600 may receive signal-quality information from an external source, for example, a second transceiver, or receiver. The signal-quality information is derived using power-control techniques described above, and may include, among other things, signal-quality measures, signal-to-noise ratio, and bit-error rate.

The multipath analyzer 4651 provides control signals 4654 to a controller 4657. The control signals 4654 provide information about the timing and amplitudes of the plurality of signals that the transceiver 4600 transmits to improve the signal-to-noise ratio at a receiver. The control signals 4654 may also include information about the number of pulses that the transceiver 4600 should transmit to improve the signal-to-noise ratio.

The controller 4657 operates together with the precision-timing generator 4618 and the pulse generator 4624 to cause the transmission of the plurality of pulses that improve the signal-to-noise ratio. For each pulse, the controller 4657 provides a first control signal 4660 to the precision-timing generator 4618. The first control signal 4660 instructs the precision-timing generator 4660 to set the timing of that pulse to the particular timing that the multipath analyzer 4651 selects. The precision-timing generator 4618 provides the timing signal 4621 for the pulse to the pulse generator 4624.

The controller 4657 also provides a second control signal 4663 to the pulse generator 4624. The second control signal 4663 instructs the pulse generator 4624 to set the amplitude of the pulse to the particular amplitude that the multipath analyzer 4651 selects. The pulse generator 4624 uses the second control signal 4663, together with the timing signal 4621, to provide the pulse to the transmit/receive switch 4630. The transmit/receive switch 4630 causes the transmission of the pulse via antenna 4633.

The controller 4657, the precision-timing generator 4618, and the pulse generator 4624 repeat the above steps for each of the plurality of pulses. For each remaining pulse, the controller 4652 provides a first control signal 4660 to the precision-timing generator 4618. Moreover, the controller 4657 provides a second control signal 4660 to the pulse generator 4624. In response, the precision-timing generator 4618 and the pulse generator 4624 cause the transmission of a pulse whose timing and amplitude correspond to the timing and amplitude that the multipath analyzer 4651 provides to the controller 4657. This process repeats until the transceiver 4600 has transmitted each of the plurality of pulses aimed at improving the signal-to-noise ratio.

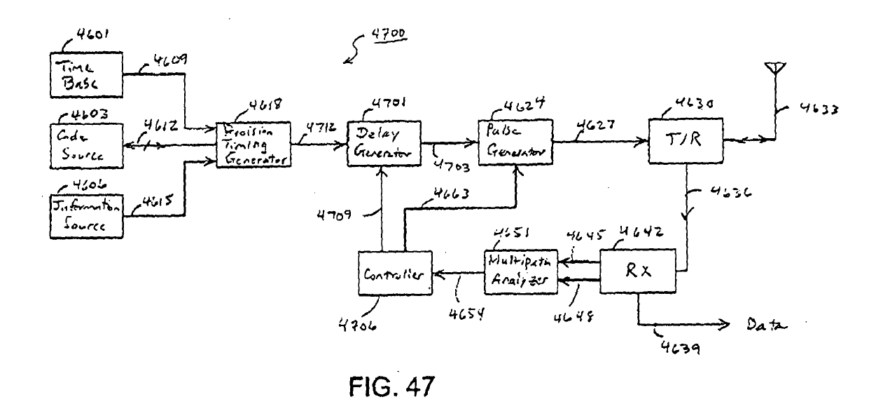

FIG. 47 shows another embodiment of a transceiver 4700 that includes transmit-rake apparatus according to the invention. The transceiver 4700 is a variation of the transceiver 4600 shown in FIG. 46 and operates in a similar manner. Unlike that transceiver, however, the transceiver 4700 in FIG. 47 includes a delay generator 4701. The delay generator 4701 receives a timing signal 4712 from the precision-timing generator 4618. The delay generator 4701 also provides a trigger signal 4703 to a pulse generator 4624. A controller 4706 provides a first control signal 4709 to the delay generator 4701. The controller 4706 also provides a second control signal 4663 to the pulse generator 4624. Rather than providing timing signals according to control signals from the controller 4706, the precision-timing generator provides a fixed timing signal 4712 to the delay generator 4701.

Using the first control signal 4709, the delay generator 4701 sets the timing of each of the plurality of pulses that the transceiver 4700 transmits. For each pulse, the delay generator 4701 provides an triggering signal 4703 to the pulse generator 6424. The pulse generator 4624 uses the second control signal 4663 to set the amplitude of each pulse that the transceiver 4700 transmits. Using the trigger signal 4703, the pulse generator 6424 causes the transmission of the pulse. Each pulse has the timing and amplitude corresponding to the timing and amplitude that the multipath analyzer 4651 selects for that particular pulse. Repeating these steps, the transceiver 4700 transmits a plurality of pulses that improve the signal-to-noise-ratio at an external receiver. The remainder of the transceiver 4700 operates in a manner similar to the transceiver 4600 in FIG. 46.

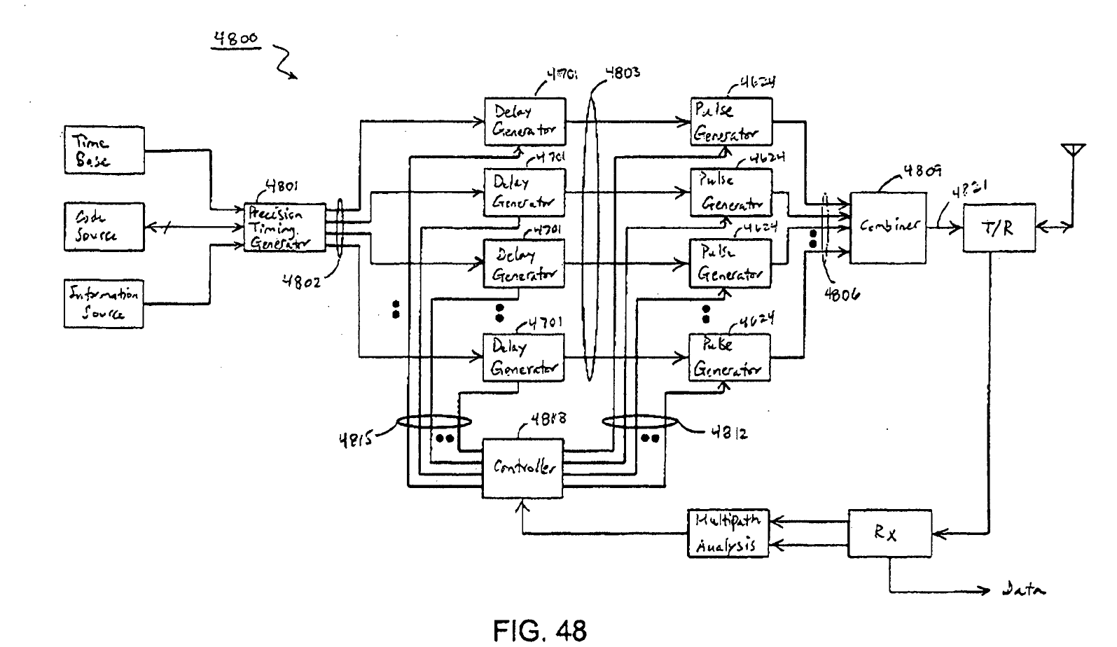

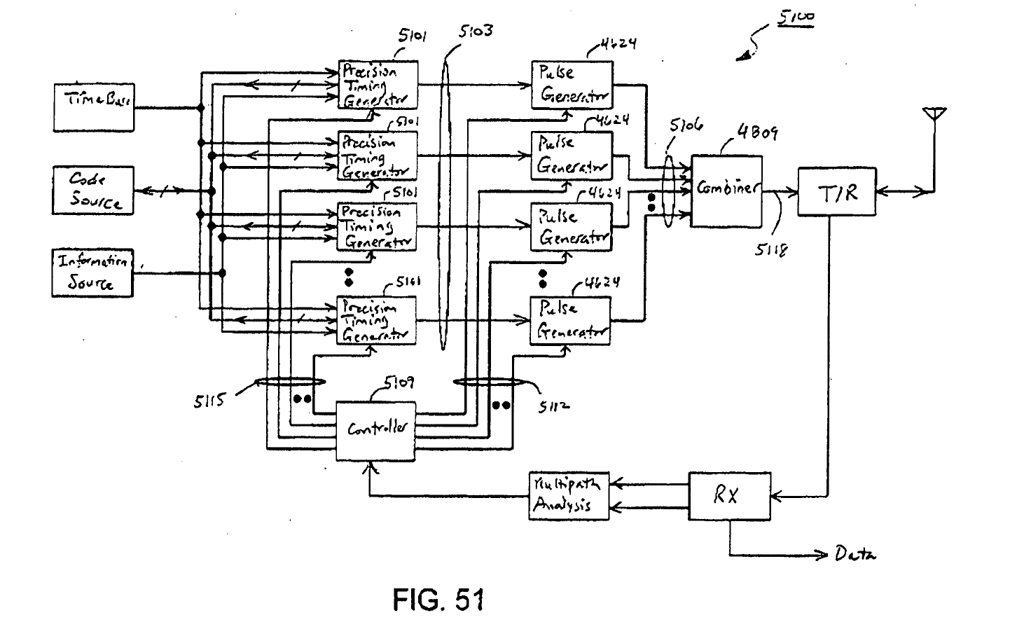

FIGS. 48-53 illustrate various embodiments of transceivers that include transmit-rake apparatus according to the invention. The transceivers in FIGS. 48-53 constitute variations of the transceivers shown in FIGS. 46 and 47. More specifically, FIGS. 48-50 illustrate embodiments that are variations of the transceiver 4700 shown in FIG. 47, whereas the embodiments in FIGS. 51-53 constitute variations of the transceiver 4600 illustrated in FIG. 46.

FIG. 48 depicts an embodiment of a transceiver 4800 that includes transmit-rake apparatus according to the invention. The transceiver 4800 has an architecture similar to the transceiver 4700 in FIG. 47. The transceiver 4800, however, uses a plurality of delay generators 4701 and a plurality of pulse generators 4624, rather than a single delay generator and a single pulse generator. The transceiver 4800 includes an equal number of delay generators 4701 and pulse generators 4624.

A precision-timing generator 4801 provides timing signals 4802 to the delay generators 4701. The delay generators 4701 provide trigger signals 4803 to pulse generators 4624. The pulse generators 4624 provide their output signals 4806 to a combiner 4809. The combiner 4809 combines the signals 4806 into an output signal 4821. Output signal 4821 comprises the plurality of pulses transmitted to improve the signal-to-noise ratio. A controller 4818 uses first control signals 4815 to control the delay generators 4701. The controller 4818 uses second control signals 4812 to control the pulse generators 4624. One may choose to use the transceiver 4800 depending on various design factors, as desired. For example, because of its parallel architecture, the transceiver 4800 may allow using slower or less costly delay generators 4701, pulse generators 4624, or both.

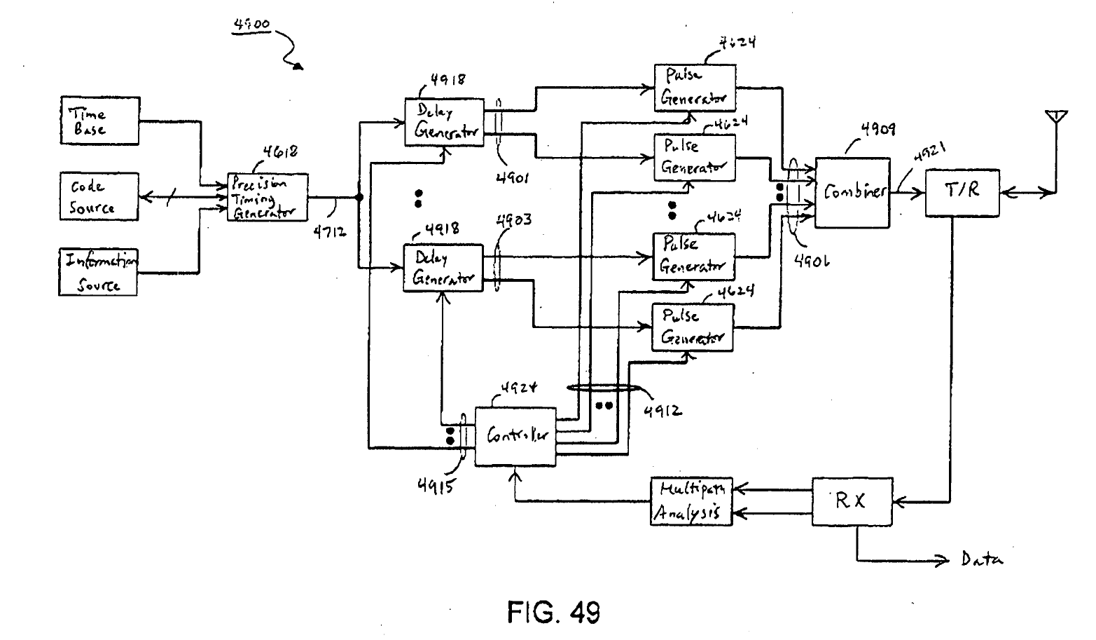

FIG. 49 depicts an embodiment of a transceiver 4900 that includes transmit-rake apparatus according to the invention. The transceiver 4900 has an architecture similar to the transceiver 4800 in FIG. 48. Similar to that transceiver, the transceiver 4900 uses a plurality of delay generators 4918 and a plurality of pulse generators 4624. The transceiver 4900, however, includes a smaller number of delay generators 4918 than it does pulse generators 4624.

The precision-timing generator 4618 provides timing signal 4712 to the delay generators 4918. Each of the delay generators 4918 provides its trigger signals (e.g., trigger signals 4901 and 4903) to a plurality of the pulse generators 4624. Note that FIG. 49 shows each delay generator 4918 as supplying trigger signals to two pulse generators 4624 for illustrative purposes only. Generally, each delay generator 4918 may provide trigger signals to other numbers of pulse generators 4624, as desired.

The pulse generators 4624 provide their output signals 4906 to a combiner 4909. The combiner 4909 combines the signals 4906 into an output signal 4921. Output signal 4921 comprises the plurality of pulses transmitted to improve the signal-to-noise ratio. A controller 4924 uses first control signals 4915 to control the delay generators 4918. The controller 4924 uses second control signals 4912 to control the pulse generators 4624. One may choose to use the transceiver 4900 depending on various design factors, as desired. For example, because of its parallel architecture, the transceiver 4900 may allow using slower or less costly delay generators 4918, pulse generators 4624, or both.

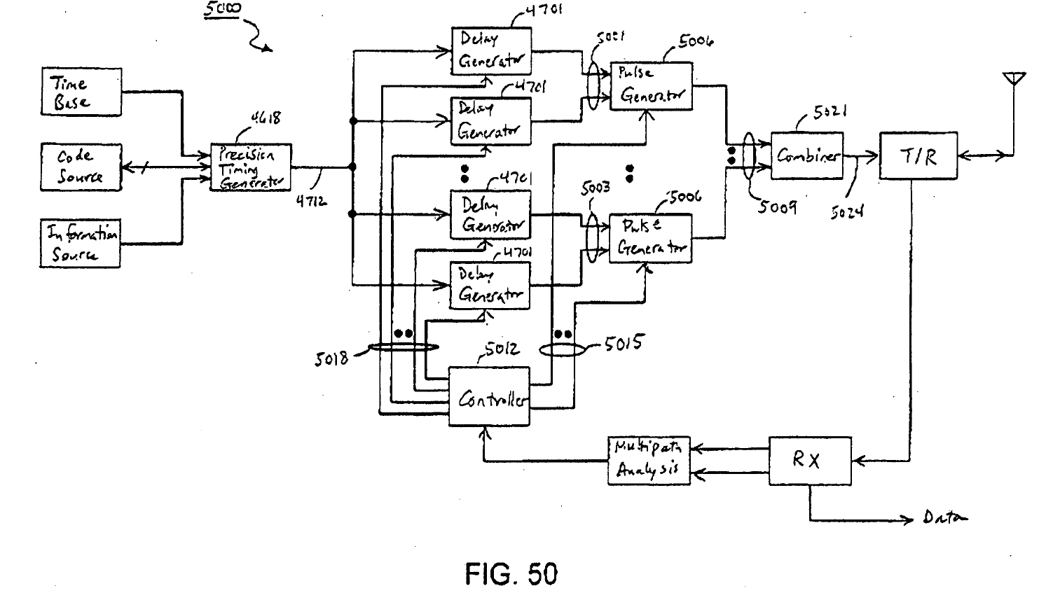

FIG. 50 illustrates an embodiment of a transceiver 5000 that includes transmit-rake apparatus according to the invention. The transceiver 5000 has an architecture similar to the transceiver 4800 in FIG. 48. Similar to that transceiver, the transceiver 5000 includes a plurality of delay generators 4701 and a plurality of pulse generators 5006. The transceiver 5000, however, includes a larger number of delay generators 4701 than it does pulse generators 5006.

The precision-timing generator 4618 provides timing signal 4712 to the delay generators 4701. Each of the pulse generators 5006 receivers its trigger signals (e.g., trigger signals 5001 and 5003) from a plurality of the delay generators 4701. Note that FIG. 50 shows each pulse generator 5006 receiving trigger signals from two delay generators 4701 for illustrative purposes only. Generally, each pulse generator 5006 may receive trigger signals from other numbers of delay generators 4701, as desired.

The pulse generators 5006 provide their output signals 5009 to a combiner 5021. The combiner 5021 combines the signals 5009 into an output signal 5024. Output signal 5024 comprises the plurality of pulses transmitted to improve the signal-to-noise ratio. A controller 5012 uses first control signals 5018 to control the delay generators 4701. The controller 5012 uses second control signals 5015 to control the pulse generators 5006. One may choose to use the transceiver 5000 depending on various design factors, as desired. For example, because of its parallel architecture, the transceiver 5000 may allow using slower or less costly delay generators 4701, pulse generators 5006, or both.

FIG. 51 depicts an embodiment of a transceiver 5100 that includes transmit-rake apparatus according to the invention. The transceiver 5100 has an architecture similar to the transceiver 4600 in FIG. 46. The transceiver 5100, however, uses a plurality of precision-timing generators 5101 and a plurality of pulse generators 4624, rather than a single delay generator and a single pulse generator. The transceiver 5100 includes an equal number of precision-timing generators 5101 and pulse generators 4624.

Precision-timing generators 5101 provide timing signals 5103 to the pulse generators 4624. The pulse generators 4624 provide their output signals 5106 to a combiner 4809. The combiner 4809 combines the signals 5106 into an output signal 5118. Output signal 5118 comprises the plurality of pulses transmitted to improve the signal-to-noise ratio. A controller 5109 uses first control signals 5115 to control the precision-timing generators 5101. The controller 5109 uses second control signals 5112 to control the pulse generators 4624. One may choose to use the transceiver 5100 depending on various design factors, as desired. For example, because of its parallel architecture, the transceiver 5100 may allow using slower or less costly precision-timing generators 5101, pulse generators 4624, or both.

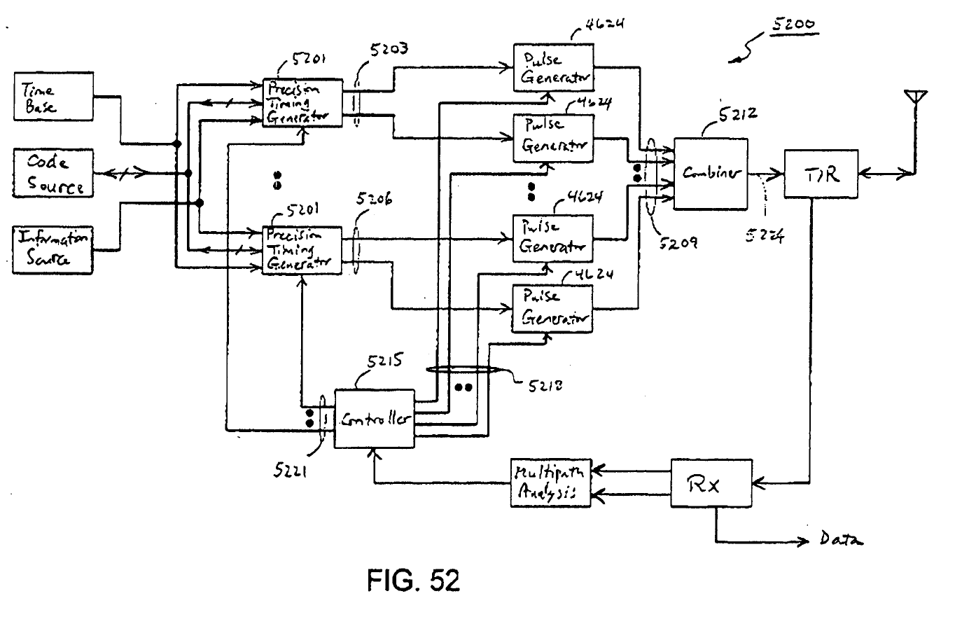

FIG. 52 depicts an embodiment of a transceiver 5200 that includes transmit-rake apparatus according to the invention. The transceiver 5200 has an architecture similar to the transceiver 5100 in FIG. 51. Similar to that transceiver, the transceiver 5200 uses a plurality of precision-timing generators 5201 and a plurality of pulse generators 4624. The transceiver 5200, however, includes a smaller number of precision-timing generators 5206 than it does pulse generators 4624.

Each of the precision-timing generators 5201 provides its timing signals (e.g., timing signals 5203 and 5206) to a plurality of the pulse generators 4624. Note that FIG. 52 shows each precision-timing generator 5201 as supplying trigger signals to two pulse generators 4624 for illustrative purposes only. Generally, each precision-timing generator 5201 may provide trigger signals to other numbers of pulse generators 4624, as desired.

The pulse generators 4624 provide their output signals 5209 to a combiner 5212. The combiner 5212 combines the signals 5209 into an output signal 5224. Output signal 5224 comprises the plurality of pulses transmitted to improve the signal-to-noise ratio. A controller 5215 uses first control signals 5221 to control the precision-timing generators 5201. The controller 5215 uses second control signals 5218 to control the pulse generators 4624. One may choose to use the transceiver 5200 depending on various design factors, as desired. For example, because of its parallel architecture, the transceiver 5200 may allow using slower or less costly precision-timing generators 5201, pulse generators 4624, or both.

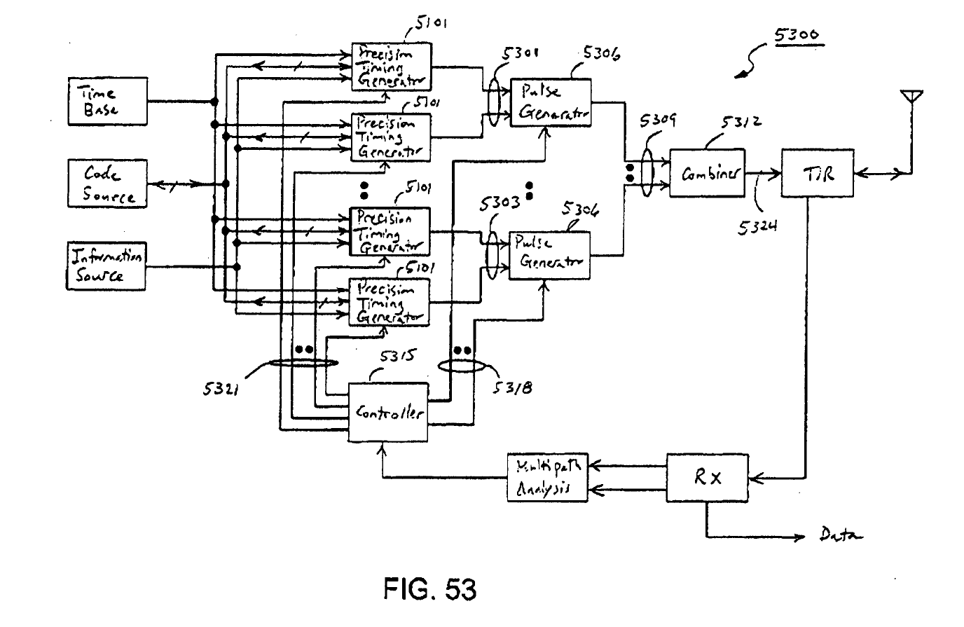

FIG. 53 illustrates an embodiment of a transceiver 5300 that includes transmit-rake apparatus according to the invention. The transceiver 5300 has an architecture similar to the transceiver 5100 in FIG. 51. Similar to that transceiver, the transceiver 5300 includes a plurality of precision-timing generators 5101 and a plurality of pulse generators 5306. The transceiver 5300, however, includes a larger number of precision-timing generators 5101 than it does pulse generators 5306.

Each of the pulse generators 5306 receivers its trigger signals (e.g., trigger signals 5301 and 5303) from a plurality of the precision-timing generators 5101. Note that FIG. 53 shows each pulse generator 5306 receiving trigger signals from two precision-timing generators 5101 for illustrative purposes only. Generally, each pulse generator 5306 may receive trigger signals from other numbers of precision-timing generators 5101, as desired.

The pulse generators 5306 provide their output signals 5309 to a combiner 5312. The combiner 5312 combines the signals 5309 into an output signal 5324. Output signal 5324 comprises the plurality of pulses transmitted to improve the signal-to-noise ratio. A controller 5315 uses first control signals 5321 to control the precision-timing generators 5101. The controller 5315 uses second control signals 5318 to control the pulse generators 5306. One may choose to use the transceiver 5300 depending on various design factors, as desired. For example, because of its parallel architecture, the transceiver 5300 may allow using slower or less costly precision-timing generators 5101, pulse generators 5306, or both. The same or different design factors may apply to choosing which of the architectures shown in FIGS. 46-53 to use in a particular application, as persons skilled in the art would understand.

As noted above, multipath environments may result in complex received signals that may include many pulses. FIG. 54A shows a pulse transmitted in a multipath environment. FIG. 54B shows a received signal in the multipath environment. Note that the received signal has four pulses, P₁, P₂, P₃, and P₄ that have the largest amplitudes of the received pulses. To improve the signal-to-noise ratio, a multipath analyzer should select pulse P₃ (the same situation would occur if the four pulses have polarities opposite of that shown in FIG. 54B). As an enhancement, the multipath analyzers in any of the transceivers shown in FIGS. 46-53 may reverse the polarity of pulse P₃ so as to make its polarity the same as the other pulses. The multipath analyzer would then analyze the multipath environment as described above, using the three original P₁, P₂, P₃, and P₄ signals, together with the modified P₃ signal. Generally, the multipath analyzers in any of the transceivers shown in FIGS. 46-53 may select the polarities of the plurality of transmitted pulses. Thus, transmit-rake apparatus according to the invention may select the timing, amplitude, and polarities of the plurality of pulses transmitted in order to improve the signal-to-noise ratio.

As another enhancement, one may use pulse generators in any of the disclosed transmit-rake apparatus that select quantized levels for the transmitted plurality of pulses. In other words, rather than selecting magnitudes of the transmitted pulses from a continuously variable range of amplitudes, the pulse generators may select the amplitudes from a set of quantized levels. For example, if the quantized levels include only two levels, the pulse generators would either include a pulse with a full amplitude (as determined by the characteristics of the pulse generator, supply voltages, etc.), or a pulse with an amplitude of zero.

In a further embodiment, the pulse properties selected may include differing pulse shapes. The multipath analyzer may be used to resolve a multipath response into a sequence of pulses of differing shapes by correlating (or deconvolving) with each pulse in turn and subtracting the maximum response for each respective pulse to generate a remainder response to be used for subsequent pulse correlation.

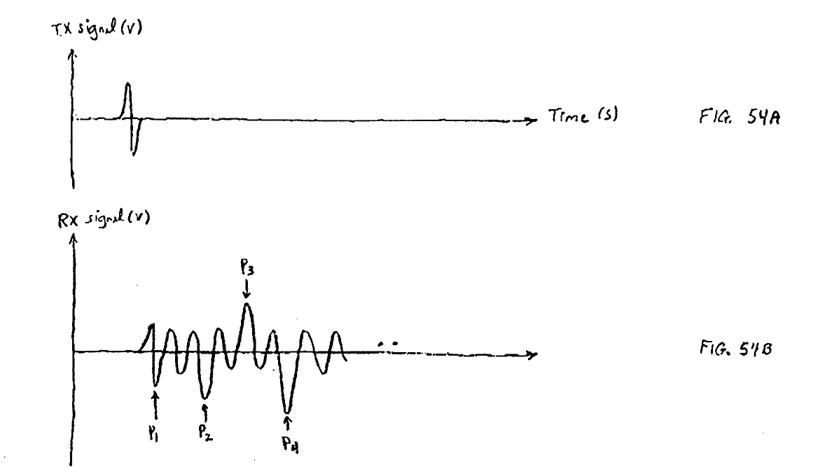

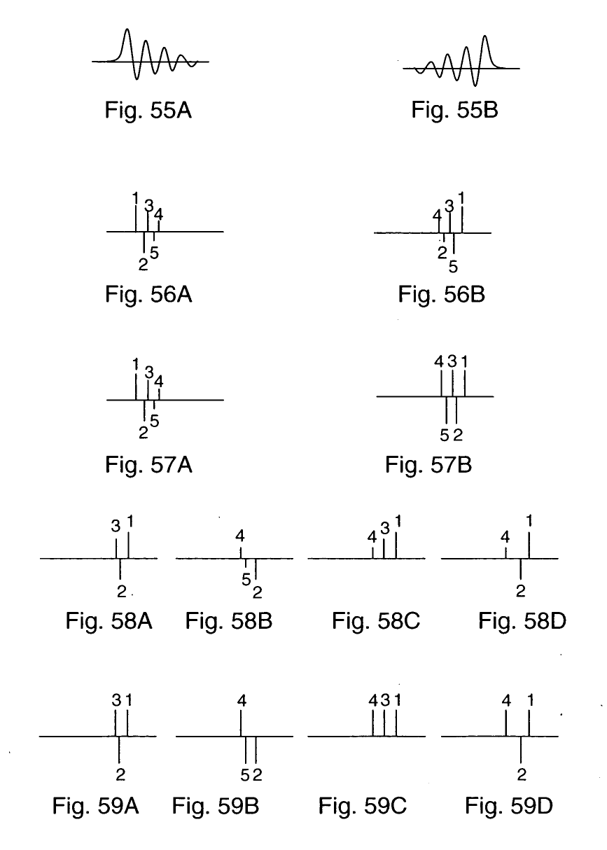

Various techniques may be employed to utilize the present invention. FIGS. 55-62 illustrate a number of techniques

FIG. 55A shows an exemplary multipath response characteristic waveform and FIG. 55B shows an associated transmitter waveform. The multipath waveform is shown as an initial pulse followed by a series of following pulses within a decaying envelope. The associated transmit waveform is a time reverse copy of the multipath characteristic waveform. Thus, the transmit waveform is a series of pulses with an increasing envelope.

FIG. 56A shows the selection of a model for a multipath waveform. FIG. 56A shows a model for the multipath response of FIG. 56a, i.e. each lobe of the multipath response of FIG. 55A is represented by a vertical line in FIG. 56A. The amplitude of the lobe is indicated by the length of the line and the time position of the lobe is indicated by the position of the vertical line. The number shown is a sequence number for discussion purposes. Thus, the amplitude response of FIG. 55A could be generated approximately by summing lobes according to the time and amplitude indicated in the model of FIG. 56A.

FIG. 56B shows a schematic of a composite transmitter signal associated with the model of FIG. 56A. Thus the transmitter transmits a sequence of pulses in reverse time and amplitude for selected response lobes according to the model of FIG. 56A. Typically the largest lobes would be selected for transmission.

FIG. 57A and FIG. 57B illustrate an alternative embodiment utilizing constant amplitude pulses. FIG. 57B illustrates constant amplitude pulses at the time delays associated with the corresponding response lobe in the model of FIG. 57A. Because the amplitude is not varied, the signal improvement may not be as great as when amplitude is set along with time position. The constant pulse amplitude embodiment is used best for lobes that are close in amplitude to the largest lobe. The performance of the constant amplitude embodiment, may be further improved by adjusting the time position of each lobe.

Because the amplitude of each lobe may not be exactly optimal, an adjustment in timing may improve performance. Such adjustment in timing may be achieved by receiving feedback from the receiver or by multipath signal analysis. In the feedback embodiment, a set of pulse timings is initially determined by a first transceiver and used to send data to a second transciever. The second transceiver determines signal quality and sends the signal quality information back in a response message. The first transceiver then adjusts the pulse timing based on the signal quality information and sends further data. The second transceiver then determines a new signal quality and sends the signal quality information back in a second response message. The first transceiver then determines the improvement by comparing the two signal quality measurements and then either returns to the original timing or further varies the timing based on the signal improvement, i.e. if the signal improved, further variation is warranted, if not a return to the original timing is warranted.

In the multipath analysis embodiment, the multipath response is scanned using a scanning receiver, the scan data is compared with a pulse model using correlation. The time shift corresponding to the greatest peak correlation response is noted. A pulse signal of proper timing and amplitude is subtracted from the scan data to zero the maximum pulse correlation response, thus generating a remainder scan response. The remainder scan response is then again compared with a pulse model using correlation to find a second maximum peak response. The process is continued to an end point. The end point may be based on a maximum number of pulses, or a minimum signal strength for the greatest peak, or other end point as may be appropriate. The location and magnitude of the greatest peaks found in this manner may be used as the pulse model for the measured environment. The transmitted pulse would then be the time reverse of this model. Alternatively, peaks that are not the greatest peaks or other locations may be used for each iteration. Use of the largest peak is preferred; however there may be hardware limitations such as minimum time spacing between pulses or other limitations that prevent the use of the preferred locations.

In a further embodiment the multipath response characteristic found with the scanning receiver may be deconvolved with a model of the transmitted pulse shape to determine a channel impulse response model. The highest peaks from the channel impulse model are then used to select pulse timing and amplitudes for a group of pulses to be transmitted (transmitted time reversed from the channel response). The deconvolution may be accomplished by such methods as the Clean algorithm, maximal likelihood deconvolution, or other deconvolution techniques known in the art.

A constant sequence of pulses in a fixed pattern tends to generate a spectral pattern, even when the pulses are modulated. The spectral pattern may have undesired peaks or other properties, depending on the pattern and the application. Thus, it may be desirable to vary the pattern of pulses.

FIGS. 58A-D illustrate a coded sequence of pulses based on varying the transmitted pulse pattern. Each of the FIGS. 58A-58D represents a different group of pulses, each pulse within each group is related by being derived from the same multipath response, i.e. resulting from the same ideal impulse source. Each group results from a different time shifted ideal impulse. In a preferred embodiment, the groups do not overlap, but they may overlap for high pulse rates or long multpath delays. By varying the pulse sequence, the spectral lines may be altered and shifted. Various embodiments utilizing the variation of pulse selection from the model set of FIG. 56B are shown in FIGS. 58A-58D. Other embodiments may be derived from the ones shown by one skilled in the art in accordance with the teachings of this disclosure.

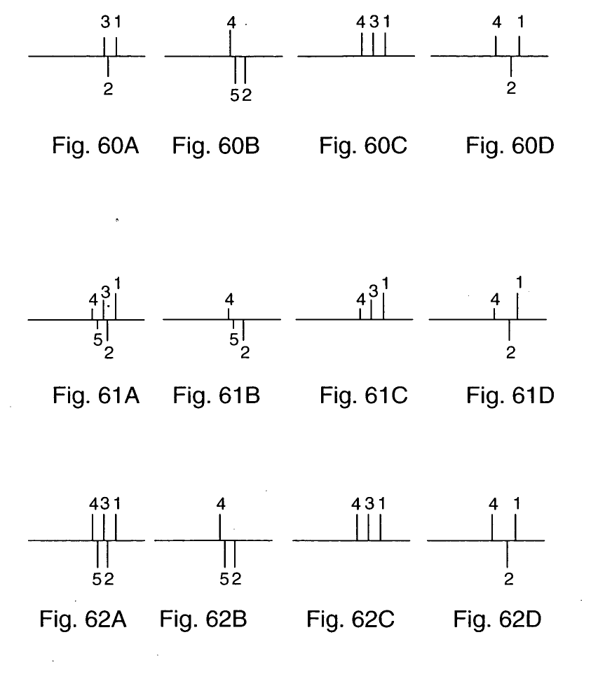

Referring to FIGS. 58A-58D, each of the FIGS. 58A, 58B, 58C, 58D illustrate a pulse group that is a subset of the pulses from the model FIG. 56B. A sequence of pulse groups comprising the group 58A followed by 58B followed by 58D followed by 58E may be sent in place of a sequence of four identical pulse groups as in 56B. Each pulse group in FIGS. 58A-58D may not have the same total power or result in the same received signal strength, thus it may be desirable to adjust each group for equal transmitted power as shown in FIGS. 59A-59D. It may also be desirable to send constant amplitude pulses to simplify the design of the pulser, for example, because there are an equal number of pulses, FIGS. 59A-59D also show equal size pulses. Pulse groups of differing size pulses are shown in FIGS. 60A-60D. It may also be desirable to vary the number of pulses as shown in FIGS. 61A-61D. Further, it may be desirable to vary the number of pulses, using a constant amplitude for each pulse as shown in FIGS. 62A-62D. Further, it may be desirable to vary the pulse shape of each pulse or each group. Other embodiments may be derived from the ones shown by one skilled in the art in accordance with the teachings of this disclosure.

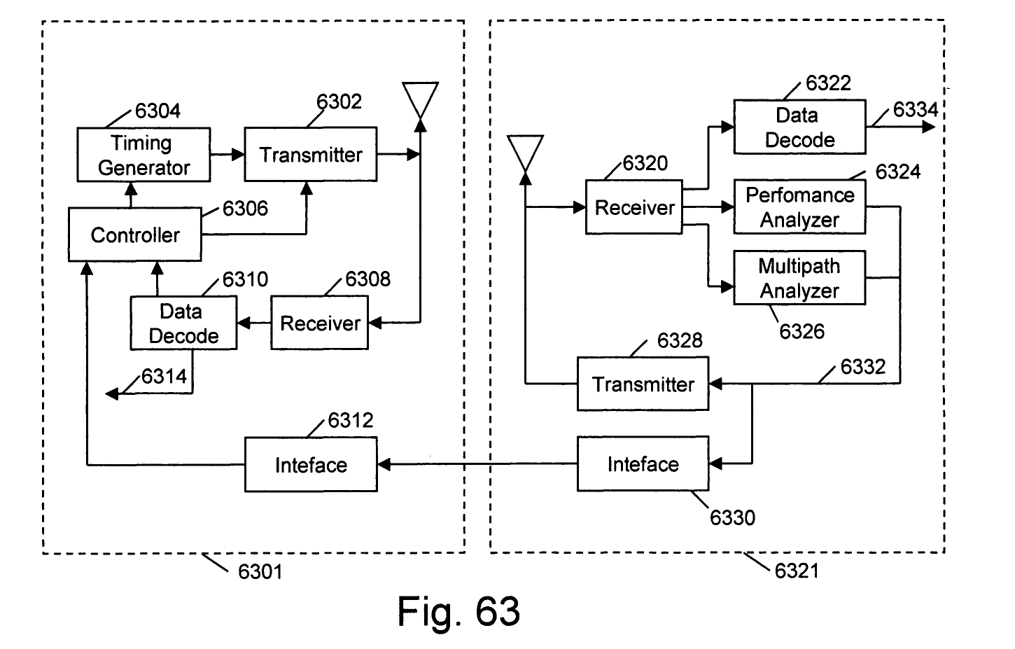

FIG. 63 illustrates a link system wherein a transmitter receives performance data and/or multipath data from an external source in accordance with the present invention. Referring to FIG. 63, FIG. 63 shows a first transceiver 6301 comprising a first transmitter 6302, a timing generator 6304, a controller 6306, a first receiver 6308 and a first data decode 6310. The first transceiver 6301 may also or alternatively include a first interface 6312 unit. FIG. 63 also shows a second transceiver 6321 comprising a second receiver 6320, a second data decode 6322, a performance analyzer 6324, a multipath analyzer 6326, a second transmitter 6328, and may also or alternatively include a second interface 6330 unit.

The link system of FIG. 63 shows how the first transmitter 6302 need not include the performance analyzer 6324, the multipath analyzer 6326, or the first receiver 6308 in order to utilize the advantages of the transmit rake invention. In FIG. 63, some of the components are optional depending on the embodiment implemented.

In one embodiment, the first transceiver 6301 includes the first receiver 6308 and first data decode 6310. The second transceiver 6321 includes the second transmitter 6328. In this embodiment, data from the performance analyzer 6324 or the multipath analyzer 6326 would be sent as link data 6332 using the second transmitter 6328 to be received by the first receiver 6308. The frist data decode then decodes the link data 6332 and provides the link data 6332 to the controller 6306. The controller 6306 may then control the timing and/or amplitude of the pulses based on the link data 6332. The link data 6332 may contain performance analyzer 6324 data or multipath analyzer 6326 data or both. If the data contains performance analyzer 6324 data, the controller 6306 would adaptively adjust the transmitted signal based on the performance analyzer 6324 data as has been described in this disclosure. If the link data 6332 contains multipath analyzer 6326 information, the controller 6306 may use directly the multipath analyzer 6326 information to select pulse timing and/or amplitudes and/or polarities. The performance analyzer 6324 or the multipath analyzer 6326 may be employed alone or in combination. The first data decode 6310 may also provide a first user data 6314. The second data decode 6322 may provide a second user data 6334.

In an alternative embodiment, the first transceiver 6301 is simplified by eliminating the first receiver 6308 and first data decode 6310. In this alternative embodiment, the first interface 6312 is used to receive link data 6332 from the second transceiver 6321. The second transceiver 6321 is also simplified as the second transmitter 6328 is not used or not implemented. The second receiver 6320 may utilize the performance analyzer 6324 or the multipath analyzer 6326 separately or in combination to analyze the received signal and generate link data 6332 to send to the first transceiver 6301. The first interface 6312 and second interface 6330 may communicate using any means available including wire, network, or alternate RF communications links.

Note that, although the description of the invention refers to communication systems including transceivers, one may apply the disclosed inventive concepts to other configurations, as persons skilled in the art would understand. For example, instead of transceivers, one may use separate, but communicating, transmitters and receivers. The transmitters and receivers may communicate either via an RF link or through a wire-line connection, for example, telephone lines, land wire-connections, direct connections, and network connections. Note also that the description of the invention uses multipath and signal configurations shown in the accompanying figures for illustration purposes only. As persons skilled in the art would understand, one may advantageously apply the disclosed inventive concepts to a wide variety of signal configurations (e.g., the number of signals analyzed or transmitted) operating in multipath environments with widely varying characteristics (e.g., the number and type of obstructions).

Further modifications and alternative embodiments of this invention will be apparent to persons skilled in the art in view of this description of the invention. Accordingly, this description teaches those skilled in the art the manner of carrying out the invention and are to be construed as illustrative only. The forms of the invention shown and described should be taken as the presently preferred embodiments. Persons skilled in the art may make various changes in the shape, size, and arrangement of parts without departing from the scope of the invention described in this document. For example, persons skilled in the art may substitute equivalent elements for the elements illustrated and described here. Moreover, persons skilled in the art who have the benefit of the description of the invention may use certain features of the invention, independently of the use of other features, without departing from the scope of the invention.

We claim:

1. A transmit-rake apparatus, comprising:
an antenna configured to radiate electromagnetic energy into a medium for reception by a receiver; and
at least one pulse generator coupled to the antenna, the at least one pulse generator configured to provide to the antenna a plurality of pulses having individual signal properties selected so as to improve the signal-to-noise ratio at the receiver.

2. The apparatus of claim 1, wherein the signal properties include pulse timing.

3. The apparatus of claim 1 wherein the signal properties include pulse amplitude.

4. The apparatus of claim 1 wherein the signal properties include pulse polarity.

5. The apparatus of claim 1 wherein the signal properties include pulse shape.

6. The apparatus of claim 1, wherein the pulse generator selects the polarity of each pulse in the plurality of pulses.

7. The apparatus of claim 1, wherein the selection of signal properties is based on a multipath analyzer.

8. The apparatus of claim 7, wherein the multipath analyzer includes a scanning receiver.

9. The apparatus of claim 8 wherein the scanning receiver includes a scanning channel and a tracking channel.

10. The apparatus of claim 7, wherein the multipath analyzer comprises a plurality of correlators.

11. The apparatus of claim 1, wherein the selection of the signal properties of the plurality of pulses depends at least in part on multipath information provided to the transmit-rake apparatus by an external source.

12. The apparatus of claim 1, wherein the selection of the signal properties of the plurality of pulses depends at least in part on signal-quality information provided to the transmit-rake apparatus by an external source.

13. The apparatus of claim 12, wherein the signal-quality information comprises signal-to-noise-ratio or bit-error rate.

14. The apparatus of claim 12, wherein the signal properties of the plurality of pulses are iteratively refined based at least in part on said signal-quality information provided to the transmit-rake apparatus by the external source.

15. The apparatus of claim 1, wherein the ultra-wideband transmit-rake apparatus further comprises:
at least one precision-timing generator, configured to provide at least one timing signal to the at least one pulse generator; and
a controller, configured to provide control signals to the at least one precision-timing generator and the at least one pulse generator.

16. The apparatus of claim 1, wherein the ultra-wideband transmit-rake apparatus further comprises:
at least one delay generator, configured to provide at least one timing signal to the at least one pulse generator;
a precision-timing generator, configured to provide at least one timing signal to the at least one delay generator; and
a controller, configured to provide control signals to the at least one delay generator and the at least one pulse generator.

17. A method of improving signal-to-noise ratio in a communication system, said method comprising:
providing at least one pulse generator in a transmitter, the at least one pulse generator configured to provide a plurality of pulses having individual signal properties selected so as to improve the signal-to-noise ratio at a receiver;
generating the plurality of pulses using the at least one pulse generator; and
providing the plurality of pulses to the receiver.

18. The method of claim 17, wherein the signal properties include pulse timing.

19. The method of claim 17 wherein the signal properties include pulse amplitude.

20. The method of claim 17 wherein the signal properties include pulse polarity.

21. The method of claim 17 wherein the signal properties include pulse shape.

22. The method of claim 17, wherein the pulse generator selects the polarity of each pulse in the plurality of pulses.

23. The method of claim 17, wherein the selection of signal properties is based on a multipath analyzer.

24. The method of claim 23, wherein the multipath analyzer includes a scanning receiver for producing a scan output.

25. The method of claim 24, wherein the scanning receiver includes a scanning channel and a tracking channel.

26. The method of claim 24, wherein the timing of each pulse in said plurality of pulses is based on the timing of the peak amplitudes in said scan output.

27. The method of claim 24, further including the step of correlating the scan output with a signal model to determine a time position for at least one pulse in said plurality of pulses.

28. The method of claim 27, further including the step of subtracting a signal based on the signal model from the scan output to produce a remaining scan output and correlating the remaining scan output with the signal model to produce a subsequent pulse time position.

29. The method of claim 23, in which the multipath analyzer includes a plurality of correlators.

30. The method of claim 17, further including the step of receiving multipath information from an external source, and selecting the signal properties of the plurality of pulses at least in part based on the multipath information.

31. The method of claim 17, further including the step of receiving signal-quality information from an external source, and selecting the signal properties of the plurality of pulses at least in part based on the signal-quality information.

32. The method of claim 31, in which receiving signal-quality information from an external source includes receiving signal-to-noise-ratio or bit-error rate information.

33. The method of claim 17, wherein the pulses are grouped and the pulse properties are varied from group to group.

34. The method of claim 33 wherein the total power for each group is substantially constant.

35. The method of claim 33 wherein the total received signal from each group is substantially constant.

36. The method of claim 33 wherein each pulse has substantially the same amplitude.

37. The method of claim 33 wherein the number of pulses varies from at least one group to at least one other group.

38. The method of claim 17, further including the steps of:
providing at least one precision-timing generator, configured to provide at least one timing signal to the at least one pulse generator; and
providing a controller, configured to provide control signals to the at least one precision-timing generator and the at least one pulse generator.

39. The method of claim 17, further including the steps of:
providing at least one delay generator, configured to provide at least one timing signal to the pulse generator;
providing a precision-timing generator, configured to provide at least one timing signal to the at least one delay generator; and
providing a controller, configured to provide control signals to the at least one delay generator and the at least one pulse generator.

40. A method for increasing the signal to noise performance of an ultra wideband communications link; said link comprising multiple paths; said method comprising the steps of:
characterizing the multiple paths of said communications link to identify a plurality of path time delays associated with said multiple paths;
providing a plurality of pulses with relative pulse time delays based on said plurality of path time delays wherein said pulse time delays are arranged in reverse order from said path time delays.
